(19) United States
(12) Patent Application Publication
(10) Pub. No.: US 2024/0114940 A1
(43) Pub. Date: Apr. 11, 2024

(54) SACCHARIDE COMPOSITIONS HAVING SUCROSE-LIKE CHARACTERISTICS AND RELATED METHODS

(71) Applicant: Cambridge Glycoscience Ltd, Cambridge (GB)

(72) Inventors: Thomas J. SIMMONS, Cambridge (GB); Jeremy BARTOSIAK-JENTYS, Chester (GB)

(21) Appl. No.: 18/486,733

(22) Filed: Oct. 13, 2023

Related U.S. Application Data
(63) Continuation of application No. PCT/EP22/60194, filed on Apr. 15, 2022.
(60) Provisional application No. 63/176,223, filed on Apr. 17, 2021.

(51) Int. Cl. A23L 27/30; A23G 3/38; A23G 3/42

(52) U.S. Cl. CPC A23L 27/33; A23G 3/38; A23G 3/42

(57) ABSTRACT

Flavoring precursor compositions including a first oligosaccharide component and a second oligosaccharide component are provided. The first oligosaccharide component may include cello-oligosaccharide. The second oligosaccharide component may include an oligosaccharide that is not cello-oligosaccharide. Also provided herein are cooked food products.

### CROSS-REFERENCE

This application is a continuation of International Application No.: PCT/EP2022/060194 filed Apr. 15, 2022, which claims the benefit of U.S. Provisional Application No. 63/176,223, filed Apr. 17, 2021, which is incorporated herein by reference.

### BACKGROUND

Industry has been searching for suitable sugar substitutes and artificial sweeteners for many decades. However, while some sugar substitutes and artificial sweeteners are able to mimic the sweetness of sugar (e.g., sucrose) in food and drinks, few are able to mimic the broad range of physical properties that sugar lends to food, such as adding bulk, modulating texture, providing structure, acting as a preservative, and modulating color and flavor (e.g., through caramelization and Maillard reactions). Additionally, sugar substitutes (e.g., bulking sweeteners) that are able to mimic the physical properties of sugar can have gastrointestinal tolerance issues that limit their use to levels below the amount needed to replace sugar in a standard Western diet.

While some sugar substitutes and artificial sweeteners can mimic the sweetness of sugar in food and drinks, they can often only lend such sweetness at room temperature. However, many of the texture, color, and flavor characteristics that sugar provides to foods such as baked goods and confectionery products are developed by the application of heat during the preparation of the foods. Under such conditions many sugar substitutes and artificial sweeteners can lose their sweetness. Sugar substitutes and artificial sweeteners also often fail to caramelize or undergo Maillard reactions. Thus, it is desirable to provide a sugar substitute can mimic the characteristics that are developed when sugar is heated to various temperatures.

### SUMMARY

In one aspect, described herein are flavoring precursor compositions. In some embodiments, flavoring precursor compositions comprise a first oligosaccharide component comprising a cello-oligosaccharide. In some embodiments, flavoring precursor compositions comprise a second oligosaccharide component comprising an oligosaccharide that is not a cello-oligosaccharide. In some embodiments, a flavoring precursor composition has an absorbance of greater than 0.2 at 420 nm after heating, vs a water control, when the composition is dissolved or suspended in water at a concentration of 100 mg/mL and held at a temperature of 170° C. for five minutes prior to measurement at room temperature. In some embodiments, a flavoring precursor composition has an absorbance that does not exceed 4 at 420 nm after heating, vs a water control, when the composition is dissolved or suspended in water at a concentration of 100 mg/mL and held at a temperature of 180° C. for five minutes prior to measurement at room temperature.

In some embodiments of a flavoring precursor composition, at least 0.1 ppm of furans are produced by a non-enzymatic breakdown reaction when a 50 mM solution of the flavoring precursor composition is reacted with leucine at a concentration of 50 mM and the mixture is held at a temperature of 160° C. for ten minutes. In some embodiments, the at least 0.1 ppm of furans comprises at least 1 ppm of furfural. In some embodiments, the at least 0.1 ppm of furans comprises at least 0.1 ppm of furfural. In some embodiments of a flavoring precursor composition, the at least 0.0025 weight % of the precursor composition is converted to furans by a non-enzymatic breakdown reaction. In some embodiments of a flavoring precursor composition, at least 0.001 weight % of the precursor composition is converted to diacetyl by a non-enzymatic breakdown reaction.

In some embodiments of a flavoring precursor composition, at least 150 ppb of diacetyl is produced by a non-enzymatic breakdown reaction when a 50 mM solution of the flavoring precursor composition is reacted with tryptophan at a concentration of 50 mM and the mixture is held at a temperature of 160° C. for ten minutes.

In another aspect described herein are cooked food products produced from a raw food product. In some embodiments, the cooked food product comprises a flavoring component. In some embodiments, the flavoring component comprises a plurality of non-enzymatic oligosaccharide breakdown products. In some embodiments, the non-enzymatic breakdown products comprise at least one compound selected from the group consisting of ketones, esters, aldehydes, furans, pyrazines, and aromatic compounds.

In some embodiments of a cooked food product, the non-enzymatic oligosaccharide breakdown products were produced during cooking of the raw food product. In some embodiments of a cooked food product, the raw food product comprised a flavoring precursor composition. In some embodiments of a cooked food product, at least one of the plurality of non-enzymatic oligosaccharide breakdown products is present in a larger concentration than a cooked food product produced from a raw food product wherein the flavoring precursor composition is substituted for sucrose.

In some embodiments of a cooked food product, the food product is a candy. In some embodiments of a cooked food product, the food product is a fudge. In some embodiments of a cooked food product, the food product is a nougat. In some embodiments of a cooked food product, the food product has a specific hardness of 0.01 N/mm² to 0.5 N/mm². In some embodiments of a cooked food product, the cooked food product comprises at least 50 weight % ingredients derived from the flavoring precursor composition. In some embodiments of a cooked food product, the cooked food product comprises at least 60 weight % ingredients derived from the flavoring precursor composition.

In some embodiments of a cooked food product, the at least one of the plurality of non-enzymatic oligosaccharide breakdown products comprises diacetyl or furfural.

In some embodiments of a cooked food product, the at least one of the plurality of non-enzymatic oligosaccharide breakdown products comprises diacetyl or furfural; and wherein the diacetyl or furfural is derived from at least 0.001 weight % of the flavoring precursor composition.

In some embodiments of a cooked food product, the cooked food product consists essentially of ingredients derived from the flavoring precursor composition and water.

In some embodiments of a cooked food product or a flavoring precursor composition, the flavoring precursor composition further comprises an amino acid. In some embodiments of a cooked food product or a flavoring precursor composition, the flavoring precursor composition further comprises one or more lipids. In some embodiments of a cooked food product or a flavoring precursor composition, the second oligosaccharide component comprises XOS or FOS. In some embodiments of a cooked food product or a flavoring precursor composition, the first and second oligosaccharide components of the flavoring precursor composition comprise a ratio of the second oligosaccharide component to the first oligosaccharide component of 80:20 to 90:10. In some embodiments of a cooked food product or a flavoring precursor composition, the flavoring precursor composition further comprises a pH regulator.

Provided in certain embodiments herein are saccharide compositions suitable for caramelization (e.g., that brown under heating conditions and at least partially retain sweetness under such conditions). In specific embodiments, compositions provided herein are low monosaccharide content compositions that are suitable for caramelization (e.g., that brown under heating conditions and at least partially retain sweetness under such conditions). Also provided in certain embodiments herein are (e.g., sweet and edible) compositions having a brown or caramel color and/or comprise non-enzymatic (e.g., oligosaccharide) reaction breakdown products (e.g., oxidation products, reduction products, hydrolysis products, polymerization products, cross-linked products, and/or other degradation products). In certain embodiments, such compositions comprise a first oligosaccharide (e.g., cello-oligosaccharide) and a second oligosaccharide (e.g., that is different than the first oligosaccharide, such as not cello-oligosaccharide). In specific embodiments, such compositions further comprise non-enzymatic (e.g., thermal) reaction breakdown product(s). Also provided in various embodiments herein are methods for producing such compositions.

Disclosed herein is a composition comprising: a first oligosaccharide component, the first oligosaccharide component comprising cello-oligosaccharide having a degree of polymerization (DP) of two to six, the cello-oligosaccharide comprising 1 dry wt. % to 60 dry wt. % of the composition; a second oligosaccharide component, the second oligosaccharide component comprising a second oligosaccharide having a DP of two to 12, the second oligosaccharide not being cello-oligosaccharide; water comprising 1 wt. % to 50 wt. % of the composition; and one or more non-enzymatic reaction breakdown products, the composition comprising less than 40 dry wt. % monosaccharides. The composition having been exposed to a temperature of greater than 100° C., 110° C., 120° C. or 130° C. The cello-oligosaccharide can comprise 1 dry wt. % to 50 dry wt. % of the composition. The water can comprise 1 wt. % to 40 wt. % of the composition. The cello-oligosaccharide can comprise 2.5 dry wt. % to 30 dry wt. % of the composition. The water can comprise 1 wt. % to 20 wt. % of the composition.

The second oligosaccharide can comprise 10 dry wt. % to 90 dry wt. % of the composition. The second oligosaccharide can be a xylo-oligosaccharide having a DP of two to 12. The xylo-oligosaccharide can have a DP of two to six comprising at least 50% of the xylo-oligosaccharide having a DP of two to 12. The second oligosaccharide can be mannan-oligosaccharide having a DP of two to 12. The mannan-oligosaccharide can have a DP of two to six comprising at least 50% of the mannan-oligosaccharide having a DP of two to 12. The second oligosaccharide can be fructo-oligosaccharide having a DP of two to 12. The fructo-oligosaccharide can have a DP of two to six comprising at least 50% of the fructo-oligosaccharide having a DP of two to 12. The second oligosaccharide can be a galacto-oligosaccharide having a DP of two to 12. The galacto-oligosaccharide can have a DP of two to six comprising at least 50% of the galacto-oligosaccharide having a DP of two to 12. The second oligosaccharide can be malto-oligosaccharide having a DP of two to 12. The malto-oligosaccharide can have a DP of two to six comprising at least 50% of the malto-oligosaccharide having a DP of two to 12. The second oligosaccharide can be mixed-linkage glucan-oligosaccharide having a DP of two to 12.

The mixed-linkage glucan-oligosaccharide can have a DP of two to six comprising at least 50% of the mixed-linkage glucan-oligosaccharide having a DP of two to 12. The second oligosaccharide can be sucrose, lactose and/or maltose. The composition can comprise a third oligosaccharide component, the third oligosaccharide component comprising a third oligosaccharide having a DP of two to 12, the third oligosaccharide not being cello-oligosaccharide and not being the same type of oligosaccharide as the second oligosaccharide. The weight ratio of the first oligosaccharide to the second oligosaccharide can be 9:1 to 1:9. The composition can further comprise a pH regulator.

The pH regulator can comprise at least one of sorbic acid, acetic acid, benzoic acid, propionic acid, adipic acid, ammonium aluminum sulfate, ammonium bicarbonate, ammonium carbonate, ammonium citrate, dibasic, ammonium citrate monobasic, ammonium hydroxide, ammonium phosphate, dibasic, ammonium phosphate, monobasic, calcium acetate, calcium acid pyrophosphate, calcium carbonate, calcium chloride, calcium citrate, calcium fumarate, calcium gluconate, calcium hydroxide, calcium lactate, calcium oxide, calcium phosphate (dibasic), calcium phosphate (monobasic), calcium phosphate (tribasic), calcium sulfate, carbon dioxide, citric acid, cream of tartar, fumaric acid, gluconic acid, glucono-delta-lactone, hydrochloric acid, lactic acid, magnesium carbonate, magnesium citrate, magnesium fumarate, magnesium hydroxide, magnesium oxide, magnesium phosphate, magnesium sulfate, malic acid, manganese sulfate, metatartaric acid, phosphoric acid, potassium acid tartrate, potassium aluminum sulfate, potassium bicarbonate, potassium carbonate, potassium chloride, potassium citrate, potassium fumarate, potassium hydroxide, potassium lactate, potassium phosphate (dibasic), potassium phosphate (tribasic), potassium pyrophosphate (tetrabasic), potassium sulfate, potassium tartrate, potassium tripolyphosphate, sodium acetate, sodium acid pyrophosphate, sodium acid tartrate, sodium aluminum phosphate, sodium aluminum, sulfate, sodium bicarbonate, sodium bisulfate, sodium carbonate, sodium citrate, sodium fumarate, sodium gluconate, sodium hexametaphosphate, sodium hydroxide, sodium lactate, sodium phosphate (dibasic), sodium phosphate (monobasic), sodium phosphate (tribasic), sodium potassium hexametaphosphate, sodium potassium tartrate, sodium potassium tripolyphosphate, sodium pyrophosphate (tetrabasic), sodium tripolyphosphate, sulfuric acid, sulfurous acid, tartaric acid, a salt thereof, or a combination thereof. The pH regulator can comprise at least one of lemon juice, baking powder, or baking soda. The amount of the pH regulator can be 0.01 dry wt. % to 10 dry wt. % of an amount of the cello-oligosaccharide and the second oligosaccharide. The composition can have a pH of 1 to 8 when dispersed in water. The composition can have a pH of 2 to 7 when dispersed in water. The composition can have a pH of 3 to 7 when dispersed in water. The composition can have a pH of 3 to 6 when dispersed in water.

The composition can be an aqueous solution which, when boiled, the boiling point of the aqueous solution is greater than 100° C. before drying out. The boiling point of the aqueous solution can be greater than 105° C., 110° C., 120° C., 130° C., 140° C., 150° C., 160° C., or 170° C. before drying out. The composition can further comprise an amino acid, a peptide, or a protein. The composition can further comprise lignin, a lignol, or a lignin breakdown product. The composition can further comprise a mineral salt. The composition can further comprise a fat. The composition can further comprise Maillard products of at least one of the cello-oligosaccharide and the second oligosaccharide. The composition can further comprise caramelization products of at least one of the cello-oligosaccharide and the second oligosaccharide.

The one or more non-enzymatic reaction breakdown products can comprise at least one of a deoxyosone, an osulose, a furan-2-aldehyde, a two-carbon alpha-dicarbonyl compound, a two-carbon hydroxycarbonyl compound, a three-carbon alpha-dicarbonyl compound, a three-carbon hydroxycarbonyl compound, a four-carbon alpha-dicarbonyl compound, a four-carbon hydroxycarbonyl compound, a glycoxal, a glycolaldehyde, a glycosylamine, a deoxyglycosyl amino acid, a deoxyglycosyl peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, a caramelan, a caramelen, a caramelin, a volatile compound, a diacetyl, or a combination thereof. The one or more non-enzymatic reaction breakdown products can comprise at least one of glucosyl, cellobiosyl derivatives of a deoxyosone, cellotriosyl derivatives of a deoxyosone, an osulose, a furan-2-aldehyde, a two-carbon alpha-dicarbonyl compound, a two-carbon hydroxycarbonyl compound, a three-carbon alpha-dicarbonyl compound, a three-carbon hydroxycarbonyl compound, a four-carbon alpha-dicarbonyl compound, a four-carbon hydroxycarbonyl compound, a glycoxal, a glycolaldehyde, a glycosylamine, a deoxyglycosyl amino acid, a deoxyglycosyl peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, a caramelan, a caramelen, a caramelin, a volatile compound, a diacetyl, or a combination thereof.

The one or more non-enzymatic reaction breakdown products can comprise at least one of xylosyl, xylobiosyl derivatives of a deoxyosone, xylotriosyl derivatives of a deoxyosone, an osulose, a furan-2-aldehyde, a two-carbon alpha-dicarbonyl compound, a two-carbon hydroxycarbonyl compound, a three-carbon alpha-dicarbonyl compound, a three-carbon hydroxycarbonyl compound, a four-carbon alpha-dicarbonyl compound, a four-carbon hydroxycarbonyl compound, a glycoxal, a glycolaldehyde, a glycosylamine, a deoxyglycosyl amino acid or peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, a caramelan, a caramelen, a caramelin, a volatile compound, a diacetyl, or a combination thereof.

The one or more non-enzymatic reaction breakdown products can comprise at least one of mannosyl, mannobiosyl derivatives of a deoxyosone, mannotriosyl derivatives of a deoxyosone, an osulose, a furan-2-aldehyde, a two-carbon alpha-dicarbonyl compound, a two-carbon hydroxycarbonyl compound, a three-carbon alpha-dicarbonyl compound, a three-carbon hydroxycarbonyl compound, a four-carbon alpha-dicarbonyl compound, a four-carbon hydroxycarbonyl compound, a glycoxal, a glycolaldehyde, a glycosylamine, a deoxyglycosyl amino acid, a deoxyglycosyl peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, a caramelan, a caramelen, a caramelin, a volatile compound, a diacetyl, or a combination thereof.

The one or more non-enzymatic reaction breakdown products in the composition can be less than 20% of the cello-oligosaccharide and the second oligosaccharide in the composition on a w/w basis. Cellobiose can comprise 50% to 100% of the cello-oligosaccharide. Cellotriose can comprise 0.1% to 20% of the cello-oligosaccharide. Cellotetraose can comprise 0.1% to 20% of the cello-oligosaccharide. The second oligosaccharide can comprise a side chain. The composition can further comprise arabinose-containing oligosaccharides. The composition can further comprise glucuronic acid-containing oligosaccharides. The composition can further comprise less than 20 dry wt. %, or 10 dry wt. % monosaccharides. The composition can comprise at least 1 dry wt. % monosaccharides. The composition can comprise glucose, fructose or galactose. The composition can comprise 1 dry wt. % to 60 dry wt. % disaccharides. The composition can comprise less than 50 dry wt. % sucrose, lactose, and maltose. The composition can comprise less than 20 dry wt. % sucrose.

The composition can comprise 0.1 dry wt. % to 30 dry wt. % trisaccharides. The composition can comprise 0.01 dry wt. % to 25 dry wt. % tetrasaccharides. The composition can comprise 0.01 dry wt. % to 20 dry wt. % pentasaccharides. The composition can comprise 0.01 dry wt. % to 20 dry wt. % hexasaccharides. At least one of the cello-oligosaccharide and the second oligosaccharide can be chemically modified. The at least one of the cello-oligosaccharide and the second oligosaccharide can be chemically modified by an oxidation reaction, reduction reaction, caramelization, or the Maillard reaction. The composition can comprise 50 dry wt. % to 99 wt. % saccharides. The composition can comprise oligosaccharides having a DP of two to 20 comprising 25 dry wt. % to 90 dry wt. % of the composition. The composition can further comprise polysaccharide. The can comprise greater than 1 dry wt. %, 2 dry wt. %, 3 dry wt. %, 4 dry wt. %, 5 dry wt. %, 6 dry wt. %, 7 dry wt. %, dry wt. 8%, 9 dry wt. %, or 10 dry wt. % of the polysaccharide. The composition can comprise less than 60 dry wt. %, 50 dry wt. %, 40 dry wt. %, 30 dry wt. %, 25 dry wt. %, 20 dry wt. %, 17.5 dry wt. %, 15 dry wt. % of the polysaccharide.

The composition can further comprise ash at less than 5 dry wt. %. The composition can further comprise phenolic material. The phenolic material can be lignin. The composition can further comprise organic acids, mineral acids, bases, neutralizing agents, or buffering agents. The organic acids can be oxalate and formate. The composition can comprise a specific hardness of 0.01 N/mm² to 0.5 N/mm². The composition can comprise one type of monosaccharide. The composition can comprise two types of monosaccharide. The monosaccharide can comprise fructose, glucose, or a combination thereof. The solubility of first mass of the cello-oligosaccharide and the second oligosaccharide can be greater than the solubility of the first mass of the cello-oligosaccharide alone. The composition can be a syrup. The composition can be a caramel. The composition can be a hard candy. The composition can be a jam, a jelly, or a preserve. The composition can be disposed in a cosmetic, a foodstuff, or a nutraceutical. The non-enzymatic reaction breakdown products can be greater than 0.1 wt. % of the first oligosaccharide. The non-enzymatic reaction breakdown products can be greater than 0.1 wt. % of the second oligosaccharide.

Disclosed herein is a candy comprising: a first oligosaccharide component, the first oligosaccharide component comprising cello-oligosaccharide having a degree of polymerization (DP) of two to six, the cello-oligosaccharide comprising 1 dry wt. % to 50 dry wt. % of the caramel; and a second oligosaccharide component, the second oligosaccharide component comprising a second oligosaccharide having a DP of two to 12, the second oligosaccharide not being cello-oligosaccharide; the candy comprising greater than 50 dry wt. % saccharides and less than 40 dry wt. % monosaccharides, and the caramel comprising non-enzymatic reaction breakdown products of at least one of the cello-oligosaccharide and the second oligosaccharide.

Disclosed herein is a consumable composition comprising: a first oligosaccharide component, the first oligosaccharide component comprising cello-oligosaccharide having a degree of polymerization (DP) of two to six, the cello-oligosaccharide comprising 1 dry wt. % to 50 dry wt. % of the consumable composition; and a second oligosaccharide component, the second oligosaccharide component comprising a second oligosaccharide having a DP of two to 12, the second oligosaccharide not being cello-oligosaccharide; the consumable composition having a consistency of sucrose in a soft ball stage. A ratio of the second oligosaccharide to the cello-oligosaccharide can be 80:20 to 60:40.

Disclosed herein is a consumable composition comprising: a first oligosaccharide component, the first oligosaccharide component comprising cello-oligosaccharide having a degree of polymerization (DP) of two to six, the cello-oligosaccharide comprising 1 dry wt. % to 50 dry wt. % of the consumable composition; and a second oligosaccharide component, the second oligosaccharide component comprising a second oligosaccharide having a DP of two to 12, the second oligosaccharide not being cello-oligosaccharide; the consumable composition having a consistency of sucrose in a hard ball stage. A ratio of the second oligosaccharide to the cello-oligosaccharide can be 80:20 to 60:40.

Disclosed herein is a method of making a foodstuff, the method comprising: providing a composition comprising: a first oligosaccharide component, the first oligosaccharide component comprising cello-oligosaccharide having a degree of polymerization (DP) of two to six; and a second oligosaccharide component, the second oligosaccharide component comprising a second oligosaccharide having a DP of two to 12, the second oligosaccharide not being cello-oligosaccharide, and the composition having a first pH; adjusting the pH of the composition from the first pH to a second pH, the second pH being 3 to 7; and heating the composition having the second pH to greater than 100° C. The composition can comprise 5 dry wt. % to 25 dry wt. % cellobiose. The second oligosaccharide can comprise a xylo-oligosaccharide having a DP of two to 12. Step (b) can comprise adjusting the composition from the first pH to a third pH, the third pH being 4 to 7. The ratio of the cello-oligosaccharide to the second oligosaccharide can be 75:25 to 65:35.

Step (c) can comprise heating the composition to at most 177° C. The foodstuff can be a baked good. The foodstuff can be a confectionery product. The confectionery product can be a fudge, a caramel, a nougat, a taffy, or a toffee. The method can further comprise (d) maintaining the heat for a time period sufficient to achieve a predetermined sugar stage. Step (d) can comprise heating the composition to from 110° C. to 112° C. such that the composition has a consistency of sucrose in a thread stage. Step (d) can comprise heating the composition to from 112° C. to 116° C. such that the composition has a consistency of sucrose in a soft ball stage. Step (d) can comprise heating the composition to from 118° C. to 120° C. such that the composition has a consistency of sucrose in a firm ball stage. Step (d) can comprise heating the composition to from 121° C. to 130° C. such that the composition has a consistency of sucrose in a hard ball stage. Step (d) can comprise heating the composition to from 133° C. to 143° C. such that the composition has a consistency of sucrose in a soft crack stage. Step (d) can comprise heating the composition to from 146° C. to 154° C. such that the composition has a consistency of sucrose in a hard crack stage. Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIGS. 1A-1D show images captured during the heating of xylo-oligosaccharides (XOS) at pH 7 and 100° C. (FIG. 1A), pH 7 and 177° C. (FIG. 1B), pH 2 and 150° C. (FIG. 1C), and pH 9 and 177° C. (FIG. 1D).

FIGS. 2A-2D show images captured during the heating of cello-oligosaccharides (COS) at a concentration of 1 g/g at pH 7, which did not reach over 100° C. (FIG. 2A); at a concentration of 0.1 g/g at pH 7, which solidified at 101° C. (FIG. 2B); at a concentration of 0.1 g/g at pH 2 and 177° C. (FIG. 2C); and at a concentration of 0.1 g/g at pH 9 and 177° C. (FIG. 2D).

FIG. 3 shows the degradation of cello-oligosaccharide after heating at various temperatures and pH levels.

FIG. 4 shows the degradation of sucrose after heating at various temperatures and pH levels.

FIG. 5 shows the degradation of a XOS and COS blend after heating at various temperatures and pH levels.

FIG. 6 shows the degradation of a XOS and COS blend after heating at various temperatures and pH levels.

FIG. 7 shows the amounts of certain organic acids present in a XOS and COS blend after heating at various temperatures and pH levels.

FIG. 8 shows the degradation of sugars present in XOS:COS combinations at 110° C., pH 7.

FIG. 9 shows a series of images of various XOS:COS combinations after heating to 100° C.

FIG. 10 shows the degradation of sugars present in XOS:COS combinations at 177° C., pH 7.

FIG. 11 shows the degradation of sugars present in XOS:COS combinations at 177° C., pH 3.

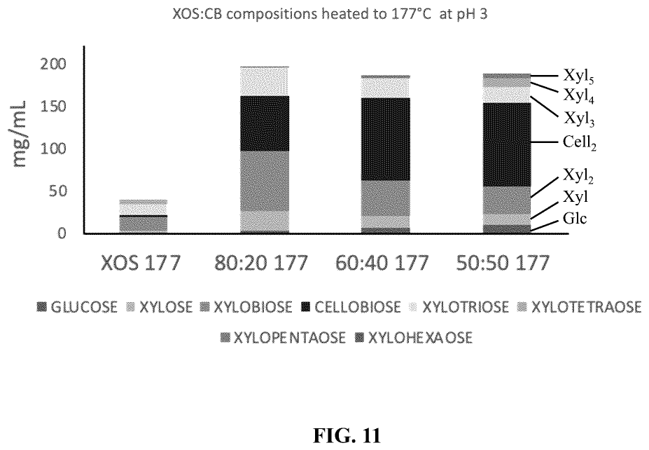

FIG. 12 shows a series of images of various XOS:COS combinations after heating to various candy stages.

FIG. 13A shows the amount of evaporated water produced from various samples of XOS:COS mixtures after heating at pH 7 to 120° C., pH 7 to 177° C., and pH 4 to 177° C.

FIG. 13B shows the amount of evaporated water produced from various samples of other oligosaccharides with COS at pH 7 and 120° C., and pH 7 and 177° C.

FIG. 14 shows the browning produced from various samples of XOS:COS mixtures after heating at pH 7 to 120° C., and to 177° C.

FIG. 15 shows the relationship between boiling point and specific hardness of candy compositions made with sucrose and with XOS:COS compositions. Approximate lines of best fit are shown as dotted lines.

FIG. 16 shows HPLC traces for XOS and COS compositions used in FIGS. 1-15.

FIG. 17 shows a HPLC trace for a different XOS:COS composition comprising a different range with more larger COS (such as cellotriose and cellotetraose), more monosaccharides, more substituted XOS and more monosaccharides, than the XOS:COS compositions analysed in FIGS. 1-16. This sample was subsequently heated and at pH 7 to 120° C. and evaporated water produced was measured.

FIG. 18 shows colour development over a range of temperatures for heated solutions of 80:20 oligosaccharide mixtures (XOS:COS, diamond; FOS:COS, triangle) and sucrose (square) in water.

FIG. 19 shows concentrations (ppb) of volatiles (A) furfural and (B) 5-hydroxymethylfurfural in headspace of solutions of 80:20 oligosaccharide mixtures (XOS:COS, diamond; FOS:COS, triangle) and sucrose ( ) in water, over a range of temperatures (° C.)

FIG. 20 shows darkening of solutions containing example mixtures due to products of a Maillard reaction.

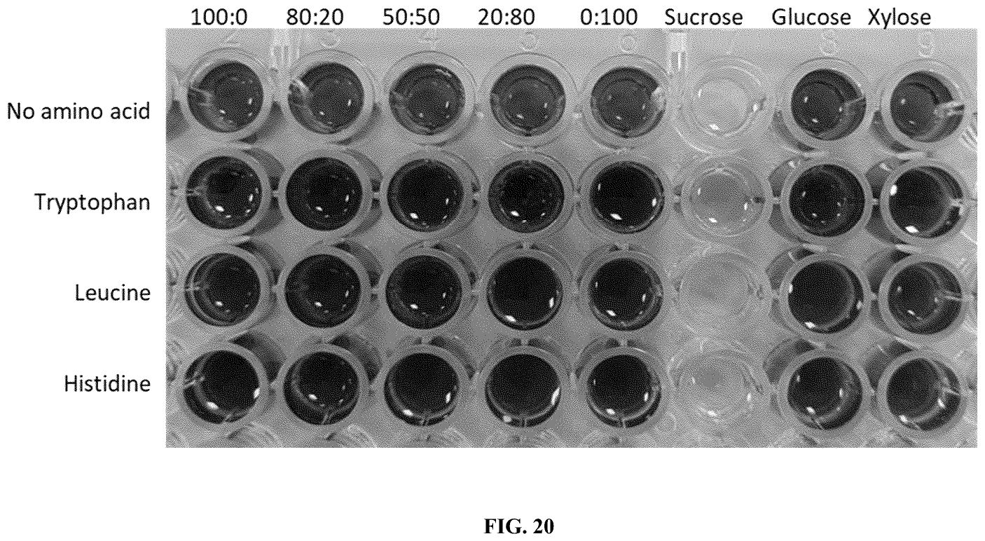

FIG. 21 illustrates an example showing that compositions described herein can be used to produce caramelized food products similar in texture, and viscosity to products made using sucrose.

FIG. 22 illustrates a caramel made with sucrose (A) and with the XOS:COS:MCC composition shown in FIG. 21 (B).

FIG. 23A shows relative amount of saccharides in solutions of XOS (100:0), COS (0:100), sucrose and mixtures of XOS:COS (90:10-20:80) before heating.

FIG. 23B shows relative amount of saccharides in solutions of XOS (100:0), COS (0:100), sucrose and mixtures of XOS:COS (90:10-20:80) after heating (A) and after heating to 110° C. (B) at pH 7 in a closed system.

FIG. 24 shows relative amount of saccharides in solutions of XOS (100:0), COS (0:100), sucrose and mixtures of XOS:COS (90:10-20:80) after heating to 177° C. at pH 7. Less oligosaccharide (Xylobiose, X3, X4, X5, X6, A3X, XA3XX, Cellobiose) degradation in mixtures of XOS:COS is observed. The relative amount of monosaccharides in the 100:0 and 0:100 sample not being the relative amount expected based on amount of oligosaccharides left suggests that the reaction is even further into the degradation pathways as the monosaccharides are converted into flavour and colour compounds. The relative amount of oligosaccharides left being highest in mixed ratios, specifically 80:20 is nutritionally favourable as oligosaccharides do not degrade into monosaccharides as easily, but there are still enough monosaccharides present for caramelisation to occur for colour and flavour development.

FIG. 25A shows relative amount of saccharides in solutions of sucrose, XOS (100:0), COS (0:100) and mixtures of XOS:COS (90:10-20:80) before heating.

FIG. 25B shows relative amount of saccharides in solutions of sucrose, XOS (100:0), COS (0:100) and mixtures of XOS:COS (90:10-20:80) after heating to 177° C. at pH 9. At pH 9, degradation of oligosaccharides is more similar across the different ratios. Under alkaline conditions it is expected that caramelization reaction rates are fastest and hence more degradation than at neutral pH. Where there is minimal increase in monosaccharides (xylose, glucose), it is expected that the monosaccharides have been degraded further into flavor and color compounds.

FIG. 26A shows relative amount of saccharides in solutions of sucrose, XOS (100:0), COS (0:100) and mixtures of XOS:COS (90:10-20:80) before heating.

FIG. 26B shows relative amount of saccharides in solutions of sucrose, XOS (100:0), COS (0:100) and mixtures of XOS:COS (90:10-20:80) after heating to 177° C. (B) at pH 3.

FIG. 27 illustrates non-enzymatic breakdown products of example flavoring precursor compositions described herein.

### DETAILED DESCRIPTION

Industry has been searching for low calorie sweeteners. However, one issue that often arises with the low calorie sweeteners, which have been developed, is that they lend only sweetness and often only lend sweetness at room temperature. Sugar lends or provides a variety of textural components to many candies, baked goods, and other foods, and many of the required processes to develop these textural component involve the application of heat. Of particular importance is the ability of sugar to caramelize. Thus, it is desirable that a low calorie sweetener mimics the changes which occur when sugar is heated to various temperatures.

This disclosure describes a mixture of xylooligosaccarides (XOS) and cellooligosaccharides (COS), in some cases cellobiose (CB), which have been found to have similar reactions to heat as sucrose. Specifically, the mixtures of XOS and COS may caramelize in a manner similar to sucrose.

Described herein are saccharide compositions that can be useful in foodstuff, cosmetic, or nutraceutical products. Some embodiments of the present disclosure additionally offer such foodstuff, cosmetic, or nutraceutical products with novel properties. The saccharide compositions may be consumable compositions including cello-oligosaccharides, xylo-oligosaccharides, and/or mannan-oligosaccharides. Such consumable compositions may be used as sweeteners (e.g., in a foodstuff), binders, and/or fiber content enhancers.

Provided herein are various compositions. The compositions can include a first oligosaccharide component, for example, a cello-oligosaccharide having a degree of polymerization (DP) of two to six (wherein the cello-oligosaccharide having a DP of two to six comprises a single DP or a mixture of DP within the two to six range). The composition can also include a second oligosaccharide component, for example, a second oligosaccharide having a DP of two to 12, wherein the second oligosaccharide is not cello-oligosaccharide (wherein the second oligosaccharide having a DP of two to 12 comprises a single DP or a mixture of DP within the two to 12 range). In certain cases, the second oligosaccharide may be a xylo-oligosaccharide having a DP of two to 12. In various cases, the second oligosaccharide may be a mannan-oligosaccharide having a DP of two to 12.

In some instances, the composition may include non-enzymatic reaction breakdown products (e.g. non-enzymatic browning reaction products, Maillard products and/or caramelization products) of at least one of the cello-oligosaccharide and the second oligosaccharide. The compositions may include ash.

The compositions may be a syrup, a caramel, a hard candy, a jam, a jelly, a preserve, or any other suitable foodstuff. The composition may be disposed in a cosmetic or a nutraceutical.

Methods of making a foodstuff are also provided herein. The methods can include providing a composition as described herein. A pH of the composition may be adjusted (e.g., from a first pH to a second pH). The methods can include heating the composition (e.g., the composition having the second pH) to greater than 100° C. In some cases, the heat may be maintained for a time period sufficient to achieve a predetermined sugar stage (e.g., a thread stage, softball stage, firm ball stage, hard ball stage, soft crack stage, or hard crack stage).

As used in the specification and claims, the singular forms “a,” “an,” and “the” include plural references unless the context clearly dictates otherwise. For example, the term “a sample” includes a plurality of samples, including mixtures thereof.

The term “about,” as used herein, can mean within 1 or more than 1 standard deviation. Alternatively, about can mean a range of up to 10%, up to 5%, or up to 1% of a given value. For example, “about” can mean up to ±10% of a given value. In more targeted instances, “about” can mean±9%, ±8%, ±7%, ±6%, ±5%, ±4%, ±3%, ±2%, or ±1% of a given value.

As used herein, “food” and “foodstuff” generally refer to any item destined for consumption, which may be consumption by a human or by any other animal. It may be food, feed, beverage, or an ingredient to be used in the production of any of the above.

As used herein, “nutraceutical” generally refers to any composition introduced into a human or other animal, whether by ingestion, injection, absorption, or any other method, for the purpose of providing nutrition to the human or other animal. Use of such a nutraceutical may take the form of a drink with added dietary fiber, a prebiotic additive, a pill or other capsule, or any other suitable use.

As used herein, “cosmetic” generally refers to any composition which is intended for use on humans or other animals to increase their aesthetic appeal or prevent future loss of aesthetic appeal, as well as any other compositions known in general parlance as cosmetics. Aesthetic appeal is not limited to visual aesthetics but applies as well to textural or any other appeal. The cosmetic may be mascara, foundation, lip gloss, eyeshadow, eyeliner, primer, lipstick, blush, nail polish, bronzer, or any other makeup; shampoo, conditioner, styling mousse, styling gel, hairspray, hair dye, hair wax, or any other hair product; moisturizer, exfoliant, sun cream, cleanser, toothpaste, cream, lotion, ointment, or any other composition effective in modifying teeth, skin, hair, or other parts of the body in some aesthetic way. Further, the cosmetic may be a composition used as a component of a face mask, brush, hair roller, other styling device, other solid structure, or any other suitable composition.

As used herein, “candy” generally refers to any composition which is intended for human consumption as is traditionally sweet-tasting. Alternative terms for candy include sweets, confections or confectionary. Types of candy include hard candy, brittles, gummy bears, fudge, chocolates, cream candies, caramels, bonbons, jaw breakers, bon bons, brittle candy, bubble gum, candy bars, candy buttons, candy canes, candy-coated popcorn, candy-coated fruits, candy-coated nuts, candy-coated chocolate, candy coating, candy corn, candy favors, candy melts, candy sprinkles & toppings, candy sticks, candy straws, caramels, chewy candy, chewing gum, chocolate, cotton candy, fizzies, fruit drops, fruit pastilles, ginger bites, gumballs, gumdrops, gummy, hard candy, hard boiled sweets, jelly beans, jelly candy, jordan almonds, licorices, liquid & spray candy, lollipops, suckers, malt balls, toffee, cinder toffee, marshmallows, mellowcreme, mints, extra strong mints, nonpareil candy, nougat, peanut candy, pearls candy, pinata candy, powder & particle candy, raisins candy, ribbon candy, rice crispy candy, rock candy, spicy candy, squeeze candy, sweet tarts candy, swizzle sticks, taffy, toffee candy, vegan candy, wafers, biscuits, cookies, pastries, cakes, cream cakes, sponges, crème caramel, crepe suzette, custard cream, macaron, mousse, praline, French fancies, shortbread, petit four, wax candy, stick candy, lemon drops, horehound drops, open-fire candy, molasses taffy, cream taffy, pan work candies, jelly babies, sugar-coated nuts, jams, jellies, preserves, gum work candy, gum drops, and syrups.

As used herein, “ingredient” generally refers to any composition suitable for incorporation into a foodstuff, cosmetic, or nutraceutical product, which may include those which are used directly as the product itself. It may be a dry or liquid ingredient, unless it is specifically referred to as “dry” or “liquid.” This includes compositions that may be deemed to be an intermediate during a method of the disclosure, such as a composition formed after the combining of the one or more oligosaccharides and the one or more soluble polysaccharides prior to any further purification, optimization, drying, dissolving, or any other such steps, as well as including the final composition obtained from the method.

As used herein, “polysaccharide” generally refers to a saccharide polymer of any length greater than 20 residues. Polysaccharides may be highly branched, lightly branched, or unbranched. Polysaccharides may include any manner of glycosidic bond in any combination; any number of, for example, α or β linkages; and any combination of monomer types, such as glucose, glucosamine, mannose, xylose, galactose, fucose, fructose, glucuronic acid, arabinose, or derivatives thereof, such as any combination of the above monomers decorated with acetyl or other groups. The polysaccharide may be a cellulosic or hemicellulosic polymer. Hemicellulosic polymers envisaged include xylan, glucuronoxylan, arabinoxylan, glucomannan, and xyloglucan. In some embodiments, the cellulosic polymer may be cellulose.

As used herein, “lignocellulose” generally refers to polysaccharide-comprising aggregates that are, or are derived from, plant cell wall material. For example, they may include one or more of the following polysaccharides associated together: cellulose, xylan, mannan, and mixed-linkage glucan.

As used herein “highly branched,” “lightly branched,” and “unbranched” generally refer to the number of side-chains per stretch of main chain in a saccharide. Highly branched saccharides have on average 4 to 10 side chains per 10 main-chain residues, slightly branched saccharides have on average 1 to 3 side chains per 10 main-chain residues, and unbranched saccharides have only one main chain and no side chains. The average is calculated by dividing the number of side chains in a saccharide by the number of main-chain residues.

As used herein, “saccharide” generally refers to any polysaccharide and/or oligosaccharide, such as a monosaccharide and/or a disaccharide.

As used herein, “oligosaccharide” generally refers to saccharide polymers having chain lengths less than or equal to 20 saccharide residues (e.g., and at least two saccharide residues). Oligosaccharides may be highly branched, lightly branched, or unbranched; and may include glycosidic bonds in any combination, any number of a or R linkages, and any combination of monomer types, such as glucose, glucosamine, mannose, xylose, galactose, fucose, fructose, glucuronic acid, arabinose, or derivatives thereof. Suitable derivatives include the above monomers including acetyl or other groups.

As used herein, “monosaccharide” and “disaccharide” generally refer to saccharide compounds consisting of one or two residues, respectively. Monosaccharides are compounds such as glucose, glucosamine, xylose, galactose, fucose, fructose, glucuronic acid, arabinose, galacturonic acid, or epimers or other derivatives thereof. Suitable derivatives include acetyl or other groups. Disaccharides are compounds consisting of two monosaccharides joined via any glycosidic bond.

As used herein, “cello-oligosaccharides” (COS) generally refer to oligosaccharides composed of one or more glucose residues linked by β-1,4-glycosidic bonds, and may be chemically related to that by oxidation, reduction, esterification, epimerization, or another chemical modification.

As used herein, “flavoring precursor” refers to a composition, which, when acted on by a non-enzymatic breakdown process (e.g. heating, combusting, pyrolyzing, curing, etc.) produces one or more non-enzymatic breakdown products which are associated with imparting specific flavors to a food product.

As used herein, “cooked food product” refers to any food product that is produced from a raw material, composition, or mixture of materials and compositions which has been subject to heating or curing by baking, frying, irradiating (e.g. microwaving, exposing to intense infrared or UV light, etc), boiling, or otherwise heating the raw material, composition, or mixture of materials and compositions to impart enough energy to cause one or more chemical reactions to occur therein.

As used herein, “xylo-oligosaccharides” (XOS) generally refer to oligosaccharides composed primarily of xylose residues (typically linked by β-1,4-glycosidic bonds) and may also include glucuronic acid residues and/or arabinose residues and/or acetyl groups and/or any other modification, and may be chemically related to that by oxidation, reduction, esterification, epimerization, further glycosylation, or another chemical modification.

As used herein, “mannan-oligosaccharides” (MOS) generally refer to oligosaccharides composed of one or more mannose residues and optionally containing one or more glucose and/or galactose residues, and may be chemically related to that by oxidation, reduction, esterification, epimerization, or another chemical modification.

As used herein, “fructo-oligosaccharides” (FOS) generally refer to oligosaccharides composed of one or more fructose residues, and may be chemically related to that by oxidation, reduction, esterification, epimerization, or another chemical modification.

As used herein, “galacto-oligosaccharides” (GOS) generally refer to oligosaccharides composed of one or more galactose residues and optionally containing one or more glucose residues, and may be chemically related to that by oxidation, reduction, esterification, epimerization, or another chemical modification.

As used herein, “malto-oligosaccharides” or “maltodextrins” (MD) generally refer to oligosaccharides composed of one or more glucose residues linked by at least one alpha-bond, and may be chemically related to that by oxidation, reduction, esterification, epimerization, or another chemical modification.

As used herein, “mixed-linkage glucan-oligosaccharides” (MLGOS) generally refer to oligosaccharides composed of one or more glucose residues linked by at least one β-1,3-glycosidic bond and at least one β-1,4-glycosidic bond, and may be chemically related to that by oxidation, reduction, esterification, epimerization, further glycosylation, or another chemical modification.

As used herein, “cellulose” generally refers to polysaccharides composed of glucose residues linked by β-1,4-glycosidic bonds, and derivatives thereof. As used herein, “xylan” generally refers to polysaccharides composed of a backbone of xylose residues and may also contain glucuronic acid residues and/or arabinose residues and/or acetyl groups and/or any other modification. As used herein, “mannan” generally refers to polysaccharides composed of greater than 40% mannose residues and optionally containing glucose and/or galactose residues. The polysaccharides of cellulose, xylan, or mannan may include chemical variants that have been modified by oxidation, reduction, esterification, epimerization, or another chemical modification.

As used herein, “non-enzymatic reaction breakdown products” generally refers to products from non-enzymatic reactions typically associated with breakdown of compounds into smaller compounds. Of particular interest are thermally catalysed reactions, for example the non-enzymatic reactions that occur in the processing of food, feed, nutraceutical and cosmetic products. One envisaged type of non-enzymatic reaction is caramelization. Another envisaged type of non-enzymatic reaction is the thermal or non-thermal decomposition of a flavoring precursor compound to one or more flavoring compounds.

The physical, chemical, and nutritional properties of an ingredient can be a product of the ingredient's chemical structure. As such, it may be desirable that the ingredients used in food products behave in a predictable manner when subjected to conditions present in food manufacture (e.g., application of heat). This predictability may include stability under food processing conditions. In some cases, compounds that are unstable under certain food processing conditions may be unable to impart desired physical, chemical, and nutritional properties on food products that are manufactured using said conditions.

Generally, cello-oligosaccharides are renewable, healthy, and readily available non-digestible disaccharides that can be used as food ingredients. For example, cello-oligosaccharides can be used as a sugar replacement. Cello-oligosaccharides can have bulking, browning, and sweetening properties (e.g., in the foodstuffs in which they are incorporated). However, many sucrose applications, such as candy and caramel manufacture, require heating to temperatures above 100° C., and cello-oligosaccharides are generally unable to undergo boiling point elevation like sucrose can.

Xylo-oligosaccharides and cello-oligosaccharides alone may be unstable under conditions commonly used in food processing, for example, heating above 100° C. at pH ranges of 3-7. However, combinations of xylo-oligosaccharides and cello-oligosaccharides may survive such conditions.

This disclosure describes combining xylo-oligosaccharides and cello-oligosaccharides to form a mixture. This mixture may allow the xylo-oligosaccharides and/or cello-oligosaccharides to survive conventional food processing conditions and impart their physical, chemical, and nutritional properties on finished food products. Similarly, the addition of xylo-oligosaccharides to cello-oligosaccharides may allow the cello-oligosaccharide to degrade less in conventional food processing conditions and impart their physical, chemical, and nutritional properties on finished food products.

By adding other oligosaccharides, such as xylo-oligosaccharides, to cello-oligosaccharides, the resulting boiling point elevation may enable formation of candy stages and caramelization that would otherwise not be possible. Further, certain mixtures may mimic the physical and/or chemical properties of sucrose, as measured by the physical properties of the candy stages.

Sugar, or sucrose, moves through a number of candy stages when heated. This ability is a core function of sugar in various food products. When a dilute solution of sugar (e.g., cane sugar) is heated in an aqueous solution, the initial boiling point is 100° C. As water evaporates due to boiling, the solution becomes more concentrated and the temperature of the boiling liquid rises. Once the boiling liquid reaches a temperature above 160° C., there is little water left in the liquid. As the boiling liquid reaches this point, the sugar concentrates in the solution. Further, the sugar undergoes chemical changes associated with caramelization. Candy stages are defined by the boiling temperature of the sugar solution and are associated with the sugar concentration and levels of caramelization. Table 1 describes the candy stages and associated characteristics of the sugar.

TABLE 1
Candy Stages of Sugar

| | | Approximate | | |
|---|---|---|---|---|
| | | Sugar | Approximate | |
| Stage | Temperature | Concentration | hardness | Characteristics |
| Thread | 110 to 112° C. | 80% | | The syrup drips |
| (e.g., | | | | from a spoon and |
| syrup) | | | | forms thin threads |
| | | | | in water. |
| Soft ball | 112 to 116° C. | 85% | | The syrup easily |
| (e.g., | | | | forms a ball while |
| fudge) | | | | in cold water but |
| | | | | flattens once |
| | | | | removed. |
| Firm ball | 118 to 120° C. | 87% | | The syrup is |
| (e.g., | | | | formed into a |
| soft caramel | | | | stable ball but |
| candy) | | | | loses its round |
| | | | | shape when |
| | | | | pressed. |
| Hard ball | 121 to 130° C. | 90% | 0.01-0.05 N/mm² | The syrup holds its |
| (e.g., | | | | ball shape when |
| nougat) | | | | pressed but |
| | | | | remains sticky. |
| Soft crack | 132 to 143° C. | 95% | 0.05-0.18 N/mm² | The syrup forms |
| (e.g., salt | | | | firm but pliable |
| water taffy) | | | | threads. |
| Hard crack | 146 to 154° C. | 99% | 0.21-0.31 N/mm² | The syrup forms |
| (e.g., | | | | brittle threads and |
| toffee) | | | | easily cracks and |
| | | | | snaps. |
| Clear liquid | 160° C. | 100% | 0.31-0.40 N/mm² | |
| Brown liquid | 170° C. | 100% | | |
| (e.g., liquid | | | | |
| caramel) | | | | |
| Burnt sugar | 177° C. | 100% | | |

This disclosure describes compositions of saccharides that are able to undergo browning reactions, such as caramelization. These compositions may be combinations of xylo-oligosaccharides (XOS) (e.g. xylobiose, xylotriose, xyltotetraose) and cello-oligosaccharides (COS) (e.g., cellobiose (CB), cellotriose, cellotetraose). These compositions can also be substantively stable during these reactions. Further, this disclosure describes compositions at pH ranges of 3-8, wherein these compositions do not degrade at high temperatures. In contrast, XOS and COS (e.g., pure XOS and COS) degrade significantly at high temperatures. These properties may allow the compositions described in this disclosure to form caramel, candy, etc. comprising XOS and COS combinations and lacking sugar (e.g., sucrose).

This disclosure provides compositions of saccharides wherein compositions comprising low XOS:COS ratios may not reach high temperatures which may be suitable for candy stages, while compositions with high XOS:COS ratios may be able to reach such high temperatures.

In some instances, the compositions of XOS and COS may include an acidity regulator. The acidity regulator may lower the pH, making the composition more acidic. The acidity regulator may be an acid, for example, lemon juice. The acidity regulator may raise the pH, making the composition more basic. The acidity regulator may be a base, for example, baking powder.

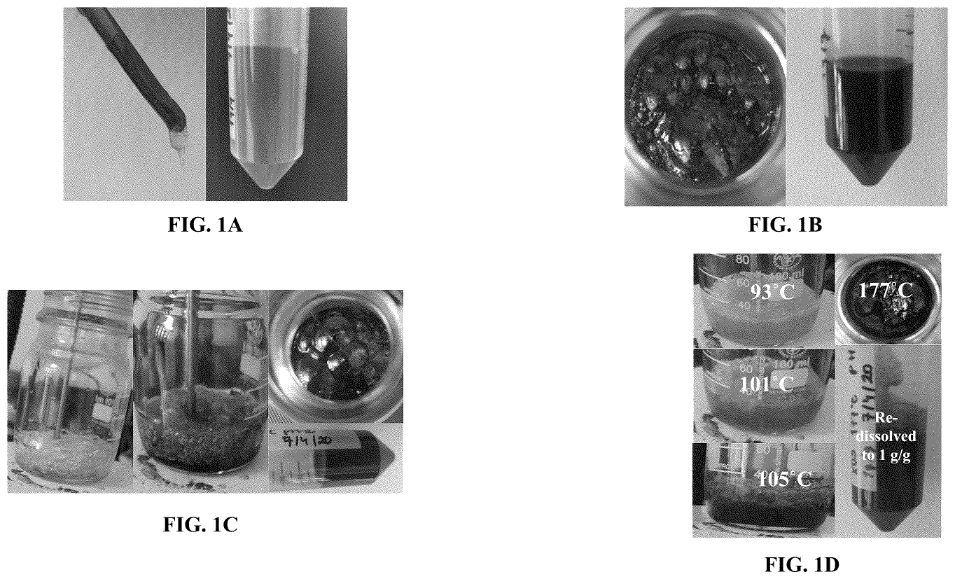

In a composition including XOS at pH 7, the composition may form soft sticky threads at 110° C. (FIG. 1A). The composition may comprise 15 g XOS and 15 g water. The composition may get very dark and smell burnt at 177° C. (FIG. 1B). The composition may get dark around 120° C., intensifying at 150° C., and forming hard crack at 177° C. The composition may comprise 10 g XOS and 10 g water.

In a composition including XOS at pH 2, the composition may start getting dark at 120° C. with intensifying dark color at 150° C. (FIG. 1C). The composition may comprise 10 g XOS, 2 g lemon juice, and 8 g water.

In a composition including XOS at pH 9, the composition may get dark around 94° C. and very dark around 105° C. (FIG. 1D). The composition may begin to boil at 55° C. The composition may comprise 10 g XOS, 1 g baking soda, and 9 g water.

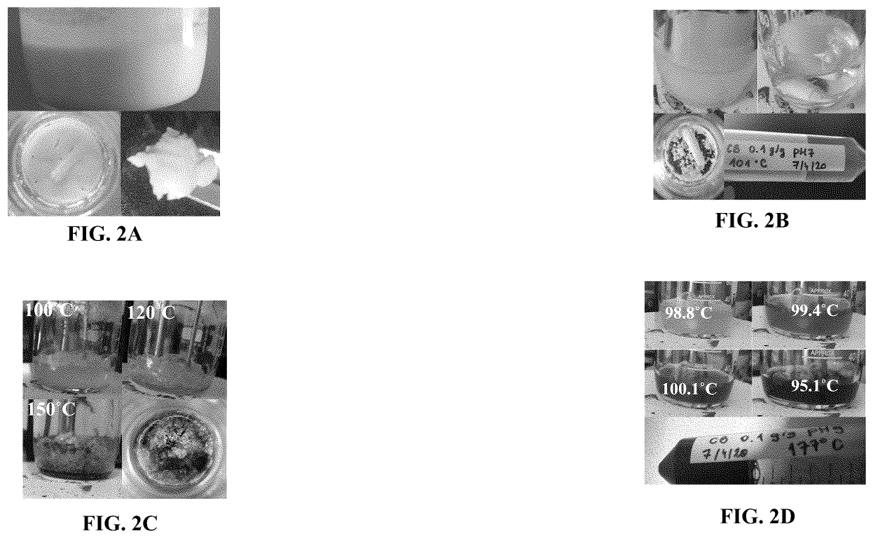

In a composition including COS at pH 7, the composition may dissolve at around 40° C., begin boiling at 95° C., and solidify completely at 101° C. (FIG. 2B). The composition may comprise 2 g COS and 20 g water.

In a composition including COS at pH 7, the composition may not be able to increase to 177° C. (FIG. 2A).

In a composition including COS at pH 2, the composition may remain at 98-99° C. for around 25 minutes with no color change (FIG. 2C). The composition may get dark around 120° C., with a darker color at 150° C. Around 177° C., the composition may form a hard crack like structure. The composition may comprise 1 g COS, 2 g lemon juice, and 18 g water.

In a composition including COS at pH 9, the composition may reach 177° C. and form a hard crack (FIG. 2D). The composition may comprise 2 g COS, 1 g baking soda, and 19 g water.

This disclosure describes mixtures of XOS and COS. In a composition, the ratio of XOS:COS may be 7:1. The composition may comprise a mixture of sugars including glucose, xylose, xylobiose, cellobiose, xylotriose, xylotetraose, xylopentaose, and xylohexaose. The composition may degrade with increasing heat and/or altered pH. The composition may comprise organic acids including oxalate, tartrate, malate, succinate, lactate, formate, acetate, or combinations thereof.

The mixture of XOS and COS may be in a ratio of 100:1 to 1:100, including at least 90:10, 85:15, 80:20, 75:25, 70:30, 65:35, 60:40, 55:45, 50:50, 45:55, 40:60, 35:65, 30:70, 25:75, 20:80, 15:85, and 10:90. The mixture of XOS and COS may be in a ratio of 100:1 to 90:10, 100:1 to 85:15, 100:1 to 80:20, 100:1 to 75:25, 100:1 to 70:30, 100:1 to 65:35, 100:1 to 60:40, 100:1 to 55:45, 100:1 to 50:50, 100:1 to 45:55, 100:1 to 40:60, 100:1 to 35:65, 100:1 to 30:70, 100:1 to 25:75, 100:1 to 20:80, 100:1 to 15:85, 100:1 to 10:90, 100:1 to 5:95, or 100:1 to 1:100.

Mixtures of XOS and COS may reach 110° C. Mixtures of XOS and COS including less than 0.8 g/g COS may not reach 110° C. Mixtures of XOS and COS at 110° C. may not show browning. Mixtures of XOS and COS from 100:1 to 65:35 may look similar to sucrose at 110° C. and may be a light transparent color. Mixtures of XOS and COS from 60:40 to 50:50 may not be transparent. Mixtures of XOS and COS from 40:60 to 1:100 may be white.

Mixtures of XOS and COS may reach 177° C. Mixtures with greater than 0.4 g/g COS may not reach 177° C. Mixtures with greater than 0.4 g/g COS may reach 177° C. when in combination with an acidity regulator. Mixtures of XOS and COS may not degrade at 177° C. as much as XOS and COS lacking an acidity regulator.

Mixtures of XOS and COS may be used to create candy stages (e.g., soft ball, firm ball, hard ball, soft crack, hard crack, etc.). Mixtures of XOS and COS in ratios from 75:25 to 65:35 may perform better (e.g., may be easier to handle, more like sucrose, etc.) than other ratios.

Mixtures of XOS and COS may have a higher boiling point than XOS or COS alone. Mixtures that include XOS and COS in ratios of 100:1 to 50:50 may be able to reach 120° C., while mixtures with lower levels of XOS (20:80 to 1:100) may not be able to reach 120° C. This may indicate that COS alone may not raise the boiling point, and it may be expected that at higher ratios (e.g., 50:50), the COS may impair the boiling point elevation compared to XOS alone. However, when the mixture includes less than 50% COS, the COS does not appear to impact the boiling point elevation, and therefore the COS has properties similar to XOS when in mixtures which are majority XOS.

Mixtures of XOS and COS may be used to create syrup, candy, bakery compositions, jams, jellies, spreads, or preserves. The mixtures of XOS and COS in these compositions may be greater than 10% dry w/w. The mixtures of XOS and COS in these compositions may be greater than 10%, 20%, 30%, 40%, 50%, 60%, 70%, 80%, 90% dry w/w.

Mixtures of XOS and COS may be used to create candy with a physical appearance of thread, soft ball, firm ball, hard ball, soft crack, hard crack, clear liquid, brown liquid, or burnt sugar. The mixture of XOS and COS may have a specific hardness of 0.01 to 0.5 N/mm². The specific hardness may be at least 0.01, 0.02, 0.03, 0.04, 0.05, 0.06, 0.07, 0.08, 0.09, 0.1, 0.15, 0.2, 0.25, 0.3, 0.35, 0.4, 0.45, or 0.5 N/mm².

Mixtures of XOS and COS may be in an aqueous composition. The pH of XOS and COS mixtures may be 1 to 9, 2 to 8, 3 to 7, or 4 to 6.

XOS may include multiple types of xylo-oligosaccharides. For example, XOS may include xylobiose, xylotriose, xylotetraose, xylopentaose, and/or xylohexaose.

In some embodiments, a composition of this disclosure may comprise polysaccharides. Mixtures may comprise greater than 1%, 2%, 3%, 4%, 5%, 6%, 7%, 8%, 9%, 10%, 20%, 30%, 40%, 50%, 60%, 70%, 80%, or 90% dry w/w polysaccharides.

In some embodiments, a composition of this disclosure may comprise water. The composition may comprise less than 50%, 40%, 30%, 20%, 10% 7.5%, 5%, 4%, 3%, 2%, or 1%, w/w water. The composition may be mixed with water to make a solution. The solution may comprise at least 60%, 70%, 80%, or 90% water.

In some embodiments, a composition of this disclosure may comprise ash. The composition may comprise less than 5%, 4%, 3%, 2%, or 1% dry w/w ash. In some embodiments, a composition of this disclosure may comprise volatile compounds. It may comprise phenolic material, e.g., lignin. In some embodiments, a composition of this disclosure may comprise protein.

In some embodiments, a composition of this disclosure may comprise sucrose. The composition may comprise less than 20%, 15%, 10%, 7.5%, 5%, 4%, 3%, 2%, or 1% w/w sucrose.

In some embodiments, a composition of this disclosure may comprise a first oligosaccharide component. The first oligosaccharide component may comprise a cello-oligosaccharide having a degree of polymerization (DP) of 2, 3, 4, 5, and/or 6. The cello-oligosaccharide may comprise 1 dry weight percent, 2 dry weight percent, 3 dry weight percent, 4 dry weight percent, 5 dry weight percent, 7.5 dry weight percent, 10 dry weight percent, 20 dry weight percent, 30 dry weight percent, 40 dry weight percent, or 50 dry weight percent of the composition. The composition may comprise a second oligosaccharide component. The second oligosaccharide component may comprise a second oligosaccharide having a DP of 2, 3, 4, 5, 6, 7, 8, 9, 10, 11, and/or 12. The second oligosaccharide may not be cello-oligosaccharide. The composition may comprise water at 1 to 50 weight percent of the composition. The composition may comprise may include at least 1 weight percent, 2 weight percent, 3 weight percent, 4 weight percent, 5 weight percent, 7.5 weight percent, 10 weight percent, 20 weight percent, 30 weight percent, 40 weight percent, or 50 weight percent water. A composition of this disclosure may comprise less than 40, 30, 20, or 10 dry weight percent monosaccharides. A composition of this disclosure may comprise one or more non-enzymatic reaction breakdown products. The one or more non-enzymatic reaction breakdown products may be present at greater than about 0.1, 0.2, 0.3, 0.4, 0.5, 0.6, 0.7, 0.8, 0.9, 1.0 wt. % of the first and second oligosaccharide, The one or more non-enzymatic reaction breakdown products may be present at less than about 20, 19, 18, 17, 16, 15, 14, 13, 12, 11, 10 wt. % of the first and second oligosaccharide, A composition of this disclosure may be caramelizable. A composition of this disclosure may be caramelized (e.g., at least partially caramelized). A composition of this disclosure may have a temperature greater than 100° C.

In some embodiments, the second oligosaccharide may comprise 10 to 90 dry weight % of the composition. The second oligosaccharide may comprise 10, 20, 30, 40, 50, 60, 70, 80, or 90 dry weight % of the composition. In some embodiments, the second oligosaccharide may be a xylo-oligosaccharide. The xylo-oligosaccharide may have a DP of 2, 3, 4, 5, 6, 7, 8, 9, 10, 11, and/or 12. The xylo-oligosaccharide may comprise at least 40, 50, 60, 70, 80, or 90 dry weight percent of the composition. The xylo-oligosaccharide may comprise 40% to 45%, 45% to 50%, 50% to 55%, 55% to 60%, 60% to 65%, 65% to 70%, 70% to 75%, 75% to 80%, 80% to 85%, or 85% to 90% by dry weight of the composition. In some embodiments, a composition of this disclosure may comprise at least two or three types of xylo-oligosaccharides. Oligosaccharides with DP of two to six may comprise at least 40%, 50%, or 60% of the xylo-oligosaccharide. Xylo-oligosaccharides may make up greater than 1%, 2%, 3%, 4%, 5%, 6%, 7%, 8%, 9%, or 10% dry w/w of the composition. The second oligosaccharide may be mannan-oligosaccharide having a DP of 2, 3, 4, 5, 6, 7, 8, 9, 10, 11, and/or 12. Oligosaccharides with DP of two to six may comprise at least 40%, 50%, or 60% of the mannan-oligosaccharide.

In some embodiments, the oligosaccharides may comprise arabinose, glucuronic acid, or the like.

In some embodiments, a composition of this disclosure may be a solid (e.g., a powder), a crystalline structure, or the like. When dispersed in water, a composition of this disclosure may have a pH of at least 1, 2, 3, 4, 5, 6, 7, or 8. When dispersed in water, a composition of this disclosure may have a pH of 1 to 8, 2 to 7, or 3 to 7.

In some embodiments, a composition of this disclosure may include a cello-oligosaccharide comprising 1, 2, 3, 4, 5, 6, 7, 8, 9, 10, 15, 20, or 25 dry weight %. The cello-oligosaccharide may comprise 1 to 25 dry weight percent of the composition. The cello-oligosaccharide may comprise 2.5 to 25 dry wt. % of the composition, and may comprise water at 1 to 20 wt. % of the composition. The composition may comprise 1 to 25 weight % water. The composition may comprise 1, 2, 3, 4, 5, 10, 15, 20, or 25 weight % water. The composition may comprise at least two types of cello-oligosaccharides. The cello-oligosaccharides may be cellobiose, cellotriose, cellotetraose, or the like. The cello-oligosaccharide may be at least 0.1%, 0.2%, 0.3%, 0.4%, 0.5%, 1%, 5%, 10%, 15%, 20% cellotriose. The cello-oligosaccharide may be at least 0.1%, 0.2%, 0.3%, 0.4%, 0.5%, 1%, 5%, 10%, 15%, 20% cellotetraose. The cello-oligosaccharide may comprise at least 50%, 60%, 70%, 80%, 90%, or 100% cellobiose.

In some embodiments, a composition of this disclosure may comprise at least one type of monosaccharide. It may comprise less than 20% w/w monosaccharides. It may comprise greater than 1% dry w/w monosaccharides. It may comprise 1% to 5%, 5% to 10%, 10% to 15%, 15% to 20%, 20% to 25%, 25% to 30%, 30% to 35%, 35% to 40%, 40% to 45%, 45% to 50%, 50% to 55%, 55% to 60% dry w/w disaccharides. It may comprise less than 50% dry w/w sucrose, lactose, maltose, and the like. It may comprise less than 20 dry weight percent sucrose.

In some embodiments, a composition of this disclosure may comprise greater than 75% saccharides. The composition may comprise trisaccharides, tetrasaccharides, pentasaccharides, or hexasaccharides; branched or unbranched saccharides; and/or charged or uncharged saccharides. The composition may comprise 0.1% to 30% dry w/w trisaccharides. The composition may comprise 0.1% to 1%, 1% to 5%, 5% to 10%, 10% to 15%, 15% to 20%, 20% to 25%, or 25% to 30% dry w/w trisaccharides. The composition may comprise 0.01% to 25% dry w/w tetrasaccharides. The composition may comprise 0.1% to 1%, 1% to 5%, 5% to 10%, 10% to 15%, 15% to 20%, or 20% to 25% dry w/w tetrasaccharides. The composition may comprise 0.01% to 20% dry w/w pentasaccharides. The composition may comprise 0.1% to 1%, 1% to 5%, 5% to 10%, 10% to 15%, or 15% to 20% pentasaccharides. The composition may comprise 0.01% to 20% dry w/w hexasaccharides. The composition may comprise 0.01% to 50% branched, unbranched, charged, or uncharged oligosaccharides. The composition may comprise 0.1% to 1%, 1% to 5%, 5% to 10%, 10% to 15%, 15% to 20%, 20% to 25%, 25% to 30%, 30% to 35%, 35% to 40%, 40% to 45%, or 45% to 50% branched, unbranched, charged, or uncharged oligosaccharides. The composition may comprise 50 dry wt. % to 99 wt. % saccharides. The composition may comprise 50, 60, 70, 80, 90, 95, or 99 dry wt. % saccharides. The composition may comprise 25 dry wt. % to 90 dry wt. % oligosaccharides having a DP of two to 20. The composition may comprise 25, 30, 35, 40, 45, 50, 55, 60, 65, 70, 75, 80, 85, or 90 dry wt. % oligosaccharides having a DP of two to 20.

In some embodiments, a composition of this disclosure may comprise greater than 75% oligosaccharides having a DP of 2, 3, 4, 5, 6, 7, 8, 9, 10, 11, 12, 13, 14, 15, 16, 17, 18, 19, and/or 20. The composition may comprise a polysaccharide. The composition may comprise greater than 1, 2, 3, 4, 5, 6, 7, 8, 9, 10 dry wt. % polysaccharides. The composition may comprise less than 60, 50, 40, 30, 25, 20, 20, 17.5, 15 dry wt. % of the polysaccharide.

In some embodiments, a composition of this disclosure may comprise xylo-oligosaccharides (XOS) and cello-oligosaccharides (COS) in a ratio of 9:1 to 1:1. The composition may comprise xylo-oligosaccharides and cello-oligosaccharides in a ratio of at least 9:1, 8:1, 7:1, 6:1, 5:1, 4:1, 3:1, 2:1, or 1:1. The composition may comprise a ratio of xylo-oligosaccharides to cello-oligosaccharides or 90:10 to 75:25. The composition may comprise a ratio of xylo-oligosaccharides to cello-oligosaccharides of at least 90:10 or 75:25. The composition may comprise a ratio of xylo-oligosaccharides to cello-oligosaccharides or 75:25 to 65:35. The composition may comprise a ratio of xylo-oligosaccharides to cello-oligosaccharides of at least 75:25, 70:30, or 65:35. The composition may comprise a ratio of xylo-oligosaccharides to cello-oligosaccharides or 90:10 to 75:25. The composition may comprise a ratio of xylo-oligosaccharides to cello-oligosaccharides of at least 90:10 or 75:25.

The hardness of the composition may be measured by a texture analyzer. The hardness of the composition may be 0.01 to 0.5 N/mm². The hardness of the composition may be 0.01 to 0.05, 0.05 to 0.1, 0.1 to 0.15, 0.15 to 0.2, 0.2 to 0.25, 0.25 to 0.3, 0.3 to 0.35, 0.35 to 0.4, 0.4 to 0.45, or 0.45 to 0.5 N/mm².

In some embodiments, a composition of this disclosure may comprise less than 1 dry weight percent w/w fructo-oligosaccharides.

In some embodiments, a composition of this disclosure may comprise fructo-oligosaccharides (FOS) and cello-oligosaccharides (COS) in a ratio of 9:1 to 1:1. The composition may comprise fructo-oligosaccharides and cello-oligosaccharides in a ratio of at least 9:1, 8:1, 7:1, 6:1, 5:1, 4:1, 3:1, 2:1, or 1:1. The composition may comprise a ratio of fructo-oligosaccharides to cello-oligosaccharides or 90:10 to 75:25. The composition may comprise a ratio of fructo-oligosaccharides to cello-oligosaccharides of at least 90:10 or 75:25. The composition may comprise a ratio of fructo-oligosaccharides to cello-oligosaccharides or 75:25 to 65:35. The composition may comprise a ratio of fructo-oligosaccharides to cello-oligosaccharides of at least 75:25, 70:30, or 65:35.

At least one of the oligosaccharides of the composition may be chemically modified. The chemical modification may comprise oxidation, reduction, caramelization, the Maillard reaction, and the like.

In some embodiments, a composition of this disclosure may comprise non-enzymatic reaction breakdown products of at least one of the xylo-oligosaccharide and the cello-oligosaccharide. Non-enzymatic reaction breakdown products may include deoxyosone, an osulose, a furan-2-aldehyde, a two-carbon alpha-dicarbonyl compound or hydroxycarbonyl compound, a three-carbon alpha-dicarbonyl compound or hydroxycarbonyl compound, a four-carbon alpha-dicarbonyl compound or hydroxycarbonyl compound, a glycoxal, a glycolaldehyde, a glycosylamine, a deoxyglycosyl amino acid or peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, caramelans, caramelens, caramelins, volatile compounds, a diacetyl, or a combination thereof.

Non-enzymatic reaction breakdown products may comprise mannosyl, mannobiosyl or mannotriosyl derivatives of a deoxyosone, an osulose, a furan-2-aldehyde, a two-carbon alpha-dicarbonyl compound or hydroxycarbonyl compound, a three-carbon alpha-dicarbonyl compound or hydroxycarbonyl compound, a four-carbon alpha-dicarbonyl compound or hydroxycarbonyl compound, a glycoxal, a glycolaldehyde, a glycosylamine, a deoxyglycosyl amino acid or peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, caramelans, caramelens, caramelins, volatile compounds, a diacetyl, or a combination thereof.

Non-enzymatic reaction breakdown products may comprise xylosyl, xylobiosyl or xylotriosyl derivatives of a deoxyosone, an osulose, a furan-2-aldehyde, a two-carbon alpha-dicarbonyl compound or hydroxycarbonyl compound, a three-carbon alpha-dicarbonyl compound or hydroxycarbonyl compound, a four-carbon alpha-dicarbonyl compound or hydroxycarbonyl compound, a glycoxal, a glycolaldehyde, a glycosylamine, a deoxyglycosyl amino acid or peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, caramelans, caramelens, caramelins, volatile compounds, a diacetyl, or a combination thereof.

Non-enzymatic reaction breakdown products may comprise glucosyl, cellobiosyl or cellotriosyl derivatives of a deoxyosone, an osulose, a furan-2-aldehyde, a two-carbon alpha-dicarbonyl compound or hydroxycarbonyl compound, a three-carbon alpha-dicarbonyl compound or hydroxycarbonyl compound, a four-carbon alpha-dicarbonyl compound or hydroxycarbonyl compound, a glycoxal, a glycolaldehyde, a glycosylamine, a deoxyglycosyl amino acid or peptide, 2-oxopropanal, glyoxal, 3-deoxy-2-hexosulose, glycolaldehyde, 2-oxopropanal, 2-hexosulose, butane-2,3-dione, hydroxy-2-propanone, 2-hydroxy-3-butanone, 5-(hydroxymethyl)furan-2-carboxaldehyde, 3-deoxy-2-pentosulose, 2-xylosulose, furan-2-carboxaldehyde, 2-glucosulose, 2-hydroxy-3-butanone, hydroxy-2-propanone, caramelans, caramelens, caramelins, volatile compounds, a diacetyl, or a combination thereof.

In some embodiments, a composition of this disclosure may comprise non-enzymatic reaction breakdown products of at least one of the xylo-oligosaccharide, the cello-oligosaccharide, and/or the fructo-oligosaccharide. Non-enzymatic reaction breakdown products may include carbonyls, ketones, furans, pyrazines, Strecker aldehydes, and/or aromatic compounds. In some embodiments the carbonyls or ketones comprise Diacetyl (2,3-Butanedione). In some embodiments the carbonyls or ketones comprise 2-Butanone. In some embodiments the carbonyls or ketones comprise 1-hydroxy-2-Propanone.

In some embodiments, the Strecker Aldehydes comprise Isovaleraldehyde (3-methyl-Butanal).

In some embodiments, the furans comprise 2-methyl-Furan, Furfural, 5-methyl furfural, and/or 2-pentyl-Furan.

In some embodiments, the pyrazines comprise methyl-pyrazine, ethyl-pyrazine, 2,5-dimethyl pyrazine, 2-ethyl-5-methyl pyrazine, and/or 2,5-diethyl pyrazine.

In some embodiments, the aromatic compounds comprise indole.

An amount of the breakdown products may be less than an amount of the xylo-oligosaccharide and the cello-oligosaccharide in the composition on a w/w basis. The breakdown products may comprise furfural, a phenol, or the like.

Monosaccharides of the composition may comprise fructose, glucose, or a combination thereof. In some embodiments, a composition of this disclosure may comprise less than 5, 10, 15, 20% w/w sucrose.

In some embodiments, a composition of this disclosure may comprise an acidity regulator. The acidity regulator may be used to increase or decrease the pH of the composition in solution. The acidity regulator may comprise lemon juice, baking soda, baking powder, adipic acid, ammonium aluminum sulfate, ammonium bicarbonate, ammonium carbonate, ammonium citrate, dibasic, ammonium citrate monobasic, ammonium hydroxide, ammonium phosphate, dibasic, ammonium phosphate, monobasic, calcium acetate, calcium acid pyrophosphate, calcium carbonate, calcium chloride, calcium citrate, calcium fumarate, calcium gluconate, calcium hydroxide, calcium lactate, calcium oxide, calcium phosphate (dibasic), calcium phosphate (monobasic), calcium phosphate (tribasic), calcium sulfate, carbon dioxide, citric acid, cream of tartar, fumaric acid, gluconic acid, glucono-delta-lactone, hydrochloric acid, lactic acid, magnesium carbonate, magnesium citrate, magnesium fumarate, magnesium hydroxide, magnesium oxide, magnesium phosphate, magnesium sulfate, malic acid, manganese sulfate, metatartaric acid, phosphoric acid, potassium acid tartrate, potassium aluminum sulfate, potassium bicarbonate, potassium carbonate, potassium chloride, potassium citrate. potassium fumarate, potassium hydroxide, potassium lactate, potassium phosphate (dibasic), potassium phosphate (tribasic), potassium pyrophosphate (tetrabasic), potassium sulfate, potassium tartrate, potassium tripolyphosphate, sodium acetate, sodium acid pyrophosphate, sodium acid tartrate, sodium aluminum phosphate, sodium aluminum, sulfate, sodium bicarbonate, sodium bisulfate, sodium carbonate, sodium citrate, sodium fumarate, sodium gluconate, sodium hexametaphosphate, sodium hydroxide, sodium lactate, sodium phosphate (dibasic), sodium phosphate (monobasic), sodium phosphate (tribasic), sodium potassium hexametaphosphate, sodium potassium tartrate, sodium potassium tripolyphosphate, sodium pyrophosphate (tetrabasic), sodium tripolyphosphate, sulfuric acid, sulfurous acid, tartaric acid, or other similar acidic or basic compounds. The acidity regulator may comprise at least one of sorbic acid, acetic acid, benzoic acid, propionic acid, or a salt thereof, such as a sodium salt. In some embodiments, a composition of this disclosure may comprise a buffering system. The buffering system or acidity regulator may comprise less than 10% dry w/w of the oligosaccharide content.

In some embodiments, a composition of this disclosure in solution may have a boiling point greater than 100° C. when in an aqueous solution. The boiling point of the solution may rise to at least 100° C. before the solution dries out. The boiling point may be greater than 105° C., 110° C., 120° C., 130° C., 140° C., 150° C., 160° C., or 170° C. The composition may be aqueous.

In some embodiments, a composition of this disclosure may comprise an amino acid, a peptide, or a protein. In some embodiments, a composition of this disclosure may comprise organic or mineral acids, bases, neutralizing agents, or buffering agents. The organic acids may be oxalate and formate.

In some embodiments, a composition of this disclosure may be a syrup, a hard candy, a soft candy, a caramel, or the like. The composition may have the physical appearance of a number of sugar stages, including thread, soft ball, firm ball, hard ball, soft crack, hard crack, clear liquid, brown liquid, or burnt sugar.

Oligosaccharides, xylo-oligosaccharides, and cello-oligosaccharides may be soluble in aqueous and non-aqueous solutions. The solubility of a first mass of cello-oligosaccharides and the second type of oligosaccharides may be greater than the solubility of cello-oligosaccharides alone. For example, a mixture of cello-oligosaccharide and xylo-oligosaccharides may be more soluble than cello-oligosaccharide alone.

The composition may be a syrup, a candy, a bakery composition, a jam, jelly, spread, or preserve.

In some embodiments, a composition of this disclosure may comprise Maillard products of at least one of the cello-oligosaccharide and the second type of oligosaccharide. The Maillard reaction describes the interaction between sugars and amino acids at high temperatures, also known as the Amadori rearrangement, and creates the familiar browning seen in food products, known as melanoidins. Thus, the composition may be, for example, a mixture of cello-oligosaccharide and xylo-oligosaccharide in a baked good, and heating may produce browning of the composition. Maillard products include a number of aminoketose compounds, including but not limited to 2,3-butanedione, 2-acetyl-1-pyrroline, and other rearrangements of amino deoxy fructose.

In some embodiments, a composition of this disclosure may comprise caramelization products of at least one of the cello-oligosaccharide and the second type of oligosaccharide. For example, the composition may include caramelization of a mixture of cello-oligosaccharide and xylo-oligosaccharide. Caramelization is the oxidation of sugars and is a non-enzymatic browning reaction. As the sugars are heated, water is released, and the sugars break down. As described in Table 1, types of caramelization can be achieved by utilizing known temperature ranges.

In some embodiments, a composition of this disclosure may be disposed in a cosmetic, foodstuff, or a nutraceutical.

This disclosure describes a caramel comprising a cello-oligosaccharide having a DP of 2, 3, 4, 5, and/or 6, the cello-oligosaccharide comprising 1 to 50 dry weight percent of a syrup, and a second type of oligosaccharide having a DP of 2, 3, 4, 5, 6, 7, 8, 9, 10, 11, and/or 12, the second type of oligosaccharide not being a cello-oligosaccharide. The cello-oligosaccharide may comprise 1% to 5%, 5% to 10%, 10% to 15%, 15% to 20%, 20% to 25%, 25% to 30%, 30% to 35%, 35% to 40%, 40% to 45%, 45% to 50% by dry weight. The syrup may comprise greater than 50 dry weight percent saccharides and less than 40 dry weight percent monosaccharides. The syrup may comprise non-enzymatic reaction breakdown products of at least one of the cello-oligosaccharide and the second type of oligosaccharide.

This disclosure describes a consumable composition comprising a xylo-oligosaccharide having a DP of 2, 3, 4, 5, 6, 7, 8, 9, 10, 11, and/or 12 and a cello-oligosaccharide having a DP of 2, 3, 4, 5, and/or 6, wherein the composition has a consistency of sucrose in a soft ball stage. The ratio of the xylo-oligosaccharide to the cello-oligosaccharide may be 80:20 to 60:40. The ratio of the xylo-oligosaccharide to the cello-oligosaccharide may be at least 80:20, 75:25, 70:30, 65:35, or 60:40.

In some embodiments, specific nonenzymatic breakdown products of a flavoring precursor compound provide a particular flavor profile to a food product.

Strecker aldehydes for example typically have a malty, aldehydic, pungent aroma.

In some embodiments, the overall flavour profile of a food product may depend on a protein source or other composition in the food matrix reacting with the flavoring precursor compound.

Furans, like carbonyls are produced from rearranged sugars, via two mechanisms. Either through cyclisation of rearranged sugars or through the condensation of carbonyls. The typical aroma of furans is caramellike, nutty and cocoa.

Pyrazines are produced from condensation of the Strecker intermediate, therefore are only present in the solutions containing amino acids. These compounds contribute to a woody, roasted, nutty aroma profile of foods. The highest concentration of the smaller pyrazines containing methyl groups are present in the monosaccharide mixtures, whereas the larger pyrazines containing ethyl groups are present in greater amounts in the oligosaccharide mixtures containing XOS (100:0-20:80). These larger pyrazines contribute woody, earthy notes.

This disclosure describes a method of making a foodstuff, comprising (a) providing a composition comprising a cello-oligosaccharide having a DP of 2, 3, 4, 5, and/or 6, and a second type of oligosaccharide having a DP of 2, 3, 4, 5, 6, 7, 8, 9, 10, 11, and/or 12, the composition having a ratio of cello-oligosaccharide to the second type of oligosaccharide of 80:20 to 60:40, and the composition having a first pH, (b) adjusting the pH of the composition from the first pH to a second pH, the second pH being at least 3, 4, 5, 6, or 7, and (c) heating the composition having the second pH to greater than 100° C. The composition may have a ratio of cello-oligosaccharide to the second type of oligosaccharide of at least 80:20, 75:25, 70:30, 65:35, or 60:40. The composition of this method may be 5% to 25% by dry weight cellobiose. The composition of this method may be 5% to 10%, 105% to 15%, 15% to 20%, or 20% to 25% by dry weight cellobiose. The second type of oligosaccharide in this method may comprise a xylo-oligosaccharide having a DP of 2, 3, 4, 5, 6, 7, 8, 9, 10, 11, and/or 12.

Step (b) of the method may comprise adjusting the composition from the first pH to a third pH, wherein the third pH is 4, 5, 6, or 7. The weight ratio of the first oligosaccharide to the second oligosaccharide may be 75:25 to 65:35. The weight ratio of the first oligosaccharide to the second oligosaccharide may be at least 75:25, 70:30, or 65:35. The weight ratio of the first oligosaccharide to the second oligosaccharide may be 9:1 to 1:9. The weight ratio of the first oligosaccharide to the second oligosaccharide may be at least 9:1, 8:2, 7:3, 6:4, 5:5, 4:6, 3:7, 2:8, or 1:9. The method may comprise at least two cello-oligosaccharides. The method may comprise at least two xylo-oligosaccharides. The composition of the method may comprise xylo-oligosaccharides and cello-oligosaccharides at a ratio of from 9:1 to 1:1. The composition of the method may comprise xylo-oligosaccharides and cello-oligosaccharides at a ratio of at least 9:1, 8:1, 7:1, 6:1, 5:1, 4:1, 3:1, 2:1, or 1:1. The method may comprise adding a buffering system or acidity regulator. The oligosaccharides may be chemically modified, and the chemical modification may comprise oxidation, reduction, caramelization, or the Maillard reaction.

In a method of making a foodstuff as described herein, the composition may comprise greater than 75% w/w oligosaccharides. The composition may have a specific hardness of 0.01 to 0.5 N/mm². The specific hardness may be at least 0.01, 0.02, 0.03, 0.04, 0.05, 0.06, 0.07, 0.08, 0.09, 0.1, 0.15, 0.2, 0.25, 0.3, 0.35, 0.4, 0.45, or 0.5 N/mm². The composition may comprise less than 50%, 40%, 30%, 20%, 10%, 7.5%, 5%, 4%, 3%, 2%, 1% w/w water. In a method of this disclosure, step (c) may comprise heating the composition from 100° C., 110° C., 120° C., 130° C., 140° C., 150° C., 160° C., 170° C., or 177° C. In a method of this disclosure, the foodstuff may be a baked good, such as a biscuit, bread, cake, cookie, pastry, or scone. The foodstuff may be a confectionary product, such as a fudge, a caramel, a nougat, a taffy, or a toffee.

In a method of making foodstuff as described by this disclosure, the method may further comprise step (d) maintaining the heat for a time period sufficient to achieve a predetermined sugar stage. Step (d) may comprise heating the composition to from 110° C. to 112° C. such that the composition has a consistency of sucrose in a thread stage, as described in Table 1. Step (d) may comprise heating the composition to from 112° C. to 116° C. such that the composition has a consistency of sucrose in a soft ball stage, as described in Table 1. Step (d) may comprise heating the composition to from 118° C. to 120° C. such that the composition has a consistency of sucrose in a firm ball stage, as described in Table 1. Step (d) may comprise heating the composition to from 121° C. to 130° C. such that the composition has a consistency of sucrose in a hard ball stage, as described in Table 1. Step (d) may comprise heating the composition to from 133° C. to 143° C. such that the composition has a consistency of sucrose in a soft crack stage, as described in Table 1. Step (d) may comprise heating the composition to from 146° C. to 154° C. such that the composition has a consistency of sucrose in a hard crack stage, as described in Table 1.

This disclosure describes a consumable composition comprising a xylo-oligosaccharide having a DP of 2, 3, 4, 5, 6, 7, 8, 9, 10, 11, and/or 12 and a cello-oligosaccharide having a DP of 2, 3, 4, 5, and/or 6, wherein the composition has a consistency of sucrose in a soft ball stage. The ratio of xylo-oligosaccharide to cello-oligosaccharide may be from 80:20 to 60:40.

This disclosure describes a consumable composition comprising a xylo-oligosaccharide having a DP of 2, 3, 4, 5, 6, 7, 8, 9, 10, 11, and/or 12 and a cello-oligosaccharide having a DP of 2, 3, 4, 5, and/or 6, wherein the composition has a consistency of sucrose in a hard ball stage. The ratio of xylo-oligosaccharide to the cello-oligosaccharide may be from 80:20 to 60:40.

The composition may include one or more polysaccharide components. The polysaccharide components of the composition may comprise one or more of any type of polysaccharide. For example, the polysaccharide may comprise cellulose, lignocellulose, xylan, mixed-linkage glucan, mannan, xyloglucan, chitin, chitosan, or derivatives of any of the aforementioned polysaccharides.

The composition or ingredient may comprise various oligosaccharides. The composition may include the oligosaccharides at varying amounts, for example, depending on the desired properties of the composition. In some instances, the composition may comprise at least 20% by dry weight, for example, at least 30% by dry weight, cello-oligosaccharides having a DP of two to six; and/or the composition may comprise at least 20% by dry weight, for example, at least 30% by dry weight, xylo-oligosaccharides having a DP of two to twelve; and/or the composition may comprise at least 20% by dry weight, for example, at least 30% by dry weight, mannan-oligosaccharides having a DP of two to twelve.

In various embodiments, the composition or ingredient may comprise 5% to 50% w/w cello-oligosaccharides with a DP of two to six. In certain embodiments, the composition or ingredient may comprise 5% to 50%, 10% to 40%, 15% to 35% w/w cello-oligosaccharides with a DP of two to six. The composition or ingredient may comprise at least 5%, 8%, 10%, 15%, 20%, or 25% w/w cello-oligosaccharides with a DP of two to six. In some embodiments, the composition or ingredient may comprise 20% to 90% w/w cello-oligosaccharides with a DP of two to six. In certain embodiments, the composition or ingredient may comprise 5% to 95%, 10% to 92.5%, 30% to 80%, 40% to 70%, or 50% to 60% w/w cello-oligosaccharides with a DP of two to six.

In various embodiments, the composition or ingredient may comprise 20% to 90% w/w xylo-oligosaccharides with a DP of two to twelve. In certain embodiments, the composition or ingredient may comprise 5% to 95%, 10% to 92.5%, 30% to 80%, 40% to 70%, or 50% to 60% w/w xylo-oligosaccharides with a DP of two to 12. For example, the composition may comprise at least 30% w/w of xylo-oligosaccharides with a DP of two to twelve. The composition or ingredient may comprise at least 5%, 8%, 10%, 15%, 20%, or 25% w/w xylo-oligosaccharides with a DP of two to twelve.

The amounts of each of the oligosaccharides may be varied depending on the desired properties of the resulting foodstuff, cosmetic, or nutraceutical. For example, the two oligosaccharides may be present in a ratio of 1:9 to 1:1, 1:2 to 1:1, or 2:3 to 1:1 in relation to each other.

The oligosaccharide mixture may further comprise a third oligosaccharide. The oligosaccharide mixture may comprise a third oligosaccharide and a fourth oligosaccharide. The oligosaccharide mixture may comprise a third oligosaccharide, a fourth oligosaccharide, and a fifth oligosaccharide. The oligosaccharide mixture may further comprise a third oligosaccharide, a fourth oligosaccharide, a fifth oligosaccharide, and a sixth oligosaccharide.

Oligosaccharide mixtures may comprise the cello-oligosaccharides, for instance, cello-oligosaccharides in combination with the xylo-oligosaccharides. An alternative composition may comprise cello-oligosaccharides in combination with mannan-oligosaccharides.

The oligosaccharide mixtures of the at least two oligosaccharides may additionally include a polysaccharide, for example, a cellulosic polysaccharide, such as cellulose, or a polysaccharide derivative, for example, a cellulose derivative, such as carboxymethylcellulose, or a polysaccharide aggregate, for example, a portion of lignocellulosic biomass. In some instances, the ratio in the combination may be 1:100 to 1:1 polysaccharide/polysaccharide derivative/polysaccharide aggregate:oligosaccharide, for example, 1:90 to 1:2, 1:80 to 1:3, 1:70 to 1:4, or 1:60 to 1:5. As such, the ratio between the first oligosaccharide, the second oligosaccharide, and the polysaccharide may be 2:2:1 to 30:30:1, for example, about 3:3:1.

A composition may comprise a mixture of one or more oligosaccharides. A mixture of oligosaccharides may comprise two forms or types of oligosaccharides, for instance, cello-oligosaccharides and xylo-oligosaccharides. A mixture of oligosaccharides may comprise three forms of oligosaccharides, for instance, cello-oligosaccharides, mannan-oligosaccharides, and xylo-oligosaccharides.

An oligosaccharide mixture may comprise two forms of oligosaccharides, for example, a first oligosaccharide and a second oligosaccharide. An oligosaccharide mixture may comprise at least 5% of a first oligosaccharide and up to 95% of a second oligosaccharide w/w. An oligosaccharide mixture may comprise at least 10% of a first oligosaccharide and up to 90% of a second oligosaccharide w/w. An oligosaccharide mixture may comprise at least 15% of a first oligosaccharide and up to 85% of a second oligosaccharide w/w. An oligosaccharide mixture may comprise at least 20% of a first oligosaccharide and up to 80% of a second oligosaccharide w/w. An oligosaccharide mixture may comprise at least 25% of a first oligosaccharide and up to 75% of a second oligosaccharide w/w. An oligosaccharide mixture may comprise at least 30% of a first oligosaccharide and up to 70% of a second oligosaccharide w/w. An oligosaccharide mixture may comprise at least 35% of a first oligosaccharide and up to 65% of a second oligosaccharide w/w. An oligosaccharide mixture may comprise at least 40% of a first oligosaccharide and up to 50% of a second oligosaccharide w/w. An oligosaccharide mixture may comprise at least 45% of a first oligosaccharide and up to 55% of a second oligosaccharide w/w. An oligosaccharide mixture may comprise at least 50% of a first oligosaccharide and up to 50% of a second oligosaccharide w/w. An oligosaccharide mixture may comprise at least 55% of a first oligosaccharide and up to 45% of a second oligosaccharide w/w. An oligosaccharide mixture may comprise at least 60% of a first oligosaccharide and up to 30% of a second oligosaccharide w/w. An oligosaccharide mixture may comprise at least 65% of a first oligosaccharide and up to 35% of a second oligosaccharide w/w. An oligosaccharide mixture may comprise at least 70% of a first oligosaccharide and up to 30% of a second oligosaccharide w/w. An oligosaccharide mixture may comprise at least 75% of a first oligosaccharide and up to 25% of a second oligosaccharide w/w. An oligosaccharide mixture may comprise at least 80% of a first oligosaccharide and up to 20% of a second oligosaccharide w/w. An oligosaccharide mixture may comprise at least 85% of a first oligosaccharide and up to 15% of a second oligosaccharide w/w. An oligosaccharide mixture may comprise at least 90% of a first oligosaccharide and up to 10% of a second oligosaccharide w/w. An oligosaccharide mixture may comprise at least 95% of a first oligosaccharide and up to 5% of a second oligosaccharide w/w.

In some cases, a first oligosaccharide may be cello-oligosaccharides and a second oligosaccharide may be xylo-oligosaccharides. In some instances, a first oligosaccharide may be cello-oligosaccharides and a second oligosaccharide may be mannan-oligosaccharides. In some embodiments, a first oligosaccharide may be xylo-oligosaccharides and a second oligosaccharide may be mannan-oligosaccharides. Other combinations of a first oligosaccharide and a second oligosaccharide are also within the scope of this disclosure.

An oligosaccharide mixture may comprise three forms of oligosaccharides, for example, a first oligosaccharide, a second oligosaccharide, and a third oligosaccharide. An oligosaccharide mixture may comprise at least 20% of a first oligosaccharide, up to 40% of a second oligosaccharide, and up to 40% of a third oligosaccharide w/w. An oligosaccharide mixture may comprise at least 30% of a first oligosaccharide, up to 30% of a second oligosaccharide, and up to 40% of a third oligosaccharide w/w. An oligosaccharide mixture may comprise at least 10% of a first oligosaccharide, up to 10% of a second oligosaccharide, and up to 80% of a third oligosaccharide w/w. An oligosaccharide mixture may comprise at least 20% of a first oligosaccharide, up to 20% of a second oligosaccharide, and up to 60% of a third oligosaccharide w/w. An oligosaccharide mixture may comprise at least 20% of a first oligosaccharide, up to 30% of a second oligosaccharide, and up to 50% of a third oligosaccharide w/w. In some examples, a first oligosaccharide may be mannan-oligosaccharides, a second oligosaccharide may be xylo-oligosaccharides, and a third oligosaccharide may be cello-oligosaccharides. Other combinations of a first oligosaccharide, a second oligosaccharide, and a third oligosaccharide are also within the scope of this disclosure.

An oligosaccharide mixture may comprise two or more oligosaccharides, a first oligosaccharide and a second oligosaccharide which is different than the first oligosaccharide. For instance, the first oligosaccharide may be a xylo-oligosaccharide or a cello-oligosaccharide or a mannan-oligosaccharide or other oligosaccharide as provided herein, whereas the second oligosaccharide can be a xylo-oligosaccharide or a cello-oligosaccharide or a mannan-oligosaccharide or other oligosaccharides not used as the first oligosaccharide. Stated another way, the first oligosaccharide can be different than the second oligosaccharide (e.g., the first oligosaccharide can be of a different type of oligosaccharide than the second oligosaccharide). The ratio of a first oligosaccharide to a second oligosaccharide in the mixture may be 1:1 to 1:9, 1:2 to 1:9, 1:3 to 1:9, 1:4 to 1:9, 1:5 to 1:9, 1:6 to 1:9, 1:7 to 1:9, or 1:8 to 1:9.

The ratio of a first oligosaccharide to a second oligosaccharide in the mixture may be 2:1 to 2:9, 2:3 to 2:9, 2:5 to 2:9, or 2:7 to 2:9. The oligosaccharides may be cello-oligosaccharides, mannan-oligosaccharides, or xylo-oligosaccharides, or other oligosaccharides as provided herein, wherein the first oligosaccharide is selected to be a different oligosaccharide than the second oligosaccharide. In other words, the first oligosaccharide may be a different type of oligosaccharide than the second oligosaccharide.

The ratio of a first oligosaccharide to a second oligosaccharide in the mixture may be 3:1 to 3:8, 3:2 to 3:8, 3:4 to 3:8, 3:5 to 3:8, or 3:7 to 3:8. The oligosaccharides may be cello-oligosaccharides, mannan-oligosaccharides, xylo-oligosaccharides, or other oligosaccharides provided herein, wherein the first oligosaccharide is selected to be a different oligosaccharide than the second oligosaccharide.

The ratio of a first oligosaccharide to a second oligosaccharide in an oligosaccharide mixture comprising two or more oligosaccharides may be 1:9 to 9:1, 1:4 to 4:1, 1:3 to 3:1, or 2:3 to 3:2. The oligosaccharides may be cello-oligosaccharides, mannan-oligosaccharides, xylo-oligosaccharides, or other oligosaccharides provided herein, wherein the first oligosaccharide is selected to be a different oligosaccharide than the second oligosaccharide.

In some cases, the composition or the ingredient may include at least 1% w/w, 2% w/w, 3% w/w, 4% w/w, 5% w/w, 10% w/w, 15% w/w, 20% w/w, 25% w/w, 30% w/w, or more of cellobiose, xylobiose, mannobiose (e.g., man-β-1,4-man), man-β-1,4-glc, laminaribiose, gentiobiose, sophorose, maltose, lactose, or sucrose. In certain cases, the composition or the ingredient may include at least 1% w/w, 2% w/w, 3% w/w, 4% w/w, 5% w/w, 10% w/w, 15% w/w, 20% w/w, 25% w/w, 30% w/w, or more of cellotriose, xylotriose, monoarabinosylated xylobiose, monoglucuronosylated xylobiose, maltotriose, mannotriose (e.g., man-β-1,4-man-β-1,4-man), man-β-1,4-glc-β-1,3-glc-β-1,4-glc, or glc-β-1,4-glc-β-1,3-glc. In certain instances, the composition or the ingredient may include at least 1% w/w, 2% w/w, 3% w/w, 4% w/w, 5% w/w, 10% w/w, 15% w/w, 20% w/w, 25% w/w, 30% w/w, or more of xylotetraose, cellotetraose, monoarabinosylated xylotriose, monoglucuronosylated xylotriose, diarabinosylated xylobiose, diglucuronosylated xylobiose, maltotetraose, mannotetraose (e.g., man-β-1,4-man-β-1,4-man-β-1,4-man), man-β-1,4-glc-β-1,4-man-β-1,4-man, 1,4-man, man-β-1,4-man-β-1,4-man-β-1,4-glc, man, glc-β-1,4-man-β-1,4-man-β-1,4-glc, 1,4-glc-1,4-glc, glc-β-1,4-glc-β-1,4-glc-1,3-glc, or glc-β-1,3-glc-β-1,4-glc-1,3-glc. In certain cases, the composition or the ingredient may include at least 0.01% w/w, 0.05% w/w, 0.1% w/w, 0.5% w/w, 1% w/w, 2% w/w, 5% w/w, 10% w/w, 15% w/w, 20% w/w, or more of xylopentaose, cellopentaose, monoarabinosylated xylotetraose, monoglucuronosylated xylotetraose, diarabinosylated xylotriose, diglucuronosylated xylotriose, maltopentaose, mannopentaose (e.g., man-β-1,4-man-β-1,4-man-β-1,4-man-β-1,4-man), mixed-linkage glucan-derived pentasaccharide, or mannan-derived pentasaccharide.

The composition or ingredient may comprise 1% to 50%, 5% to 40%, 10% to 30%, or 15% to 25% w/w of cellobiose. The composition or ingredient may comprise 2.5% to 90%, 5% to 80%, 10% to 70%, or 20% to 60% w/w of xylobiose. The composition or ingredient may comprise 2.5% to 75%, 5% to 50%, 10% to 40%, or 20% to 30% w/w of xylotriose.

The average DP of the oligosaccharides in the composition may be 1 to 50, 1.5 to 25, 2 to 15, 2.1 to 10, 2.1 to 7, or 2.2 to 5.

The concentration of xylo-oligosaccharides with a DP of two in a xylo-oligosaccharide mixture may be 2% to 80% w/w. The concentration of xylo-oligosaccharides with a DP of two may be at least 2%, 4%, 6%, 8%, 10%, 12%, 15%, 18%, 20%, 25%, or 30% w/w. The concentration of xylo-oligosaccharides with a DP of two may be higher in some cases, for instance, up to 35%, 40%, 45%, 50%, 55%, 60%, 65%, 70%, 75%, or 80% w/w.

The concentration of xylo-oligosaccharides with a DP of three in a xylo-oligosaccharide mixture may be 2% to 20% w/w. The concentration of xylo-oligosaccharides with a DP of three may be at least 2%, 4%, 6%, 8%, 10%, 12%, 15%, 18%, or 20% w/w.

The concentration of xylo-oligosaccharides with a DP of four in a xylo-oligosaccharide mixture may be 5% to 20% w/w. The concentration of xylo-oligosaccharides with a DP of four may be at least 5%, 8%, 10%, 12%, 15%, 18%, or 20% w/w.

The concentration of xylo-oligosaccharides with a DP of five in a xylo-oligosaccharide mixture may be 5% to 20% w/w. The concentration of xylo-oligosaccharides with a DP of five may be at least 5%, 7%, 8%, 10%, 12%, 15%, 18%, or 20% w/w.

The concentration of xylo-oligosaccharides with a DP of six in a xylo-oligosaccharide mixture may be 5% to 25% w/w. The concentration of xylo-oligosaccharides with a DP of six may be at least 5%, 8%, 10%, 12%, 15%, 18%, 20%, or 25% w/w.

The concentration of xylo-oligosaccharides with a DP of seven in a xylo-oligosaccharide mixture may be 2% to 20% w/w. The concentration of xylo-oligosaccharides with a DP of seven may be at least 2%, 4%, 6%, 8%, 10%, 12%, 15%, 17%, or 20% w/w.

The concentration of xylo-oligosaccharides with a DP of eight in a xylo-oligosaccharide mixture may be 1% to 15% w/w. The concentration of xylo-oligosaccharides with a DP of eight may be at least 1%, 2%, 3%, 4%, 5%, 6%, 7%, 8%, 9%, 10%, or 15% w/w.

The concentration of xylo-oligosaccharides with a DP of nine in a xylo-oligosaccharide mixture may be 2% to 15% w/w. The concentration of xylo-oligosaccharides with a DP of nine may be at least 1%, 2%, 3%, 4%, 5%, 6%, 7%, 8%, 9%, 10%, or 15% w/w.

The concentration of xylo-oligosaccharides with a DP of ten in a xylo-oligosaccharide mixture may be 2% to 15% w/w. The concentration of xylo-oligosaccharides with a DP of ten may be at least 1%, 2%, 3%, 4%, 5%, 6%, 7%, 8%, 9%, 10%, or 15% w/w.

The concentration of xylo-oligosaccharides with a DP of eleven in a xylo-oligosaccharide mixture may be 2% to 15% w/w. The concentration of xylo-oligosaccharides with a DP of eleven may be at least 1%, 2%, 3%, 4%, 5%, 6%, 7%, 8%, 9%, 10%, or 15% w/w.

The concentration of xylo-oligosaccharides with a DP of twelve in a xylo-oligosaccharide mixture may be 2% to 15% w/w. The concentration of xylo-oligosaccharides with a DP of twelve may be at least 1%, 2%, 3%, 4%, 5%, 6%, 7%, 8%, 9%, 10%, or 15% w/w.

The concentration of cello-oligosaccharides with a DP of two in a cello-oligosaccharide mixture may be 2% to 80% w/w. The concentration of cello-oligosaccharides with a DP of two may be at least 2%, 4%, 6%, 8%, 10%, 12%, 15%, 18%, 20%, 25%, or 30% w/w. The concentration of cello-oligosaccharides with a DP of two may be higher in some cases, for instance, at least 35%, 40%, 45%, 50%, 55%, 60%, 65%, 70%, 75%, or 80% w/w.

The concentration of cello-oligosaccharides with a DP of three in a cello-oligosaccharide mixture may be 2% to 20% w/w. The concentration of cello-oligosaccharides with a DP of three may be at least 2%, 4%, 6%, 8%, 10%, 12%, 15%, 18%, or 20% w/w.

The concentration of cello-oligosaccharides with a DP of four in a cello-oligosaccharide mixture may be 5% to 20% w/w. The concentration of cello-oligosaccharides with a DP of four may be at least 5%, 8%, 10%, 12%, 15%, 18%, or 20% w/w.

The concentration of cello-oligosaccharides with a DP of five in a cello-oligosaccharide mixture may be 5% to 20% w/w. The concentration of cello-oligosaccharides with a DP of five may be at least 5%, 7%, 8%, 10%, 12%, 15%, 18%, or 20% w/w.

The concentration of cello-oligosaccharides with a DP of six in a cello-oligosaccharide mixture may be 5% to 25% w/w. The concentration of cello-oligosaccharides with a DP of six may be at least 5%, 8%, 10%, 12%, 15%, 18%, 20%, or 25% w/w.

The concentration of mannan-oligosaccharides with a DP of two in a mannan-oligosaccharide mixture may be 2% to 30% w/w. The concentration of mannan-oligosaccharides with a DP of two may be at least 2%, 4%, 6%, 8%, 10%, 12%, 15%, 18%, 20%, 25%, or 30% w/w.

The concentration of mannan-oligosaccharides with a DP of three in a mannan-oligosaccharide mixture may be 2% to 20% w/w. The concentration of mannan-oligosaccharides with a DP of three may be at least 2%, 4%, 6%, 8%, 10%, 12%, 15%, 18%, or 20% w/w.

The concentration of mannan-oligosaccharides with a DP of four in a mannan-oligosaccharide mixture may be 5% to 20% w/w. The concentration of mannan-oligosaccharides with a DP of four may be at least 5%, 8%, 10%, 12%, 15%, 18%, or 20% w/w.

The concentration of mannan-oligosaccharides with a DP of five in a mannan-oligosaccharide mixture may be 5% to 20% w/w. The concentration of mannan-oligosaccharides with a DP of five may be at least 5%, 7%, 8%, 10%, 12%, 15%, 18%, or 20% w/w.

The concentration of mannan-oligosaccharides with a DP of six in a mannan-oligosaccharide mixture may be 5% to 25% w/w. The concentration of mannan-oligosaccharides with a DP of six may be at least 5%, 8%, 10%, 12%, 15%, 18%, 20%, or 25% w/w.

The concentration of mannan-oligosaccharides with a DP of seven in a mannan-oligosaccharide mixture may be 2% to 20% w/w. The concentration of mannan-oligosaccharides with a DP of seven may be at least 2%, 4%, 6%, 8%, 10%, 12%, 15%, 17%, or 20% w/w.

The concentration of mannan-oligosaccharides with a DP of eight in a mannan-oligosaccharide mixture may be 1% to 15% w/w. The concentration of mannan-oligosaccharides with a DP of eight may be at least 1%, 2%, 3%, 4%, 5%, 6%, 7%, 8%, 9%, 10%, or 15% w/w.

The concentration of mannan-oligosaccharides with a DP of nine in a mannan-oligosaccharide mixture may be 2% to 15% w/w. The concentration of mannan-oligosaccharides with a DP of nine may be at least 1%, 2%, 3%, 4%, 5%, 6%, 7%, 8%, 9%, 10%, or 15% w/w.

The concentration of mannan-oligosaccharides with a DP of ten in a mannan-oligosaccharide mixture may be 2% to 15% w/w. The concentration of mannan-oligosaccharides with a DP of ten may be at least 1%, 2%, 3%, 4%, 5%, 6%, 7%, 8%, 9%, 10%, or 15% w/w.

The concentration of mannan-oligosaccharides with a DP of eleven in a mannan-oligosaccharide mixture may be 2% to 15% w/w. The concentration of mannan-oligosaccharides with a DP of eleven may be at least 1%, 2%, 3%, 4%, 5%, 6%, 7%, 8%, 9%, 10%, or 15% w/w.

The concentration of mannan-oligosaccharides with a DP of twelve in a mannan-oligosaccharide mixture may be 2% to 15% w/w. The concentration of mannan-oligosaccharides with a DP of twelve may be at least 1%, 2%, 3%, 4%, 5%, 6%, 7%, 8%, 9%, 10%, or 15% w/w.

A composition may comprise a combination of polysaccharides and oligosaccharides. In some embodiments, a composition may comprise a combination of oligosaccharides and soluble polysaccharides. The source of the polysaccharides in such compositions may include cellulose, such as biomass, for example, the undigested component of partially digested biomass, such as the undigested biomass from the same reaction as that which produced the oligosaccharides. The polysaccharides in the undigested biomass may comprise lignin, polyphenol, cellulose, lignocellulose, or any other suitable polysaccharides as described herein. Addition of polysaccharides (e.g., soluble polysaccharides) to oligosaccharide mixtures can be done to improve the gastrointestinal tolerance of the oligosaccharide mixtures. Oligosaccharide consumption can cause gastrointestinal distress, including diarrhea, discomfort, and bloating.

The compositions described herein may have an improved gastrointestinal tolerance such as, less or no discomfort, bloating, diarrhea, or gastrointestinal distress as compared to a saccharide composition available commercially or a saccharide composition comprising primarily monosaccharides and/or disaccharides. For example, a subject who ingests one or more of the compositions provided herein may have an improved gastrointestinal tolerance such as, less or no discomfort, bloating, diarrhea, or gastrointestinal distress as compared to if, or when, the subject ingests a saccharide composition available commercially or a saccharide composition comprising primarily monosaccharides and/or disaccharides.

The concentration of undigested biomass in a composition may be 1% to 50% w/w. The concentration of undigested biomass in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of undigested biomass in a composition may be at least 1%, 5%, 10%, 15%, 20%, 25%, 30%, 35%, 40%, or 45% w/w. The concentration of undigested biomass in a composition may be at most 5%, 10%, 15%, 20%, 25%, 30%, 35%, 40%, 45%, or 50% w/w.

The concentration of soluble polysaccharides in a composition may be 1% to 50% w/w. The concentration of soluble polysaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of soluble polysaccharides in a composition may be at least 1%, 5%, 10%, 15%, 20%, 25%, 30%, 35%, 40%, or 45% w/w. The concentration of soluble polysaccharides in a composition may be at most 5%, 10%, 15%, 20%, 25%, 30%, 35%, 40%, 45%, or 50% w/w.

The concentration of xylo-oligosaccharides in a composition may be 1% to 80% w/w. The concentration of xylo-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 1% to 55%, 1% to 60%, 1% to 65%, 1% to 70%, 1% to 75%, 5% to 10%, 5% to 15%, 5% to 20%, 5% to 25%, 5% to 30%, 5% to 35%, 5% to 40%, 5% to 45%, 5% to 50%, 5% to 55%, 5% to 60%, 5% to 65%, 5% to 70%, 5% to 75%, 5% to 80%, 10% to 15%, 10% to 20%, 10% to 25%, 10% to 30%, 10% to 35%, 10% to 40%, 10% to 45%, 10% to 50%, 10% to 55%, 10% to 60%, 10% to 65%, 10% to 70%, 10% to 75%, 10% to 80%, 15% to 20%, 15% to 25%, 15% to 30%, 15% to 35%, 15% to 40%, 15% to 45%, 15% to 50%, 15% to 55%, 15% to 60%, 15% to 65%, 15% to 70%, 15% to 75%, 15% to 80%, 20% to 25%, 20% to 30%, 20% to 35%, 20% to 40%, 20% to 45%, 20% to 50%, 20% to 55%, 20% to 60%, 20% to 65%, 20% to 70%, 20% to 75%, 20% to 80%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, 45% to 50%, or 45% to 80% w/w. The concentration of xylo-oligosaccharides in a composition may be at least 1%, 5%, 10%, 15%, 20%, 25%, 30%, 35%, 40%, 45%, 50%, 55%, 60%, 65%, 70%, or 75% w/w. The concentration of xylo-oligosaccharides in a composition may be at most 5%, 10%, 15%, 20%, 25%, 30%, 35%, 40%, 45%, 50%, 55%, 60%, 65%, 70%, 75%, or 80% w/w.

The concentration of cello-oligosaccharides in a composition may be 1% to 80% w/w. The concentration of cello-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of cello-oligosaccharides in a composition may be at least 1%, 5%, 10%, 15%, 20%, 25%, 30%, 35%, 40%, or 45% w/w. The concentration of cello-oligosaccharides in a composition may be at most 5%, 10%, 15%, 20%, 25%, 30%, 35%, 40%, 45%, or 50% w/w.

In some embodiments, the composition may comprise at least 5% w/w of cello-oligosaccharides and at least 5% w/w of a second oligosaccharides (e.g., at least 5% w/w of xylo-oligosaccharides, mannan-oligosaccharides, or any other suitable oligosaccharides).

The concentration of mannan-oligosaccharides in a composition may be 1% to 80% w/w. The concentration of mannan-oligosaccharides in a composition may be 1% to 5%, 1% to 10%, 1% to 15%, 1% to 20%, 1% to 25%, 1% to 30%, 1% to 35%, 1% to 40%, 1% to 45%, 1% to 50%, 5% to 10%, 5% to 15%, 5% to 20%, 5% to 25%, 5% to 30%, 5% to 35%, 5% to 40%, 5% to 45%, 5% to 50%, 10% to 15%, 10% to 20%, 10% to 25%, 10% to 30%, 10% to 35%, 10% to 40%, 10% to 45%, 10% to 50%, 15% to 20%, 15% to 25%, 15% to 30%, 15% to 35%, 15% to 40%, 15% to 45%, 15% to 50%, 20% to 25%, 20% to 30%, 20% to 35%, 20% to 40%, 20% to 45%, 20% to 50%, 25% to 30%, 25% to 35%, 25% to 40%, 25% to 45%, 25% to 50%, 30% to 35%, 30% to 40%, 30% to 45%, 30% to 50%, 35% to 40%, 35% to 45%, 35% to 50%, 40% to 45%, 40% to 50%, or 45% to 50% w/w. The concentration of mannan-oligosaccharides in a composition may be at least 1%, 5%, 10%, 15%, 20%, 25%, 30%, 35%, 40%, or 45% w/w. The concentration of mannan-oligosaccharides in a composition may be at most 5%, 10%, 15%, 20%, 25%, 30%, 35%, 40%, 45%, or 50% w/w.

A composition may comprise one or more polysaccharides and one or more oligosaccharides. The composition may comprise a polysaccharide and one type of oligosaccharide. The composition may comprise a polysaccharide or plurality of polysaccharides and two forms of oligosaccharides. The composition may comprise a polysaccharide or plurality of polysaccharides and three forms of oligosaccharides. The composition may comprise a polysaccharide or plurality of polysaccharides and four forms of oligosaccharides. The composition may comprise a polysaccharide or plurality of polysaccharides and five forms of oligosaccharides. The oligosaccharides may be xylo-oligosaccharides, cello-oligosaccharides, mannan-oligosaccharides, or any other suitable oligosaccharides described herein.

The composition may comprise 1% to 50% polysaccharides w/w, such as in the type of undigested biomass or extracted soluble polysaccharides, and 5% to 95% oligosaccharides w/w. The composition of polysaccharides may be at least 1%, 2%, 2.5%, 3%, 4%, 5%, 10%, 15%, 20%, 25%, 30%, 35%, 40%, 45%, or 50% w/w. Oligosaccharides in such mixtures may be present at greater than 5%, 10%, 15%, 20%, 25%, 30%, 35%, 40%, 45%, 50%, 55%, 60%, 65%, 70%, 75%, 80%, 85%, 90%, or 95% w/w. The oligosaccharides may be a mixture of one or more oligosaccharides. For instance, a composition may comprise 5% undigested biomass and 50% oligosaccharide mixture w/w as described elsewhere herein. In another instance, a composition may comprise 2.5% soluble polysaccharides and 50% oligosaccharide mixture w/w as described elsewhere herein.

In some embodiments, the composition or ingredient may comprise less than 1%, 5%, 10%, 15%, 20%, 25%, 30%, or 40% w/w monosaccharides. For example, the composition may comprise less than 20% w/w monosaccharides. The composition may include 10% to 40%, 15% to 30%, 18% to 25%, or about 20% w/w monosaccharides. In some embodiments, the composition or ingredient may comprise less than 1%, 5%, 10%, 15%, 20%, 25%, 30%, or 40% w/w glucose. For example, the composition may comprise less than 10% w/w glucose. The composition may include 10% to 40%, 15% to 30%, 18% to 25%, or about 20% w/w glucose. In some embodiments, the composition or ingredient may comprise less than 1%, 5%, 10%, 15%, 20%, 25%, 30%, or 40% w/w xylose. For example, the composition may comprise less than 10% w/w xylose. The composition may include 10% to 40%, 15% to 30%, 18% to 25%, or about 20% w/w xylose.

In certain cases, the ratio of glucose residues to xylose residues (e.g., glucose:xylose) within the composition or ingredient may be 1:1 to 1:9, 1:1 to 1:7, 1:1 to 1:5, 1:1 to 1:3, or 1:1 to 1:2.

In certain embodiments, the composition may comprise less than 30%, 40%, 50%, 60%, 65%, 70%, 75%, or 80% w/w disaccharides. For example, the composition may comprise less than 70% w/w disaccharides. The composition may include 10% to 95%, 15% to 90%, 20% to 80%, 30% to 70%, or 40% to 60% w/w disaccharides. The composition may comprise 5% to 95%, 10% to 92.5%, 15% to 90%, 20% to 70%, 30% to 60%, or 40% to 50% disaccharides. In various embodiments, the composition may comprise at least 0.5%, 1%, 2.5%, 5%, 7.5%, 10%, 15%, or 20% w/w trisaccharides. For example, the composition may comprise at least 5% w/w trisaccharides. In various embodiments, the composition may comprise at least 0.5%, 1%, 2.5%, 5%, 7.5%, 10%, 15%, or 20% w/w trisaccharides. For example, the composition may comprise at least 5% w/w trisaccharides. The composition may comprise 1% to 75%, 2.5% to 60%, 5% to 50%, 10% to 40%, or 20% to 30% trisaccharides. In some cases, the composition may comprise at least 0.1%, 0.5%, 1%, 2.5%, 5%, 7.5%, 10%, 15%, or 20% w/w tetrasaccharides. For example, the composition may comprise at least 1% w/w tetrasaccharides. In various cases, the composition may comprise at least 0.01%, 0.05%, 0.1%, 0.2%, 0.3%, 0.5%, 0.5%, 1%, 2.5%, 5%, 7.5%, or w/w pentasaccharides. For example, the composition may comprise at least 0.1% w/w pentasaccharides.

In some embodiments, the composition is an ingredient (e.g., in a foodstuff). In certain embodiments, the ingredient comprises at least 50%, 60%, 70%, 80%, 90%, 95%, 99%, or 99.5% by dry weight of saccharide present. The ingredient may consist essentially of saccharides. For example, the ingredient may have less than 0.5%, 0.3%, or 0.1% by dry weight of other substances.

The ingredient may comprise an oligosaccharide mixture as described elsewhere herein. The ingredient may comprise at least two of the oligosaccharides. For instance, it may comprise three oligosaccharides, four oligosaccharides, five oligosaccharides, six oligosaccharides, or more oligosaccharides.

In some embodiments, the ingredient comprises cello-oligosaccharides, for instance, cello-oligosaccharides in combination with xylo-oligosaccharides. An alternative ingredient may comprise cello-oligosaccharides in combination with mannan-oligosaccharides.

Ingredients may be used to prepare finished products. The ingredient may also be treated in some physical or chemical way before or during incorporation into a foodstuff, cosmetic, or nutraceutical. It may be directly incorporated into a product, or it may be incorporated into, for example, a dough, cake mixture, chocolate mixture, or other foodstuff precursor; a cosmetic base composition; or a nutraceutical, and, for example, be cooked or otherwise treated in a way which may cause chemical modification, a change of texture, a change of color, or other modification.

A foodstuff, cosmetic, or nutraceutical may be produced from an ingredient described herein. For example, in the food industry, the saccharide formulations produced by the current method may be used as sweeteners, bulking agents, added dietary fiber, or humectants. The ingredient may be used as a sugar substitute. The ingredient may be incorporated into cakes, breads, or other baked goods, or into chocolate or other confectionery such as toffee, fudge, meringue, jam, jelly, or caramel; or drinks, for example, to provide favorable taste or color characteristics or to increase dietary fiber content. In certain instances, the ingredient may be incorporated into animal feed, for example, either as an isolated ingredient or by utilizing the enzymatic reaction mixture directly as feed.

In the cosmetics industry, saccharides can be useful as ingredients, as they may improve texture and moisture retention, act as UV-absorbing molecules, maintain a gel or cream structure, and/or serve as bulking agents. The compositions described herein can be incorporated into nutraceutical compositions, as the dietary fiber they provide can encourage digestive health, well-regulated gut flora, and other benefits to wellbeing. In this context, they may also function as an ingredient in a probiotic drink or other prebiotic or probiotic formulation.

Compositions or ingredients as described herein may be used to alter one or more properties of the finished product. Such properties include, but are not limited to, sweetness, texture, mouthfeel, binding, glazing, smoothness, moistness, viscosity, color, hygroscopicity, flavor, bulking, water-retention, caramelization, surface texture, crystallization, structural properties, and dissolution.

In some cases, the compositions and/or ingredients described herein may provide a property to a finished product which is comparable to or better than the same property as provided by a saccharide mixture comprising primarily monosaccharides and/or disaccharides. The control composition may be a saccharide used commonly in consumables, for instance, a monosaccharide composition such as glucose, fructose, etc, a disaccharide composition such as sucrose or an artificial sugar composition. The control composition may be table sugar, corn syrup, high-fructose corn syrup, or any other suitable composition. The term “comparable,” as used herein, generally means that the two compositions may be up to 100%, up to 95%, up to 90%, or up to 80% identical. For instance, comparable can mean that the composition is up to 90% identical to the control composition.

In some cases, the compositions described herein may be used as sweetener compositions. Sweetener compositions may be used by themselves or as an ingredient in a finished product. The compositions described herein may provide about the same level of sweetness or greater sweetness than an identical amount of a control composition wherein the control composition comprises primarily monosaccharides and/or disaccharides. The compositions described herein may be used to replace the control composition as the sweetener in a finished product. In some cases, the sweetness of a composition may be 5%, 10%, 15%, 20%, 30%, 40%, 50%, 70%, 80%, 90%, or 100% more than an identical amount of the control composition.

The compositions described herein may provide a comparable flavor profile or better flavor profile than an identical amount of a control composition wherein the control composition comprises primarily monosaccharides and/or disaccharides. The compositions described herein may be used to replace the control composition as a flavor enhancer in a finished product. In some cases, the flavor of a composition may be 5%, 10%, 15%, 20%, 30%, 40%, 50%, 70%, 80%, 90%, or 100% more than an identical amount of the control composition.

The compositions described herein may provide a comparable texture profile or better texture profile than an identical amount of a control composition wherein the control composition comprises primarily monosaccharides and/or disaccharides. The compositions described herein may be used to replace the control composition as a texture enhancer in a finished product.

The compositions described herein may provide a comparable binding profile or better binding profile than an identical amount of a control composition wherein the control composition comprises primarily monosaccharides and/or disaccharides. The compositions described herein may be used to replace the control composition as a binding enhancer in a finished product.

The compositions described herein may provide a comparable glazing profile or better glazing profile than an identical amount of a control composition wherein the control composition comprises primarily monosaccharides and/or disaccharides. The compositions described herein may be used to replace the control composition as a glazing enhancer in a finished product.

The compositions described herein may provide a comparable moistness or better moistness than an identical amount of a control composition wherein the control composition comprises primarily monosaccharides and/or disaccharides. The compositions described herein may be used to replace the control composition to provide moistness in a finished product.

The compositions described herein may provide a comparable color profile or better color profile than an identical amount of a control composition wherein the control composition comprises primarily monosaccharides and/or disaccharides. The compositions described herein may be used to replace the control composition as a color enhancer in a finished product.

The compositions described herein may provide a comparable dissolution profile or better dissolution profile than an identical amount of a control composition wherein the control composition comprises primarily monosaccharides and/or disaccharides. The compositions described herein may be used to replace the control composition as a dissolution enhancer in a finished product. In some cases, the dissolution of a composition may be 5%, 10%, 15%, 20%, 30%, 40%, 50%, 70%, 80%, 90%, or 100% more than an identical amount of the control composition.

The compositions described herein may provide a comparable mouthfeel or better mouthfeel than an identical amount of a control composition wherein the control composition comprises primarily monosaccharides and/or disaccharides.

The compositions described herein may provide a comparable viscosity or better viscosity than an identical amount of a control composition wherein the control composition comprises primarily monosaccharides and/or disaccharides.

The compositions described herein may provide a comparable hygroscopicity or better hygroscopicity than an identical amount of a control composition wherein the control composition comprises primarily monosaccharides and/or disaccharides. In some cases, the hygroscopicity of a composition may be 5%, 10%, 15%, 20%, 30%, 40%, 50%, 70%, 80%, 90%, or 100% more than an identical amount of the control composition.

The compositions described herein may provide a comparable water-retention or better water-retention than an identical amount of a control composition wherein the control composition comprises primarily monosaccharides and/or disaccharides. In some cases, the water-retention of a composition may be 5%, 10%, 15%, 20%, 30%, 40%, 50%, 70%, 80%, 90%, or 100% more than an identical amount of the control composition.

The compositions described herein may provide a lower calorie composition than an identical amount of a control composition wherein the control composition comprises primarily monosaccharides and/or disaccharides. In some cases, the calorie count of a composition may be 5%, 10%, 15%, 20%, 30%, 40%, 50%, 70%, 80%, 90%, or 100% less than an identical amount of the control composition.

The compositions described herein may provide a lower glycemic index than an identical amount of a control composition wherein the control composition comprises primarily monosaccharides and/or disaccharides. In some cases, the glycemic index of a composition may be 5%, 10%, 15%, 20%, 30%, 40%, 50%, 70%, 80%, 90%, or 100% less than an identical amount of the control composition.

The compositions described herein may provide a comparable bulking or better bulking than an identical amount of a control composition wherein the control composition comprises primarily monosaccharides and/or disaccharides.

The compositions described herein may provide a comparable caramelization or better caramelization than an identical amount of a control composition wherein the control composition comprises primarily monosaccharides and/or disaccharides.

The compositions described herein may provide a comparable surface texture or better surface texture than an identical amount of a control composition wherein the control composition comprises primarily monosaccharides and/or disaccharides.

The compositions described herein may provide a comparable crystallization or better crystallization than an identical amount of a control composition wherein the control composition comprises primarily monosaccharides and/or disaccharides.

The compositions described herein may provide comparable structural properties as an identical amount of a control composition wherein the control composition comprises primarily monosaccharides and/or disaccharides.

The compositions described herein may provide less aftertaste compared to an identical amount of a control composition wherein the control composition comprises primarily monosaccharides and/or disaccharides.

Different compositions of oligosaccharides may have improved dissolution profiles, hygroscopicity profiles, and taste profiles compared to the oligosaccharides used alone.

The compositions or ingredients as described herein may be used to increase the fiber content of a finished product such as a foodstuff or a nutraceutical. The compositions may provide a higher level of fiber in the finished product as compared to an identical amount of a control composition wherein the control composition comprises primarily monosaccharides and/or disaccharides. In some cases, the compositions may improve the fiber content of the finished product without negatively, or substantially negatively, affecting any other properties such as taste, sweetness, mouthfeel, texture, binding, or any other properties described herein. In some cases, the fiber content of a composition may be 5%, 10%, 15%, 20%, 30%, 40%, 50%, 70%, 80%, 90%, or 100% more than an identical amount of the control composition.

Ingredients may be used to alter the properties of a finished product such as foodstuff or nutraceutical or cosmetic. In order to alter the properties of the finished products, the finished products may additionally comprise a polysaccharide, for example, a cellulosic polysaccharide, such as cellulose, or a polysaccharide derivative, for example, a cellulose derivative, such as carboxymethylcellulose, or a polysaccharide aggregate, for example, a portion of lignocellulosic biomass. In some instances, the finished products can comprise greater than 0% to 40% by dry weight of polysaccharide, polysaccharide derivative, or polysaccharide aggregate, for example, greater than 1% to 30% by dry weight of polysaccharide, polysaccharide derivative, or polysaccharide aggregate, for example, greater than 5% to 25% by dry weight of polysaccharide, polysaccharide derivative, or polysaccharide aggregate, for example, greater than 10% to 20% by dry weight of polysaccharide, polysaccharide derivative, or polysaccharide aggregate.

The concentration of a composition comprising polysaccharides and a mixture of oligosaccharides in a finished product may be 0.1% to 40% w/w. The concentration of a composition comprising polysaccharides and a mixture of oligosaccharides in a finished product may be 0.1% to 0.5%, 0.1% to 1%, 0.1% to 5%, 0.1% to 10%, 0.1% to 15%, 0.1% to 20%, 0.1% to 25%, 0.1% to 30%, 0.1% to 35%, 0.1% to 40%, 0.5% to 1%, 0.5% to 5%, 0.5% to 10%, 0.5% to 15%, 0.5% to 20%, 0.5% to 25%, 0.5% to 30%, 0.5% to 35%, 0.5% to 40%, 1% to 5%, 1% to 10%, 1% to 15%, 1% to 20%, 1% to 25%, 1% to 30%, 1% to 35%, 1% to 40%, 5% to 10%, 5% to 15%, 5% to 20%, 5% to 25%, 5% to 30%, 5% to 35%, 5% to 40%, 10% to 15%, 10% to 20%, 10% to 25%, 10% to 30%, 10% to 35%, 10% to 40%, 15% to 20%, 15% to 25%, 15% to 30%, 15% to 35%, 15% to 40%, 20% to 25%, 20% to 30%, 20% to 35%, 20% to 40%, 25% to 30%, 25% to 35%, 25% to 40%, 30% to 35%, 30% to 40%, or 35% to 40% w/w. The concentration of a composition comprising polysaccharides and a mixture of oligosaccharides in a finished product may be at least 0.1%, 0.5%, 1%, 5%, 10%, 15%, 20%, 25%, 30%, or 35% w/w. The concentration of a composition comprising polysaccharides and a mixture of oligosaccharides in a finished product may be at most 0.5%, 1%, 5%, 10%, 15%, 20%, 25%, 30%, 35%, or 40% w/w.

In some cases, the oligosaccharide mixtures (e.g., cello-oligosaccharides and xylo-oligosaccharides) may form at least 20%, 30%, 40%, 50%, 60%, or 70% w/w of the consumable composition or ingredient. For example, 50% w/w of a combination of cello-oligosaccharides and xylo-oligosaccharides may form the consumable composition or ingredient.

### EXAMPLES

The following illustrative examples are representative of embodiments of the compositions and methods described herein and are not meant to be limiting in any way.

### Example 1A—Heating of Xylo-Oligosaccharides in an Open System

The following steps were performed to observe the impact of heat and pH on xylo-oligosaccharides:
1. Four saccharide solutions comprising xylo-oligosaccharides of primarily degree of polymerization (DP) 2-6 (XOS) were created by dissolving saccharides in water, some solutions including an acidity regulator. The four solutions were:
   a. XOS in water, pH 7
   b. XOS in water, pH 7
   c. XOS in water and lemon juice, pH 2
   d. XOS in water and baking soda, pH 9
2. The four solutions were heated, and the resulting products analyzed. For the four solutions:
   a. XOS in water at pH 7 was heated to 110° C. (FIG. 1A). The solution was yellow when dissolved in water, and sticky, dissolving around 60° C. The solution formed soft, sticky threads at 110° C. The resulting solution tasted vaguely sweet, and had a sticky mouthfeel.
   b. XOS in water at pH 7 was heated to 177° C. (FIG. 1B). The solution got very dark at 177° C. and smelled burnt. The solution began darkening in color around 120° C., with the darkest color formation beginning at 150° C. The solution formed a hard crack consistency at 177° C. When water was added, the hard crack consistency re-dissolved slowly.
   c. XOS in water and lemon juice at pH 2 was heated to 177° C. (FIG. 1C). This solution behaved the same as solution (b).
   d. XOS in water and baking soda at pH 9 was heated to 177° C. (FIG. 1D). This solution became dark in color around 93° C., and became very dark at 105° C. The solution began bubbling at around 55° C. All water evaporated from the solution, and re-dissolving was obtained slowly.

### Example 1B—Heating of Xylo-Oligosaccharides in a Closed System

The following steps were performed to observe the impact of heat and pH on xylo-oligosaccharides:

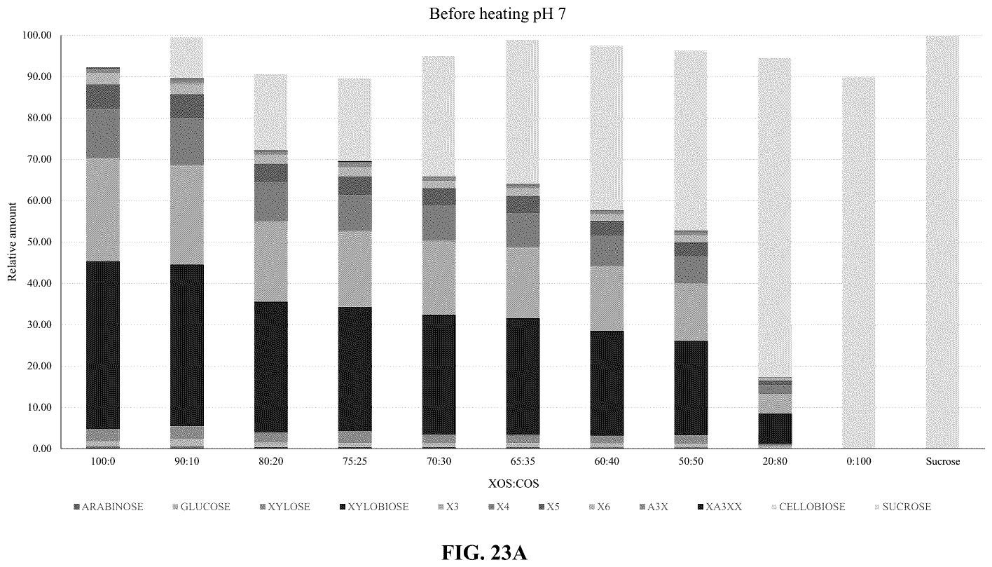

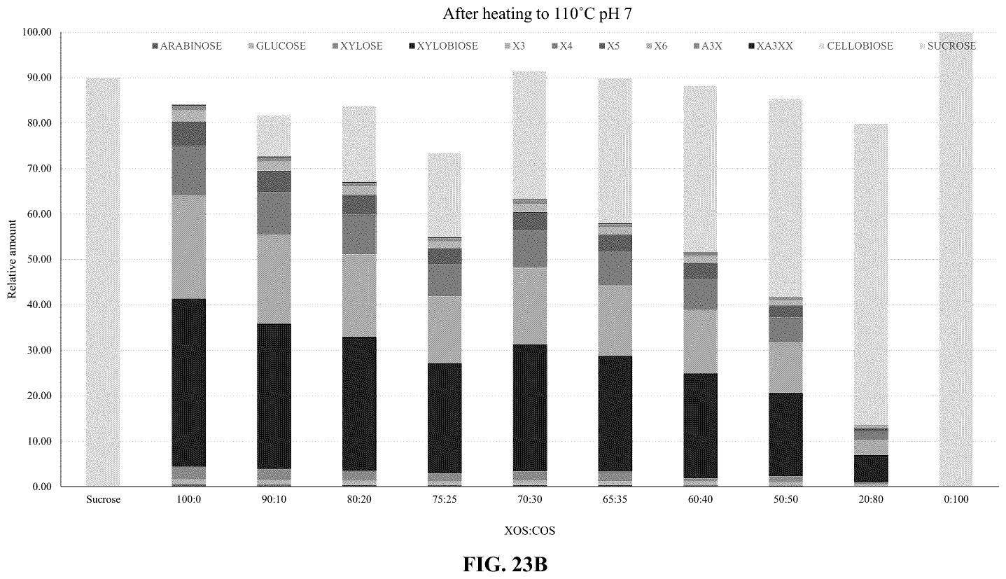

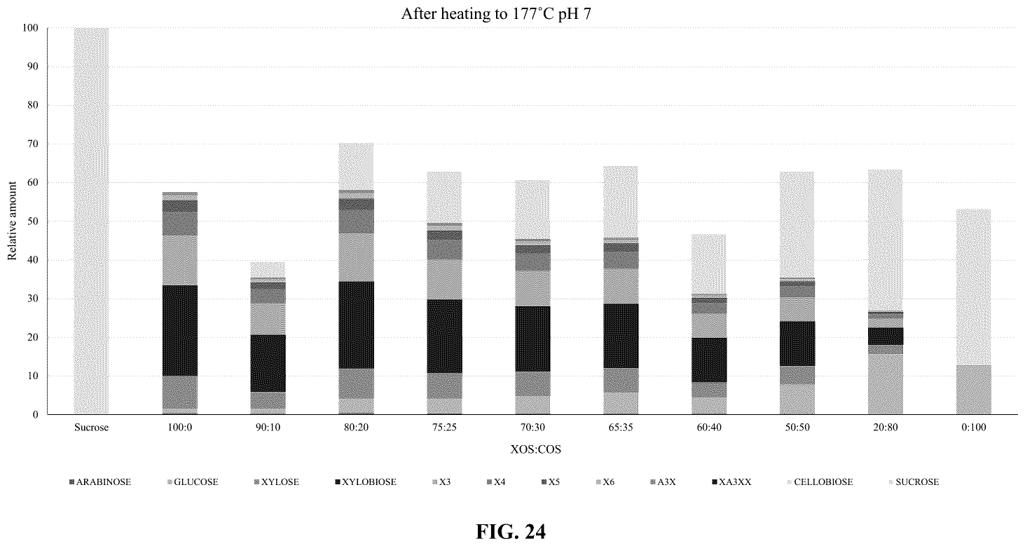

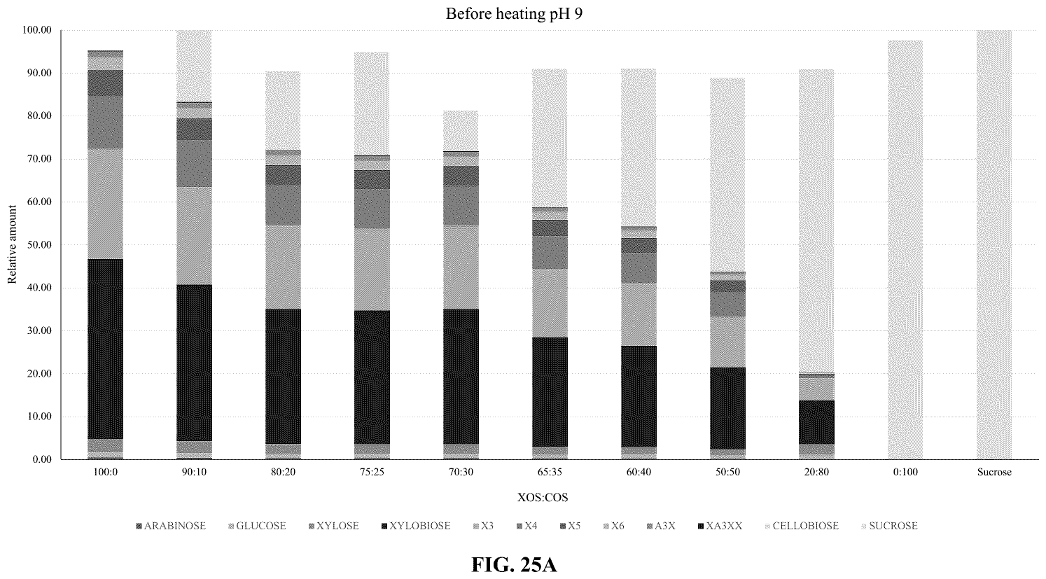

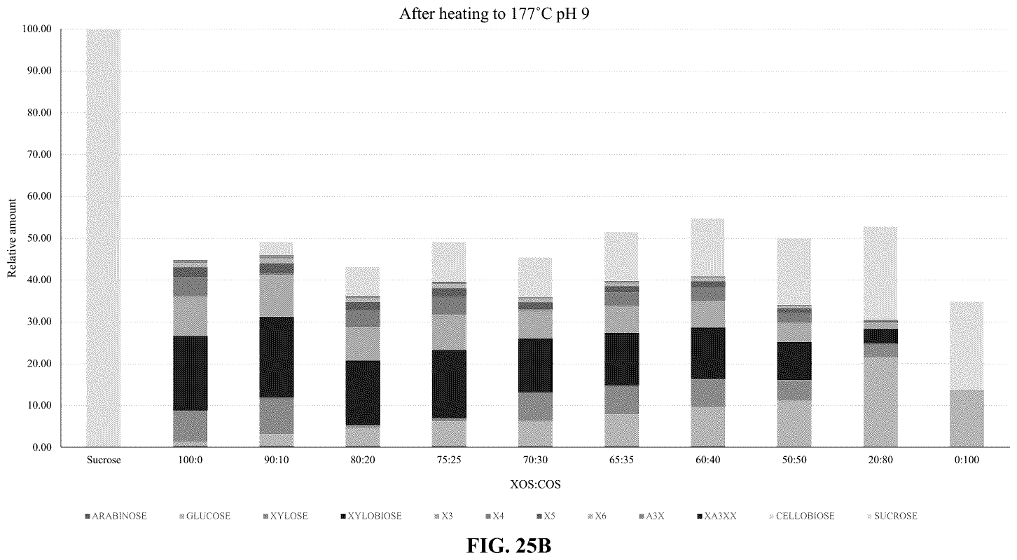

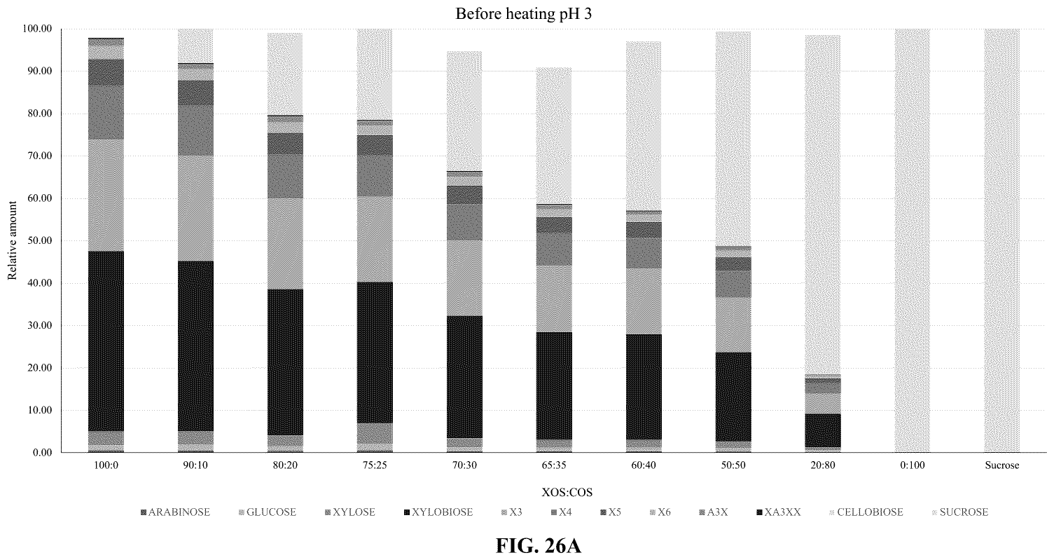

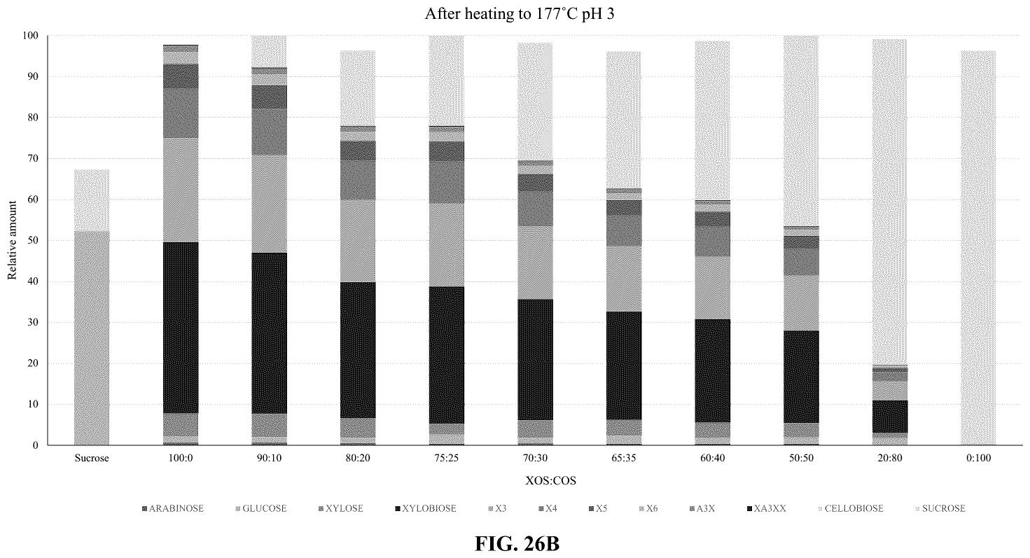

Four saccharide solutions comprising xylo-oligosaccharides of primarily degree of polymerization (DP) 2-6 (XOS) were created by dissolving saccharides (100 mg/mL) in acidity regulated solutions. The four solutions were:
a. XOS in pH 7 buffer
b. XOS in pH 7 buffer
c. XOS in pH 3 buffer
d. XOS in pH 9 buffer
   The four solutions were transferred to individual 10 mL microwave reactor tubes and sealed. The solutions were rapidly heated to temperatures described below and held at the specified temperature for 2 min. After 2 min the samples were rapidly cooled, and the resulting products analysed by diluting 1:5000 for ion-exchange chromatography. For the four solutions:
a. XOS in pH 7 buffer (before heating FIG. 23A, Table 2A) was heated to 110° C. (FIG. 23B, Table 2B). The solution was yellow when dissolved and slight colour development was observed (Table 2C).
b. XOS in pH 7 buffer (before heating FIG. 23A, Table 2A) was heated to 177° C. (FIG. 24, Table 2D). The solution browned, colour development was measured (Table 2C).
c. XOS in pH 3 buffer (before heating FIG. 26A, Table 2E) was heated to 177° C. (FIG. 26B, Table 2F), no colour development was observed (Table 2G).
d. XOS in pH 9 buffer (before heating FIG. 25A, Table 2H) was heated to 177° C. (FIG. 25B, Table 21), the solution turned a red-brown colour, this colour change was measured (Table 2J).

Samples were diluted 1:5000 for ion-exchange chromatography analysis of sugars. Assumptions during quantification
1. The detector response is the same for all compounds
2. Individual compounds calibration curves follow the same gradient as the total XOS calibration curve, since experimental XOS was used as standards.
   Calculations of the relative amount of compounds was completed using different standards prepared:
XOS (arabinose, glucose, xylose, xylobiose, X3, X4, X5, X6, A3X, XA3XX) from total experimental XOS
COS from experimental cellobiose
Glucose in 0:100 samples from analytical grade glucose

TABLE 2A
Relative amount of saccharides in solutions of XOS (100:0), COS (0:100), sucrose
and mixtures of XOS:COS (90:10-20:80) at pH 7 before heating.

| pH 7 | ARABINOSE | GLUCOSE | XYLOSE | XYLOBIOSE | CELLOBIOSE | X3 | X4 | X5 | X6 | A3X | XA3XX | SUCROSE |
|---|---|---|---|---|---|---|---|---|---|---|---|---|
| XOS: | | | | | | | | | | | | 100.00 |
| COS\| | | | | | | | | | | | | |
| Sucrose | | | | | | | | | | | | |
| 100:0 | 0.52 | 1.25 | 2.93 | 40.65 | | 24.95 | 11.89 | 5.92 | 2.72 | 1.12 | 0.25 | |
| 90:10 | 0.51 | 1.83 | 3.07 | 39.17 | 10.02 | 24.02 | 11.44 | 5.70 | 2.49 | 1.09 | 0.23 | |
| 80:20 | 0.38 | 1.08 | 2.42 | 31.64 | 18.56 | 19.42 | 9.35 | 4.61 | 2.17 | 0.91 | 0.18 | |
| 75:25 | 0.38 | 1.01 | 2.80 | 30.06 | 20.08 | 18.37 | 8.75 | 4.49 | 2.23 | 1.21 | 0.26 | |
| 70:30 | 0.36 | 0.92 | 2.10 | 29.05 | 29.30 | 17.86 | 8.51 | 4.22 | 1.77 | 0.84 | 0.16 | |
| 65:35 | 0.35 | 0.99 | 2.00 | 28.23 | 35.02 | 17.16 | 8.27 | 4.15 | 1.87 | 0.81 | 0.17 | |
| 60:40 | 0.33 | 0.92 | 1.86 | 25.41 | 39.95 | 15.62 | 7.38 | 3.63 | 1.61 | 0.74 | 0.14 | |
| 50:50 | 0.29 | 0.90 | 2.08 | 22.78 | 43.69 | 13.86 | 6.67 | 3.40 | 1.65 | 0.91 | 0.21 | |
| 20:80 | 0.08 | 0.48 | 0.52 | 7.45 | 77.38 | 4.64 | 2.25 | 1.09 | 0.49 | 0.22 | 0.04 | |
| 0:100 | | | | | 90.05 | | | | | | | |

TABLE 2B
Relative amount of saccharides in solutions of XOS (100:0), COS (0:100), sucrose
and mixtures of XOS:COS (90:10-20:80) after heating to 110° C. at pH 7

| 110° C. | | | | | | | | | | | | |
|---|---|---|---|---|---|---|---|---|---|---|---|---|
| pH 7 | ARABINOSE | GLUCOSE | XYLOSE | XYLOBIOSE | CELLOBIOSE | X3 | X4 | X5 | X6 | A3X | XA3XX | SUCROSE |
| XOS:COS | | | | | | | | | | | | 89.90 |
| 100:0 | 0.48 | 1.12 | 2.77 | 36.98 | | 22.67 | 10.91 | 5.38 | 2.49 | 1.01 | 0.20 | |
| 90:10 | 0.39 | 1.02 | 2.46 | 31.97 | 9.11 | 19.60 | 9.35 | 4.66 | 2.05 | 0.90 | 0.19 | |
| 80:20 | 0.37 | 0.92 | 2.16 | 29.52 | 16.77 | 18.14 | 8.70 | 4.39 | 1.84 | 0.84 | 0.18 | |
| 75:25 | 0.30 | 0.83 | 1.81 | 24.23 | 18.57 | 14.71 | 7.09 | 3.50 | 1.56 | 0.71 | 0.15 | |
| 70:30 | 0.34 | 0.98 | 2.03 | 27.92 | 28.31 | 16.98 | 8.11 | 4.04 | 1.84 | 0.77 | 0.17 | |
| 65:35 | 0.32 | 0.92 | 2.09 | 25.44 | 31.88 | 15.53 | 7.47 | 3.68 | 1.65 | 0.71 | 0.14 | |
| 60:40 | 0.29 | 0.88 | 0.64 | 23.10 | 36.66 | 13.98 | 6.85 | 3.45 | 1.56 | 0.66 | 0.13 | |
| 50:50 | 0.22 | 0.74 | 1.32 | 18.34 | 43.83 | 11.07 | 5.47 | 2.68 | 1.12 | 0.53 | 0.13 | |
| 20:80 | 0.06 | 0.47 | 0.41 | 6.01 | 66.32 | 3.35 | 1.81 | 0.79 | 0.37 | 0.17 | 0.04 | |
| 0:100 | | | | | 100 | | | | | | | |

TABLE 2C
pH and absorbance at 420 nm for solutions of sucrose, XOS (100:0), COS (0:100) and mixtures of
XOS:COS (90:10-20:80) for samples labelled as pH 7 after heating to 110° C. and 177° C.

| | | | | | A420 | A420 |
|---|---|---|---|---|---|---|
| | | pH after | pH after | A420 | after | after |
| | pH before | heating | heating to | before | heating to | heating |
| Sample | heating | to 110° C. | 177° C. | heating | 110° C. | to 177° C. |
| Sucrose | 6.78 | 6.88 | 6.84 | 0.115 | 0.086 | 0.18 |
| 100:0 | 6.9 | 6.87 | 5.25 | 0.166 | 0.302 | 2.447 |
| 90:10 | 6.9 | 6.87 | 5.34 | 0.158 | 0.274 | 2.651 |
| 80:20 | 6.95 | 6.87 | 5.36 | 0.147 | 0.213 | 2.754 |
| 75:25 | 6.92 | 6.88 | 5.36 | 0.157 | 0.188 | 2.516 |
| 70:30 | 6.94 | 6.89 | 5.35 | 0.143 | 0.228 | 2.475 |
| 65:35 | 6.94 | 6.88 | 5.38 | 0.308 | 0.209 | 2.531 |
| 60:40 | 6.93 | 6.92 | 5.39 | 0.168 | 0.184 | 2.601 |
| 50:50 | 6.95 | 6.8 | 5.4 | 0.133 | 0.271 | 2.524 |
| 20:80 | 6.92 | 6.87 | 5.56 | 0.12 | 0.241 | 2.578 |
| 0:100 | 6.86 | 6.88 | 5.89 | 0.119 | 0.192 | 2.234 |

TABLE 2D
Relative amount of saccharides in solutions of XOS (100:0), COS (0:100), sucrose
and mixtures of XOS:COS (90:10-20:80) after heating to 177° C. at pH 7

| 177° C. | | | | | | | | | | | | |
|---|---|---|---|---|---|---|---|---|---|---|---|---|
| pH 7 | ARABINOSE | GLUCOSE | XYLOSE | XYLOBIOSE | CELLOBIOSE | X3 | X4 | X5 | X6 | A3X | XA3XX | SUCROSE |
| XOS: | | | | | | | | | | | | 106.68 |
| COS\| | | | | | | | | | | | | |
| Sucrose | | | | | | | | | | | | |
| 100:0 | 0.34 | 1.17 | 8.47 | 23.42 | | 12.87 | 6.18 | 2.96 | 1.28 | 0.60 | 0.12 | |
| 90:10 | 0.20 | 1.32 | 4.38 | 14.74 | 4.18 | 8.10 | 3.69 | 1.74 | 0.76 | 0.33 | 0.08 | |
| 80:20 | 0.37 | 3.75 | 7.75 | 22.53 | 12.36 | 12.44 | 6.06 | 2.95 | 1.41 | 0.59 | 0.10 | |
| 75:25 | 0.29 | 3.81 | 6.60 | 19.04 | 13.52 | 10.28 | 5.10 | 2.42 | 1.27 | 0.50 | 0.11 | |
| 70:30 | 0.26 | 4.49 | 6.37 | 16.89 | 15.45 | 9.14 | 4.51 | 2.11 | 0.97 | 0.45 | 0.11 | |
| 65:35 | 0.25 | 5.43 | 6.32 | 16.65 | 18.75 | 9.02 | 4.46 | 2.14 | 0.87 | 0.41 | 0.09 | |
| 60:40 | 0.19 | 4.22 | 3.90 | 11.53 | 15.59 | 6.19 | 2.80 | 1.37 | 0.59 | 0.30 | 0.06 | |
| 50:50 | 0.17 | 7.61 | 4.79 | 11.55 | 27.56 | 6.15 | 2.97 | 1.22 | 0.57 | 0.29 | 0.06 | |
| 20:80 | 0.10 | 15.52 | 2.37 | 4.50 | 36.57 | 2.31 | 1.19 | 0.57 | 0.22 | 0.13 | 0.00 | |
| 0:100 | | 12.81 | | | 40.43 | | | | | | | |

TABLE 2E
Relative amount of saccharides in solutions of XOS (100:0), COS (0:100), sucrose
and mixtures of XOS:COS (90:10-20:80) at pH 3 before heating.

| pH 3 | ARABINOSE | GLUCOSE | XYLOSE | XYLOBIOSE | CELLOBIOSE | X3 | X4 | X5 | X6 | A3X | XA3XX | SUCROSE |
|---|---|---|---|---|---|---|---|---|---|---|---|---|
| XOS: | | | | | | | | | | | | 115.72 |
| COS\| | | | | | | | | | | | | |
| Sucrose | | | | | | | | | | | | |
| 100:0 | 0.52 | 1.24 | 3.25 | 42.52 | | 26.32 | 12.65 | 6.32 | 3.10 | 1.70 | 0.25 | |
| 90:10 | 0.50 | 1.38 | 3.16 | 40.16 | 9.72 | 24.82 | 11.86 | 5.93 | 2.67 | 1.20 | 0.24 | |
| 80:20 | 0.42 | 1.07 | 2.62 | 34.44 | 19.52 | 21.43 | 10.31 | 5.13 | 2.48 | 1.44 | 0.23 | |
| 75:25 | 0.51 | 1.53 | 4.88 | 33.32 | 25.29 | 20.13 | 9.69 | 4.80 | 2.30 | 1.20 | 0.14 | |
| 70:30 | 0.34 | 0.92 | 2.18 | 28.81 | 28.33 | 17.79 | 8.59 | 4.36 | 2.10 | 1.15 | 0.17 | |
| 65:35 | 0.29 | 0.88 | 1.86 | 25.37 | 32.26 | 15.72 | 7.60 | 3.84 | 1.87 | 1.06 | 0.15 | |
| 60:40 | 0.31 | 0.84 | 1.87 | 24.87 | 39.97 | 15.51 | 7.29 | 3.72 | 1.75 | 0.74 | 0.17 | |
| 50:50 | 0.25 | 0.80 | 1.58 | 21.02 | 50.76 | 12.93 | 6.34 | 3.15 | 1.56 | 0.90 | 0.13 | |
| 20:80 | 0.09 | 0.53 | 0.62 | 7.90 | 80.15 | 4.78 | 2.41 | 1.15 | 0.55 | 0.31 | 0.04 | |
| 0:100 | | | | | 100.04 | | | | | | | |

TABLE 2F
Relative amount of saccharides in solutions of XOS (100:0), COS (0:100), sucrose
and mixtures of XOS:COS (90:10-20:80) after heating to 177° C. at pH 3

| 177° C. | | | | | | | | | | | | |
|---|---|---|---|---|---|---|---|---|---|---|---|---|
| pH 3 | ARABINOSE | GLUCOSE | XYLOSE | XYLOBIOSE | CELLOBIOSE | X3 | X4 | X5 | X6 | A3X | XA3XX | SUCROSE |
| XOS:COS\| | | 52.22 | | | | | | | | | | 15.09 |
| Sucrose | | | | | | | | | | | | |
| 100:0 | 0.64 | 1.53 | 5.60 | 41.77 | | 25.38 | 12.09 | 6.00 | 2.93 | 1.57 | 0.19 | |
| 90:10 | 0.60 | 1.43 | 5.70 | 39.24 | 8.92 | 23.80 | 11.35 | 5.67 | 2.73 | 1.45 | 0.18 | |
| 80:20 | 0.51 | 1.36 | 4.74 | 33.17 | 18.43 | 20.10 | 9.51 | 4.81 | 2.28 | 1.28 | 0.15 | |
| 75:25 | 0.39 | 2.23 | 2.64 | 33.46 | 25.29 | 20.26 | 10.22 | 4.89 | 2.34 | 1.30 | 0.18 | |
| 70:30 | 0.45 | 1.43 | 4.24 | 29.50 | 28.89 | 17.79 | 8.52 | 4.23 | 2.01 | 1.10 | 0.13 | |
| 65:35 | 0.40 | 1.99 | 3.82 | 26.40 | 33.56 | 15.96 | 7.49 | 3.75 | 1.70 | 1.01 | 0.12 | |
| 60:40 | 0.38 | 1.45 | 3.73 | 25.22 | 38.98 | 15.21 | 7.39 | 3.61 | 1.72 | 0.92 | 0.13 | |
| 50:50 | 0.35 | 1.59 | 3.49 | 22.54 | 50.55 | 13.44 | 6.47 | 3.18 | 1.52 | 0.80 | 0.10 | |
| 20:80 | 0.13 | 1.64 | 1.26 | 7.93 | 79.56 | 4.66 | 2.26 | 1.01 | 0.53 | 0.22 | | |
| 0:100 | | 0.27 | | | 96.10 | | | | | | | |

TABLE 2G
pH and absorbance at 420 nm for solutions of sucrose, XOS
(100:0), COS (0:100) and mixtures of XOS:COS (90:10-20:80)
for samples labelled as pH 3, after heating to 177° C.

| | | pH after | A420 | A420 after |
|---|---|---|---|---|
| | pH before | heating to | before | heating to |
| Sample | heating | 177° C. | heating | 177° C. |
| Sucrose | 3 | 3.08 | 0.082 | 0.089 |
| 100:0 | 3.09 | 3.17 | 0.148 | 0.139 |
| 90:10 | 3.09 | 3.16 | 0.117 | 0.142 |
| 80:20 | 3.05 | 3.15 | 0.146 | 0.137 |
| 75:25 | 3.05 | 3.16 | 0.135 | 0.133 |
| 70:30 | 3.07 | 3.18 | 0.141 | 0.137 |
| 65:35 | 3.08 | 3.16 | 0.14 | 0.13 |
| 60:40 | 3.06 | 3.16 | 0.17 | 0.29 |
| 50:50 | 3.06 | 3.11 | 0.143 | 0.122 |
| 20:80 | 3.08 | 3.07 | 0.115 | 0.104 |
| 0:100 | 3.01 | 3.16 | 0.127 | 0.101 |

TABLE 2H
Relative amount of saccharides in solutions of XOS (100:0), COS (0:100), sucrose
and mixtures of XOS:COS (90:10-20:80) at pH 9 before heating.

| pH 9 | ARABINOSE | GLUCOSE | XYLOSE | XYLOBIOSE | CELLOBIOSE | X3 | X4 | X5 | X6 | A3X | XA3XX | SUCROSE |
|---|---|---|---|---|---|---|---|---|---|---|---|---|
| XOS:COS\| | | | | | | | | | | | | 102.74 |
| Sucrose | | | | | | | | | | | | |
| 100:0 | 0.51 | 1.19 | 3.05 | 41.93 | | 25.64 | 12.25 | 6.09 | 2.90 | 1.42 | 0.22 | |
| 90:10 | 0.44 | 1.07 | 2.80 | 36.45 | 24.19 | 22.65 | 10.92 | 5.09 | 2.38 | 1.25 | 0.21 | |
| 80:20 | 0.35 | 0.94 | 2.36 | 31.39 | 18.55 | 19.53 | 9.31 | 4.66 | 2.20 | 1.08 | 0.16 | |
| 75:25 | 0.36 | 0.99 | 2.23 | 31.13 | 24.19 | 19.02 | 9.19 | 4.45 | 2.14 | 1.11 | 0.20 | |
| 70:30 | 0.35 | 1.00 | 2.23 | 31.47 | 9.61 | 19.40 | 9.22 | 4.64 | 2.16 | 1.12 | 0.17 | |
| 65:35 | 0.29 | 0.84 | 1.85 | 25.50 | 32.35 | 15.88 | 7.67 | 3.81 | 1.86 | 0.86 | 0.17 | |
| 60:40 | 0.27 | 0.90 | 1.75 | 23.56 | 36.93 | 14.57 | 7.04 | 3.47 | 1.66 | 0.87 | 0.13 | |
| 50:50 | 0.22 | 0.70 | 1.45 | 19.10 | 45.23 | 11.74 | 5.73 | 2.79 | 1.28 | 0.64 | 0.10 | |
| 20:80 | 0.08 | 1.04 | 2.45 | 10.17 | 70.76 | 5.16 | 0.77 | 0.32 | 0.14 | 0.04 | 0.06 | |
| 0:100 | | | | | 97.74 | | | | | | | |

TABLE 2I
Relative amount of saccharides in solutions of XOS (100:0), COS (0:100), sucrose
and mixtures of XOS:COS (90:10-20:80) after heating to 177° C. at pH 9

| 177° C. | | | | | | | | | | | | |
|---|---|---|---|---|---|---|---|---|---|---|---|---|
| pH 3 | ARABINOSE | GLUCOSE | XYLOSE | XYLOBIOSE | CELLOBIOSE | X3 | X4 | X5 | X6 | A3X | XA3XX | SUCROSE |
| XOS:COS\| | | | | | | | | | | | | 104.57 |
| Sucrose | | | | | | | | | | | | |
| 100:0 | 0.27 | 1.03 | 7.46 | 17.80 | | 9.45 | 4.65 | 2.33 | 1.09 | 0.55 | 0.10 | |
| 90:10 | 0.29 | 2.91 | 8.63 | 19.33 | 3.35 | 10.02 | 0.36 | 2.38 | 1.19 | 0.63 | 0.09 | |
| 80:20 | 0.26 | 4.44 | 0.63 | 15.37 | 7.03 | 7.96 | 4.05 | 1.97 | 0.93 | 0.47 | 0.09 | |
| 75:25 | 0.27 | 5.92 | 0.73 | 16.32 | 9.61 | 8.47 | 4.25 | 2.05 | 0.99 | 0.49 | 0.07 | |
| 70:30 | 0.21 | 6.05 | 6.82 | 12.92 | 9.64 | 6.65 | 0.32 | 1.65 | 0.81 | 0.32 | 0.05 | |
| 65:35 | 0.22 | 7.65 | 6.81 | 12.64 | 11.82 | 6.47 | 3.21 | 1.50 | 0.77 | 0.37 | 0.04 | |
| 60:40 | 0.20 | 9.41 | 6.68 | 12.32 | 14.02 | 6.41 | 3.18 | 1.46 | 0.73 | 0.34 | 0.05 | |
| 50:50 | 0.12 | 10.99 | 4.99 | 9.03 | 15.90 | 4.61 | 2.29 | 1.14 | 0.57 | 0.23 | 0.04 | |
| 20:80 | 0.12 | 21.38 | 3.25 | 3.57 | 22.29 | 1.53 | 0.08 | 0.36 | 0.17 | 0.10 | | |
| 0:100 | | 13.78 | | | 21.12 | | | | | | | |

TABLE 2J
pH and absorbance at 420 nm for solutions of sucrose, XOS
(100:0), COS (0:100) and mixtures of XOS:COS (90:10-20:80)
for samples labelled as pH 9, after heating to 177° C.

| | | pH after | A420 | A420 after |
|---|---|---|---|---|
| | pH before | heating | before | heating to |
| Sample | heating | 177° C. | heating | 177° C. |
| Sucrose | 8.76 | 8.14 | 0.087 | 0.435 |
| 100:0 | 8.44 | 5.14 | 0.349 | 4.685 |
| 90:10 | 8.42 | 5.14 | 0.415 | 4.742 |
| 80:20 | 8.44 | 5.17 | 0.307 | 4.572 |
| 75:25 | 8.44 | 5.17 | 0.293 | 4.892 |
| 70:30 | 8.45 | 5.13 | 0.288 | 4.992 |
| 65:35 | 8.44 | 5.15 | 0.278 | 4.853 |
| 60:40 | 8.46 | 5.15 | 0.27 | 4.633 |
| 50:50 | 8.47 | 5.23 | 0.246 | 4.569 |
| 20:80 | 8.56 | 5.41 | 0.222 | 4.631 |
| 0:100 | 8.59 | 5.45 | 0.128 | 5.044 |

### Example 2A—Heating of Cello-Oligosaccharides in an Open System

The following steps were performed to observe the impact of heat and pH on cello-oligosaccharide:
1. Four saccharide solutions comprising cello-oligosaccharide were created by dissolving saccharides in water, some solutions including an acidity regulator. The four solutions were:
   a. 1 g/g cello-oligosaccharide at pH 7
   b. 0.1 g/g cello-oligosaccharide at pH 2
   c. 0.1 g/g cello-oligosaccharide at pH 7
   d. 0.1 g/g cello-oligosaccharide at pH 9
2. The four solutions were heated, and the resulting products analyzed. For the four solutions:
   a. 1 g/g cello-oligosaccharide in water at pH 7 could not reach >100° C. (FIG. 2A). Once the water evaporated from the solution, a solid residue of cello-oligosaccharide remained.
   b. 0.1 g/g cello-oligosaccharide in water at pH 7 changed color from white to transparent around 40° C. and began to boil around 95° C. (FIG. 2B). Around 101° C., all water had evaporated and a solid residue of cello-oligosaccharide remained.
   c. 0.1 g/g cello-oligosaccharide in water at pH 2 remained at 98-99° C. for >25 minutes without a change in color (FIG. 2C). The solution began to darken in color around 120° C., with the darkest color around 150° C. The solution reached 177° C., but had a different consistency than the other compositions. The resulting composition was very challenging to solubilize in water.
   d. 0.1 g/g cello-oligosaccharide in water at pH 9 developed a dark color around 100° C., with increasing darkness as temperature both increased and decreased (FIG. 2D). The solution was able to reach 177° C. and could be re-solubilized quickly. The solution smelled sweet in comparison to the XOS solutions.

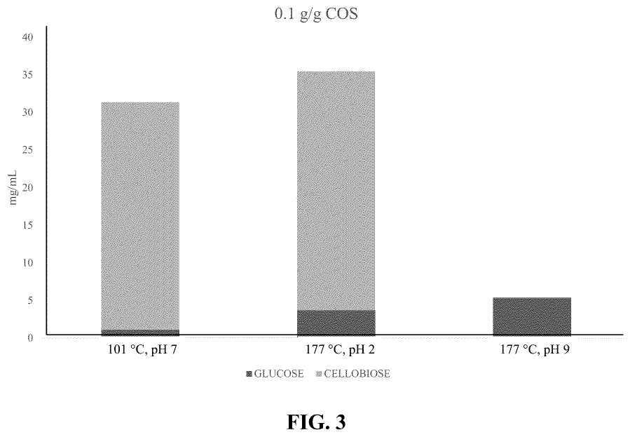

The experiments demonstrate that cello-oligosaccharide solutions cannot be heated to temperatures greater than 100° C. unless the solution is at an acidic pH, and thus cello-oligosaccharide alone cannot caramelize like sucrose. Cello-oligosaccharide at pH 2 heated to 177° C. is chemically stable and only broken down somewhat yielding a small amount of glucose. In contrast, cello-oligosaccharide at pH 9 heated to 177° C. was completely degraded, yielding some glucose but with the majority of the composition being converted into non-enzymatic reaction breakdown products, such as caramelization products (FIG. 3).

### Example 2B—Heating of Cello-Oligosaccharides in a Closed System

The following steps were performed to observe the impact of heat and pH on cello-oligosaccharides:

Four saccharide solutions comprising cello-oligosaccharides were created by dissolving saccharides in acidity regulated solutions (100 mg/mL). The four solutions were:
a. cello-oligosaccharide in pH 7 buffer
b. cello-oligosaccharide in pH 7 buffer
c. cello-oligosaccharide in pH 3 buffer
d. cello-oligosaccharide in pH 9 buffer

The four solutions were transferred to individual 10 mL microwave reactor tubes and sealed. The solutions were rapidly heated to temperatures specified below and held at this temperature for 2 min. After 2 min the samples were rapidly cooled, and the resulting products diluted 1:5000 and analysed by ion-exchange chromatography. For the four solutions:
a. cello-oligosaccharide in pH 7 buffer was heated to 110° C. (FIG. 23B, Table 2A&B). The solution was clear when dissolved and slight yellow colour development was observed (Table 2C).
b. cello-oligosaccharide in pH 7 buffer was heated to 177° C. (FIG. 24, Table 2A&D). The solution browned, colour development was measured (Table 2C).
c. cello-oligosaccharide in pH 3 buffer was heated to 177° C. (FIG. 26B, Table 2E&F), no colour development was observed (Table 2G).
d. cello-oligosaccharide in pH 9 buffer was heated to 177° C. (FIG. 25B, Table 2H&I), the solution turned a red-brown colour, this colour change was measured (Table 2J).

### Example 3A—Heating of Sucrose in an Open System

Sucrose was heated in solutions prepared at various pH values to determine the level of degradation. The solutions were as follows:
1. Sucrose without heat or a change in pH.
2. Sucrose at pH 7, 110° C.
3. Sucrose at pH 7, 177° C.
4. Sucrose at pH 4, 177° C.
5. Sucrose at pH 10, 177° C.

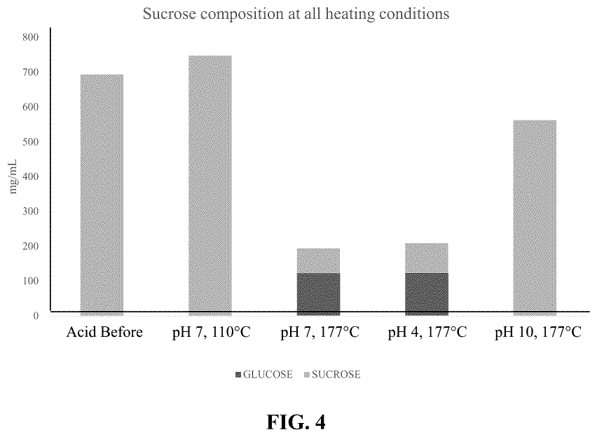

The samples were subsequently analysed for sucrose (indicative of a lack of degradation of the sample) and fructose (a compound indicative of the degradation of sucrose). The results are shown in FIG. 4. Sucrose degrades at 177° C. at pH 7 and pH 4, but does not degrade at 177° C. at pH 10.

### Example 3B—Heating of Sucrose in a Closed System

The procedure of Example 3A was repeated in a closed system. Sucrose was heated at various pH levels to observe the level of degradation. This is shown in FIGS. 23-26 (Tables 2A-J). The solutions were as follows:
1. sucrose in pH 7 buffer
2. sucrose in pH 7 buffer
3. sucrose in pH 3 buffer
4. sucrose in pH 9 buffer

Under acidic conditions, around 85% of sucrose is degraded and a large increase in glucose, the hydrolysis product of sucrose, is measured (FIG. 26B, Table 2F).

### Example 4—Heating of a Combination of Xylo-Oligosaccharides and Cello-Oligosaccharide in an Open System

A combination of XOS and COS with a ratio of 7:1 (XOS:COS) was heated at various pH levels to observe the level of degradation of each solution. The solutions were as follows:
1. 7:1 (XOS:COS) without heat or change in pH.
2. 7:1 (XOS:COS) at pH 7, 110° C.
3. 7:1 (XOS:COS) at pH 7, 177° C.
4. 7:1 (XOS:COS) at pH 4, 177° C.
5. 7:1 (XOS:COS) at pH 10, 177° C.

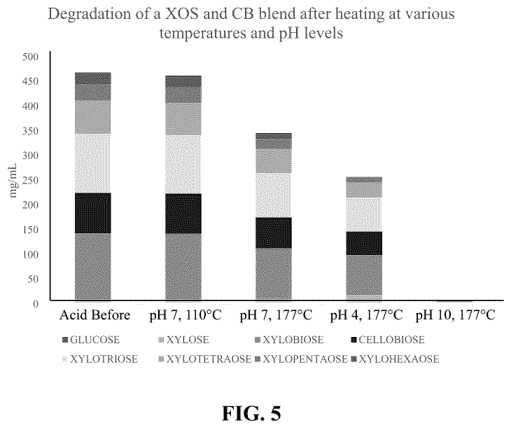

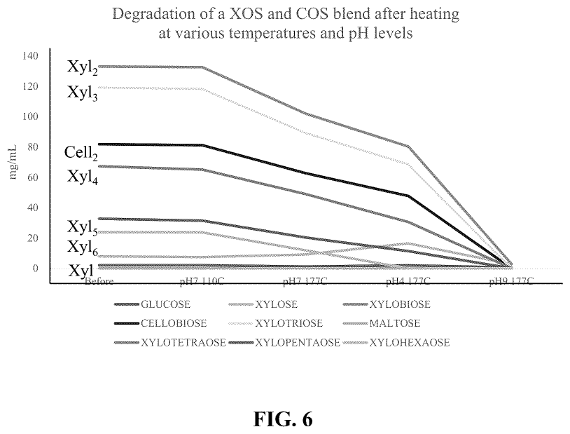

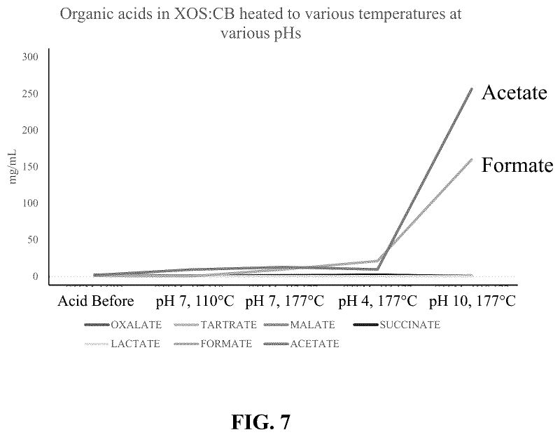

The results are seen in FIGS. 5-7. In FIG. 5, the 7:1 ratio solutions degraded with increased heat, with the greatest degradation at pH 10. In FIG. 6, the concentration of sugars present are shown at each temperature and pH. In FIG. 7, some of the organic acids present in the 7:1 solutions are shown at each temperature and pH.

### Example 5A—Heating of Xylo-Oligosaccharide and Cello-Oligosaccharide Mixtures to 110° C. in an Open System

The following steps were performed to determine the impact of heat and pH on cello-oligosaccharide:
1. Eleven oligosaccharide solutions comprising cello-oligosaccharides of primarily DP 2 (COS) and xylo-oligosaccharides of primarily DP 2-6 (XOS) were created by dissolving saccharides in water. The eleven solutions consisted of various ratios of XOS:COS (100:0, 90:10, 80:20, 75:25, 70:30, 65:35, 60:40, 50:50, 40:60, 20:80, 0:100) and were heated under the same conditions as Examples 1A and 2A. Sucrose was heated similarly in separate solutions.
2. 10 g oligosaccharides were dissolved in 10 g water and heated to 110° C., then removed from heat.
3. Water was added to achieve the initial weight of the sample (20 g) and the samples were analyzed using ion-exchange chromatography (IC).

All samples except 0:100 and 20:80 (XOS:COS) reached 110° C. COS may only be able to reach 110° C. in combination with XOS when the concentration of COS is <0.8 g/g.

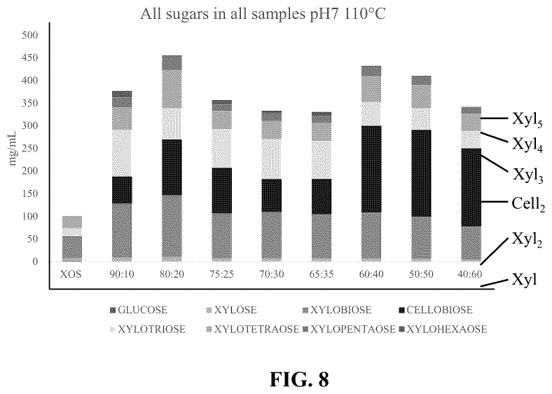

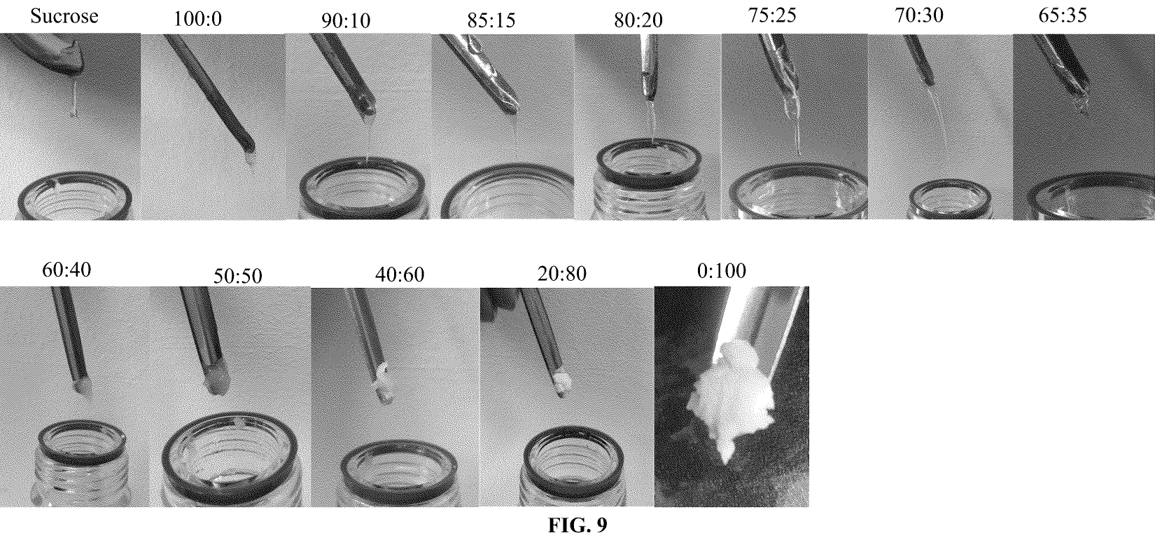

When heated to 110° C., solutions comprising 100:0 to 65:35 ratios of XOS:COS were similar to each other and to sucrose. The color was lightly transparent, with no browning. Increasing the concentration of COS (ratios 60:40 and 50:50) decreased the transparency, without any increase in browning. Samples with >0.5 g/g of COS (ratios 40:60 to 0:100) had no transparency, and were white in color. No samples showed any darkening of color. The degradation of these samples is seen in FIG. 8 and the color change and the texture/rheology of the samples is seen in FIG. 9.

### Example 5B—Heating of Xylo-Oligosaccharide and Cello-Oligosaccharide Mixtures to 110° C. in a Closed System

Ten oligosaccharide solutions (100 mg/mL) comprising cello-oligosaccharides of primarily DP 2 (COS) and xylo-oligosaccharides of primarily DP 2-6 (XOS) were created by dissolving XOS and COS in pH 7 buffer and mixing the stock solutions made in Example 1B and Example 2B to different ratios. The ten solutions consisted of various ratios of XOS:COS (100:0, 90:10, 80:20, 75:25, 70:30, 65:45, 60:40, 50:50, 20:80, 0:100). 5 mL of oligosaccharide solutions and sucrose were transferred to individual 10 mL microwave reactor tubes and sealed. The solutions were rapidly heated to 110° C. and held at temperature for 2 min. After 2 min, the samples were rapidly cooled. The results are presented in FIGS. 23A and 23B and Tables 2A-2C.

### Example 6A—Heating of Xylo-Oligosaccharides and Cello-Oligosaccharide Mixtures to 177° C. in an Open System

The steps of Example 5A were repeated with the samples being heated to 177° C. When heating the samples to 177° C., samples with >0.4 g/g COS concentration cannot reach 177° C., but in the presence of an acidity regulator COS concentration in the samples reaching 177° C. increases such that even samples with 0.5 g/g COS can reach 177° C. Samples with >0.5 g/g COS cannot reach 177° C.

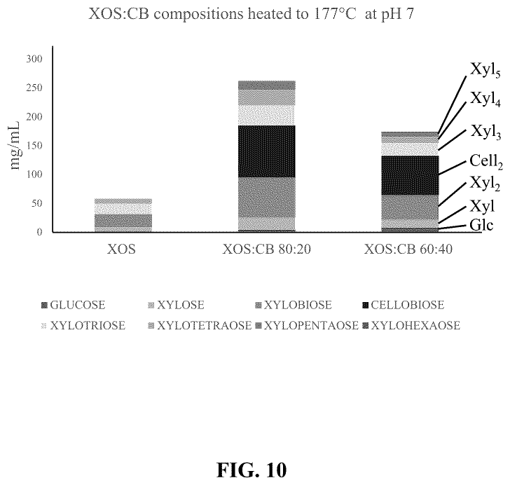

Samples containing some portion of COS survive heating to 177° C. better than pure XOS. At a XOS:COS ratio of 7:1, the sample is chemically stable at 110° C. and pH 7. Unlike sucrose, XOS:COS samples are only slightly degraded at 177° C. at pH 7 and pH 3, and completely degraded at pH 9. The degradation of these samples is seen in FIGS. 9 and 10.

### Example 6B—Heating of Xylo-Oligosaccharides and Cello-Oligosaccharide Mixtures to 177° C. in a Closed System

The steps of Example 5B were repeated with the samples being heated to 177° C. The same sample set was also heated under acidity regulated conditions at pH 3 and pH 9. Unexpectedly, upon heating to 177° C. at pH 7, less degradation of the composition is measured in those samples containing some portion of COS vs samples comprising XOS or COS alone. At a XOS:COS ratio of 7:1, the sample is chemically stable upon heating to 110° C. at pH 7. The results are presented in FIGS. 23-26 and Tables 2A-2J.

The tables (2C, 2G, 2J) show the measured pH for the individual samples, and colour formation. At pH 7 and pH 9 there is little change in pH of the sucrose samples, but large drops in pH in the XOS:COS mixtures further supporting the data in FIGS. 23-26 since degradation products include organic acids. No change in pH for pH 3 samples was observed for all samples after heating.

Absorbance of yellow wavelengths (Tables 2C, 2G, 2J) show that after heating the pH 7 and pH 9 samples, the XOS:COS mixtures developed more colour than sucrose samples which is consistent with the degradation data. No trend was observed in browning in the different XOS:COS ratios, despite more degradation of oligosaccharides in 100:0 and 0:100 samples, suggesting browning rates require very little monosaccharides.

Less oligosaccharide (Xylobiose, X3, X4, X5, X6, A3X, XA3XX, Cellobiose) degradation in mixtures of XOS:COS is observed. The relative amount of monosaccharides in the 100:0 and 0:100 samples not being the relative amount expected based on amount of oligosaccharides left suggests that the reaction is even further into the degradation pathways as the monosaccharides are converted into flavour and colour compounds. The relative amount of oligosaccharides left being highest in mixed ratios, specifically 80:20 is nutritionally favourable as oligosaccharides do not degrade into monosaccharides as easily, but there are still enough monosaccharides present for caramelisation to occur for colour and flavour development.

At pH 9, degradation of oligosaccharides is more similar across the different ratios. Under alkaline conditions it is expected that caramelisation reaction rates are fastest and hence more degradation than at neutral pH. Where there is minimal increase in monosaccharides (xylose, glucose), it is expected that the monosaccharides have been degraded further into flavour and colour compounds.

### Example 7—Heating of Xylo-Oligosaccharides and Cello-Oligosaccharide Mixtures to Candy Stages

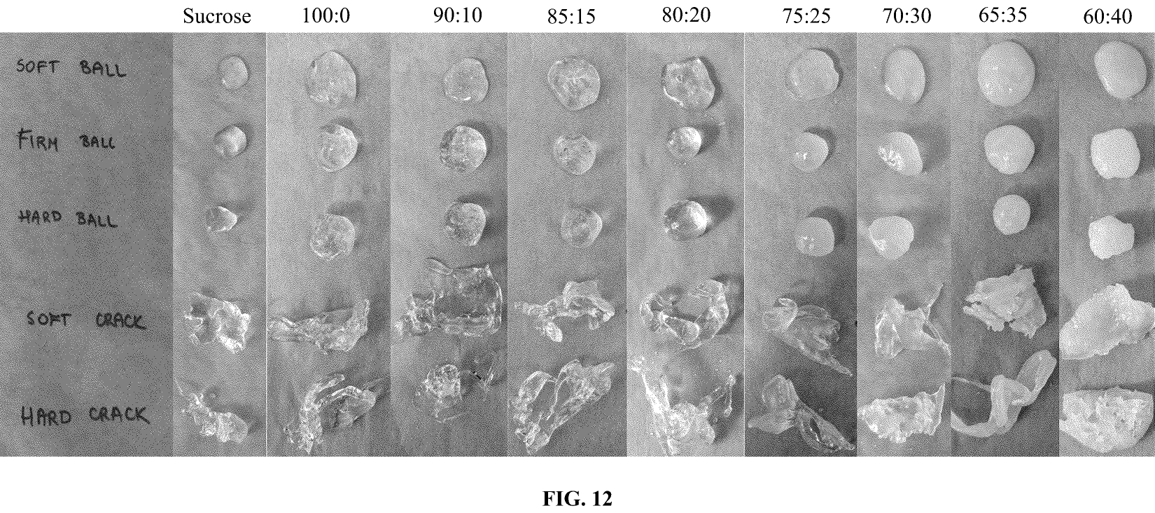

Samples of XOS:COS over various ratios (100:0, 90:10, 85:15, 80:20, 75:25, 70:30, 65:35, 60:40) were heated to soft ball, firm ball, hard ball, soft crack, and hard crack candy stages, as described above at Table 1. The visual results are seen in FIG. 12. The 75:25-65:35 ratios were found to be the best for candy making as they matched the stages achieved with sucrose most closely.

### Example 8—Examination of Hygroscopicity and Elevated Boiling Point for Mixtures of COS and Non-COS Oligosaccharides

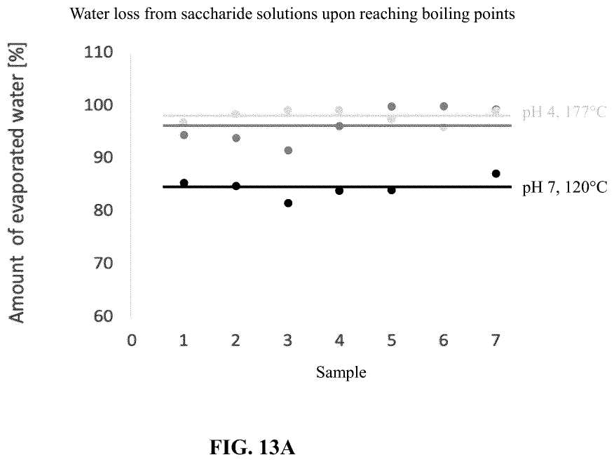

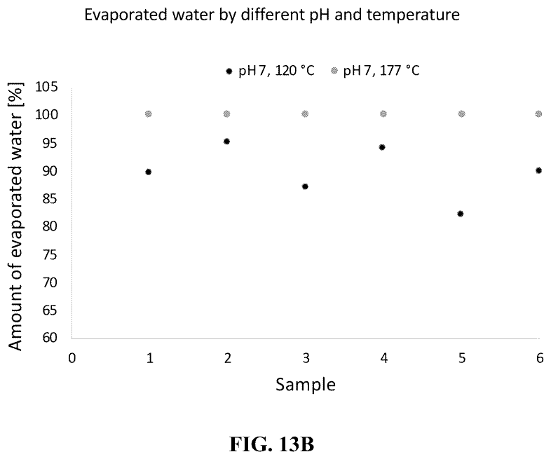

Samples of XOS:COS over various ratios (100:0, 95:5, 90:10, 85:15, 80:20, 70:30, 50:50, 20:80, and 0:100) were heated to 120° C. at pH 7, 177° C. at pH 7, and 177° C. at pH 4. Water in the samples evaporated at 100° C., however, the temperature of the solution was able to rise above 100° C. prior to the evaporation of all of the water, indicating that the boiling point of the solution had been elevated. This elevation of the boiling point may be a result of chemistry of the XOS:COS mixture and the concentrations of the solutes. The amount of evaporated water is shown in Table 2K and FIG. 13A. The mixtures of 20:80 and 0:100 did not reach the noted temperatures and are marked “n/a” in Table 2K. The percent evaporation was determined once the desired temperature was reached and heating stopped. It was determined by the difference in weight before heating and after.

TABLE 2K

| XOS:COS (sample | Amount of evaporated water (%) | | |
|---|---|---|---|
| number and ratio) | pH 7, 120° C. | pH 7, 177° C. | pH 4, 177° C. |
| 1) 100:0 | 85 | 95 | 97 |
| 2) 95:5 | 85 | 94 | 98 |
| 3) 90:10 | 82 | 92 | 99 |
| 4) 85:15 | 84 | 96 | 99 |
| 5) 80:20 | 84 | 100 | 98 |
| 6) 70:30 | — | 100 | 96 |
| 7) 50:50 | 87 | 99 | 99 |
| 8) 20:80 | n/a | n/a | n/a |
| 9) 0:100 | n/a | n/a | n/a |

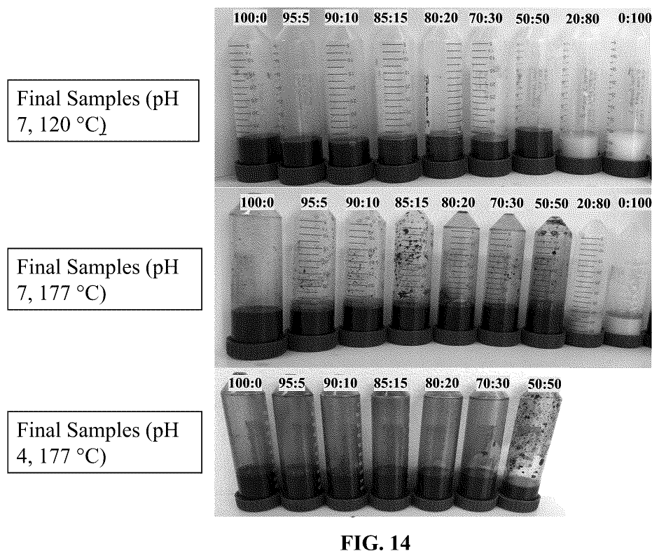

As noted, mixtures of 20:80 and 0:100 were unable to reach 120° C. These mixtures also did not brown significantly, as seen in FIG. 14. This indicates that COS is not hygroscopic enough to cause boiling point elevation. However, the mixture of 100:0 did reach 120° C., which indicates that XOS is hygroscopic enough to cause boiling point elevation. Similarly, mixtures of 100:0 to 50:50 all reached 120° C. and 177° C., and did so with similar loss of water. This indicates that the mixtures have similar chemical structure. The fact that similar parameters of boiling point elevation were observed for the mixtures from 100:0-50:50 mixture, indicates that, at those ratios, the COS is acting similarly to the XOS. The fact that the 20:80 and 0:100 did not reach the noted temperatures indicates that, at those ratios, the COS is acting differently to the XOS.

Samples of other oligosaccharide concentrations were heated to 120° C. at pH 7, 177° C. at pH 7. Water in the samples evaporated at 100° C. the temperature of the solution was able to rise above 100° C. prior to the evaporation of all of the water, indicating that the boiling point of the solution had been elevated. This elevation of the boiling point may be a result of chemistry of the COS in the presence of other oligosaccharides and the concentrations of the solutes. The amount of evaporated water is shown in Table 3 and FIG. 13B. The percent evaporation was determined once the desired temperature was reached and heating stopped. It was determined by the difference in weight before heating and after. This showed that the phenomenon observed with XOS:COS compositions is also seen in combinations of COS with other oligosaccharides.

TABLE 3

| | |
|---|---|
| Oligosaccharide mixture | Amount of evaporated water (%) |

| (sample number and ratio) | pH 7, 120° C. | pH 7, 177° C. |
|---|---|---|
| 1) FOS | 90 | 100 |
| 2) FOS:COS (2:1) | 95 | 100 |
| 2) MD | 87 | 100 |
| 3) MD:COS (2:1) | 94 | 100 |
| 4) XOS:COS (2:1) | 82 | 100 |
| 5) Sucrose:COS (2:1) | 90 | 100 |

Samples of FOS:COS over various ratios (100:0, 90:10, 85:15, 80:20, 75:25, 70:30, 65:35, 50:50, 20:80) were heated at 120° C. at pH 7. Water in the samples evaporated at 100° C. the temperature of the solution was able to rise above 100° C. prior to the evaporation of all of the water, indicating that the boiling point of the solution had been elevated. This elevation may be a result of chemistry of the COS in the presence of FOS and the concentrations of the solutes. The amount of evaporated water is shown in Table 4. The percent evaporation was determined once the desired temperature was reached, and heating stopped. It was determined by the difference in weight before and after heating.

TABLE 3A

| | |
|---|---|
| FOS COS | pH 7, 120° C. |
| Sample | % evaporated water weight |

| | | |
|---|---|---|
| 1 | (100:0) | 95.6 |
| 2 | (95:5) | 89 |
| 3 | (90:10) | 90 |
| 4 | (85:15) | 92 |
| 5 | (80:20) | 91.7 |
| 6 | (70:30) | 94 |
| 7 | (50:50) | 94.2 |
| 8 | (20:80) | n/a |

### Example 9—XOS:COS Form Candy Stage Compositions at Lower Temperatures than Sucrose Does

40 mL 1 g/ml saccharide solutions (80:20 XOS:COS; sucrose) in phosphate buffer (0.2M solution pH7) were heated in 100 ml Duran bottles on a hotplate to 110° C., 120° C., 130° C., 140° C., 150° C. and 160° C. Temperature during heating was recorded with the temperature probe of the hotplate, inserted into the solution. Samples were removed from the heat as soon as desired temperature was reached.

After reaching desired temperature, solution was evenly divided between silicone cups until the whole bottom was covered with solution, and left on the room temperature for 24 hours.

To measure texture the hardness of the candies was measured with a probe pressing them from the top. Hardness is defined as the peak force that occurs during compression of the sample, and is calculated using the following formula:

Hardness (N/m²)=Force (N)/Surface contact area of the probe used (m²)

During the analysis, the candy was positioned centrally under the probe. Each candy stage was assayed and measured in triplicate.

Method BSW2/P6 “Measurement of the hardness and stickiness of chewy confectionery by penetration” was loaded on Exponent Connect software controlling a Stable Micro Systems texture analyser. The following parameters were used for the test: Probe, P/6 (6 mm); Load Cell, 30 kg; Penetration distance, 1 mm; Test speed, 0.5 mm/sec; Trigger force, 10 g; Mode, Measure Force in Compression; Option, Return to Start.

Once the probe triggered on the surface of the sample it then proceeded to penetrate to a depth of 1 mm within the sample. At this point the force value was recorded and taken as a measure of ‘Hardness’ of the sample.

The data acquisition rate was set at 500 PPS. The strain of the target was set to be 25%. The probe compressed the sample until it had compressed 25% of the product height (15 mm). The probe was held at this distance for 30 seconds and then withdrawn from the sample to return to the starting position. Two examples of the probes used are shown in FIGS. 4B and 4C. The probe shown in FIG. 4B is a P/2″ (2-inch) probe.

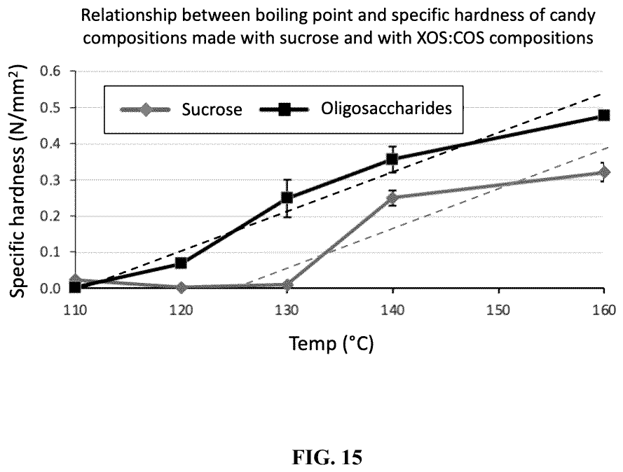

As shown in FIG. 15, the temperature required to reach the same hardness for the 80:20 XOS:COS composition was roughly 20° C. lower than what was needed for the sucrose composition, indicating less energy is needed to achieve a composition of similar physical properties.

### Example 10—Ion Chromatography (IC) Analyses of XOS and COS Samples Used in Examples 1-9

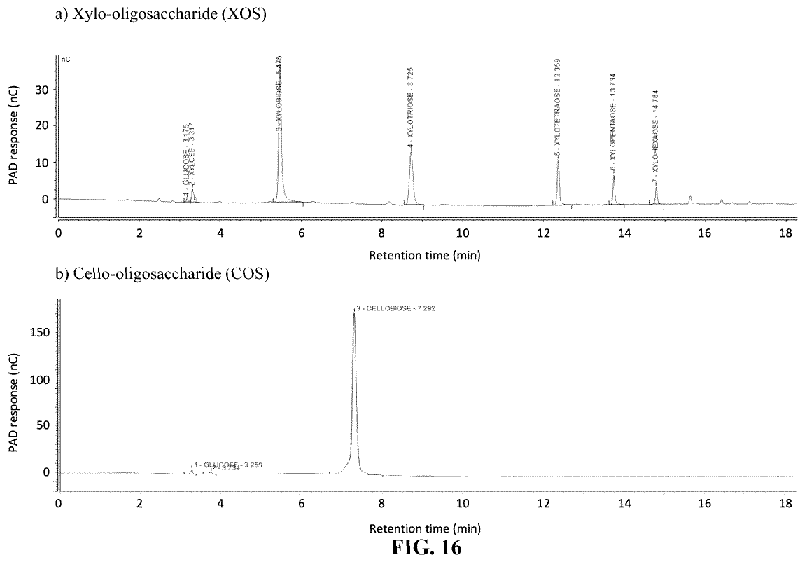

IC analysis was performed on the (a) XOS and (b) COS compositions used in this document FIG. 16. Quantitation of the components of the XOS composition is shown in Table 4. Quantification of the components of the COS composition is shown in Table 5.

TABLE 4

| Component | Proportion (mass %) |
|---|---|
| Glucose | 0.6 |
| Xylose | 1.2 |
| Xylobiose | 38.2 |
| Xylotriose | 25.7 |
| Xylotetraose | 17.9 |
| Xylopentaose | 8.9 |
| Xylohexaose | 6.7 |

TABLE 5

| Component | Proportion (mass %) |
|---|---|
| Glucose | 0.8 |
| Xylose | 0.3 |
| Cellobiose | 98.3 |

### Example 11—IC Analysis and Elevated Boiling Point of Another XOS:COS Sample

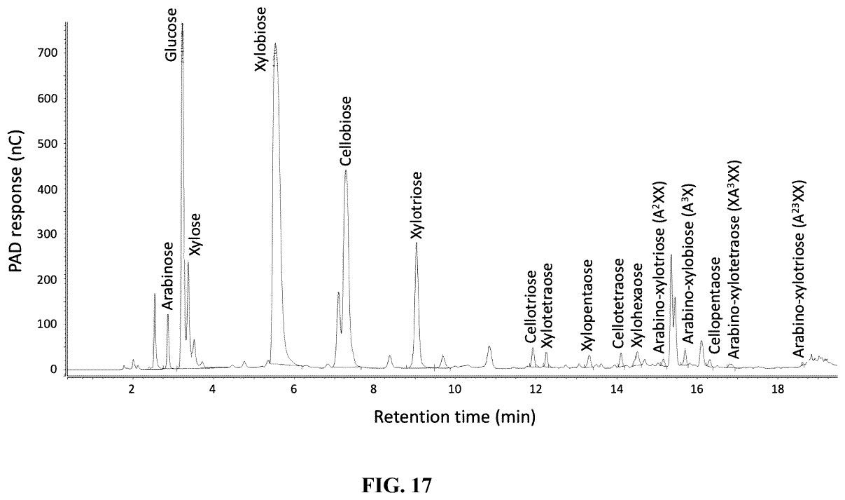

IC analysis was performed on another XOS:COS sample (FIG. 17). Quantification of the components of the XOS composition is shown in Table 6. This composition had more glucose, xylose, cellotriose, cellotetraose, and substituted xylo-oligosaccharides than the XOS:COS compositions used in Examples 1-10.

TABLE 6

| | Proportion of total labelled |
|---|---|
| Component | oligosaccharide (mass %) |
| Arabinose | 2.7 |
| Glucose | 8.1 |
| Xylose | 2.6 |
| Xylobiose | 43.4 |
| Cellobiose | 20.8 |
| Xylotriose | 12.4 |
| Xylotetraose | 1.2 |
| Xylopentaose | 1.4 |
| Xylohexaose | 2.1 |
| Cellotriose | 1.2 |
| Cellotetraose | 0.9 |
| Cellopentaose | 0.7 |
| Arabino-xylotriose (A²XX) | 0.7 |
| Arabino-xylotriose (A²³XX) | 0.1 |
| Arabino-xylobiose (A³X) | 1.2 |
| Arabino-xylotetraose (XA³XX) | 0.6 |

Samples of this XOS:COS composition was heated at pH 7 to 120° C. Water in the samples evaporated at 100° C. until the boiling point began to rise. This elevation of the boiling point may be a result of chemistry of the XOS:COS mixture and the concentrations of the solutes. The amount of evaporated water at pH 7, 120° C. was 97.4%. The percent evaporation was determined once the desired temperature was reached, and heating stopped. It was determined by the difference in weight before heating and after.

The fact that similar parameters of boiling point elevation were observed for the mixtures from 100:0-50:50 mixture, indicates that, at those ratios, the COS is acting similarly to the XOS. The fact that the 20:80 and 0:100 did not reach the noted temperatures indicates that, at those ratios, the COS is acting differently to the XOS.

### Example 12—Non Enzymatic Breakdown Products (NEB Products) Quantification

### A. Progression of Caramelisation

Solutions of 80:20 oligosaccharide mixtures xylo-oligosaccharides:cellobiose (XOS:COS), fructo-oligosaccharides:cellobiose (FOS:CB) and sucrose in water were made in 100 mL volumetric flasks to a concentration of 100 mg/mL. 10 mL of each solution were transferred to 10 mL microwave reactor tubes and sealed. The solutions were rapidly heated to set temperatures and held at temperature for 5 min. After 5 min, the samples were rapidly cooled. Absorbance at 420 nm was measured for 200 μL of each sample using a spectrophotometer (BMG Labtech Spectra star nano).

The data for the absorbance at 420 nm (after baseline removal) is presented in table 7.

TABLE 7

| Temperature ° C. | Sucrose | XOS:COS | FOS:COS |
|---|---|---|---|
| 100 | 0 | 0 | 0 |
| 120 | 0.003 | 0.037 | 0.035 |
| 140 | 0 | 0.038 | 0.026 |
| 150 | 0.007 | 0.07 | 0.054 |
| 155 | 0.01 | 0.103 | 0.078 |
| 160 | 0.022 | 0.135 | 0.17 |
| 165 | 0.051 | 0.242 | 0.376 |
| 170 | 0.137 | 0.379 | 0.495 |
| 177 | 0.382 | 0.795 | 1.136 |
| 180 | 0.719 | 1.022 | 2.272 |
| 190 | 3.561 | 3.769 | 5.872 |

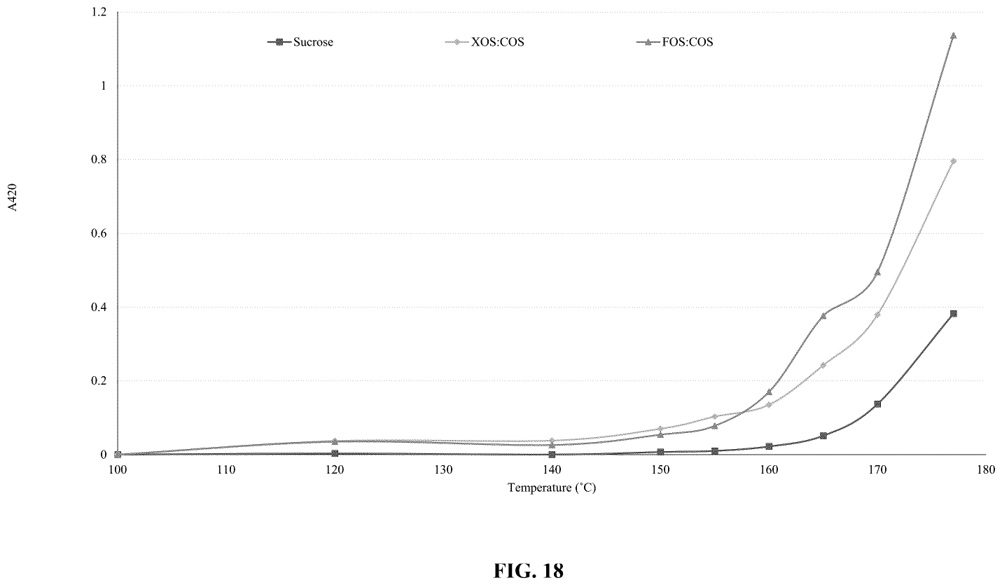

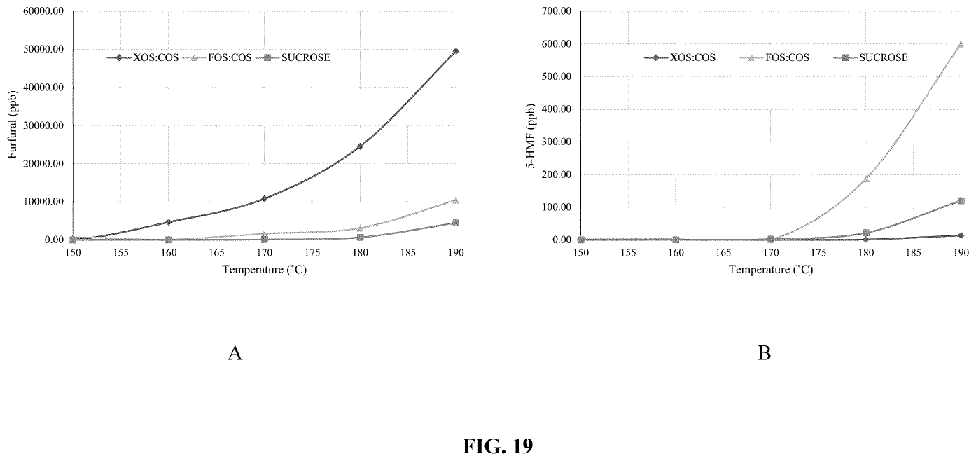

Sucrose caramelizes at 170° C.; this is when colour compounds that are important for flavour start to develop rapidly. It was observed that colour development in oligosaccharide mixtures starts at lower temperatures than sucrose, with differences observed at 150° C. but more noticeably at 160° C. (FIG. 18). The data is also plotted in FIG. 18 until 180° C. Furfural and 5-hydroxymethylfurfural (HMF) are breakdown intermediates from pentose and hexose sugars respectively. FIG. 19 shows that an increase in furfural concentration is measured at 160° C. for samples containing XOS, whereas HMF concentration increased at 180° C. for sucrose, again showing that the XOS:COS mixture begins to degrade at lower temperatures than sucrose. Conversion of cellobiose to HMF is low in the XOS:COS sample at all temperatures investigated, suggesting either cellobiose is not easily degraded or that in the XOS:COS reaction mixture there is rapid conversion of HMF into other compounds.

### B. Maillard Reaction Products (MRP) at pH 7

0.1M individual solutions of XOS:COS ratios 100:0, 80:20, 50:50, 20:80, and 0:100, sucrose, glucose and xylose, tryptophan, leucine and histidine in pH 7 buffer (monobasic/dibasic phosphate buffer prepared according to Sigma phosphate buffer tables) were prepared. Reaction mixtures were prepared by taking 1 mL of the saccharide solutions (XOS:COS, sucrose, glucose or xylose) and mixing with 1 mL of the amino acids (tryptophan, leucine or histidine), the concentration of the saccharides and amino acids in the mixture being 0.05M each. Controls were prepared addition of 1 mL of pH 7 buffer to the amino acids. The samples were rapidly heated to 160° C. and held at this temperature for 10 min. Samples were rapidly cooled afterwards, and absorbance at 500 nm was measured for each reaction mixture. Volatiles were analysed using gas chromatography mass spectrometry (GCMS) analysis. An Agilent Technologies 5975B Inert XL MSD gas chromatography, single quadruple mass spectrometer was used for analysis of volatiles. Samples were added to separate GCMS headspace vials and weighed. 0.03 g of 0.01% 3-heptanone in water was added and the vial was sealed for GCMS solid phase micro extraction (SPME) analysis. Samples were analysed in a randomized order. Samples were incubated and agitated at 250 RPM, at 60° C. for 15 min prior to SPME analysis of volatiles. The SPME fibre (50/30 DVB/CAR/PDMS, 23 Ga) extracted for 10 min, then thermally desorbed at 250° C. for 5 min. A 30 m×0.25 mm×0.25 μm HP-5MS column was used (Phenomenex, UK). Oven temperature settings: 31° C.-5 min, 5° C./min to 150° C., 30° C./min to 240° C. Inlet settings: 250° C., pressure 10.4 psi, flow 11.2 mL/min, split ratio 7:1. MS operated in full scan mode from 40 to 400 m/z with a scan time of 0.2s. The peak area of the aroma compounds was compared to the peak of the internal standard 3-heptanone and corrected for the weight of the sample.

The choice of the 3 amino acids is based on the literature reports mentioning tryptophan as high reactivity in Maillard reactions, Leucine as a medium reactivity in Maillard reactions and Histidine as a low reactivity in Maillard reactions. The choice of the temperature for the Maillard breakdown products is based upon a pretest experiment testing the temperature at which the aroma development and browning starts.

The data for the absorbance at 500 nm (after baseline removal, 420 nm for the samples with no amino acid) is presented in table 8.

TABLE 8

| Sample | No saccharide | 100:0 | 80:20 | 50:50 | 20:80 | 0:100 | Sucrose | Glucose |
|---|---|---|---|---|---|---|---|---|
| No amino acid | 0.065 | 2.385 | 2.129 | 1.907 | 1.778 | 1.842 | 0.098 | 2.051 |
| Tryptophan (H) | 0.119 | 5.952 | 5.952 | 5.952 | 5.952 | 5.952 | 1.087 | 5.952 |
| Leucine (M) | 0.067 | 5.068 | 4.789 | 4.719 | 4.393 | 3.892 | 0.19 | 2.998 |
| Histidine (L) | 0.064 | 4.323 | 3.844 | 3.291 | 2.853 | 2.861 | 0.183 | 2.422 |

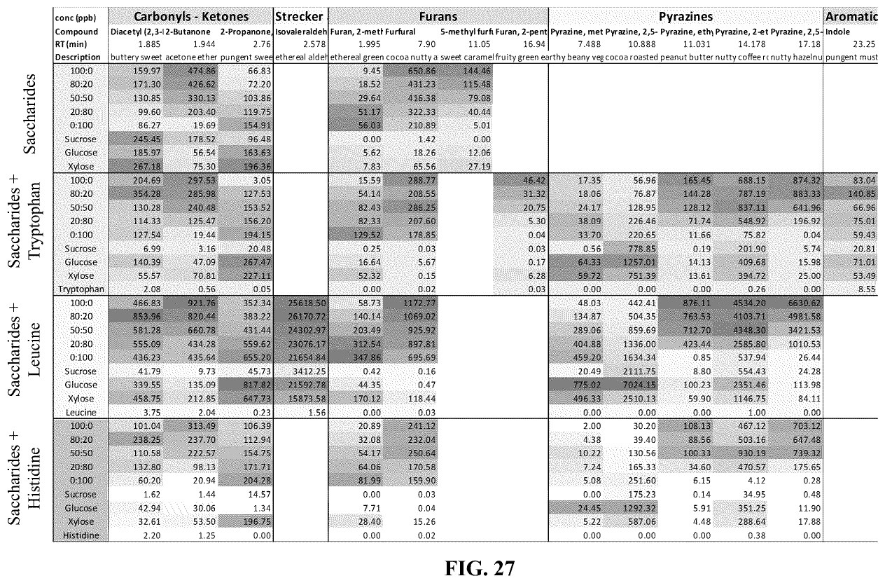

Compounds of interest presented in FIG. 27 were selected based on abundance, representation of functional groups, and trends observed. Expected groups of compounds were identified in these reaction mixtures, including pyrroles, furans, carbonyls, Strecker aldehydes and pyrazines. For example, the structure of tryptophan contains indole, therefore indole was expected as a degradation product and was observed in the reaction mixtures at higher concentrations with saccharides present, but also present in the tryptophan solution heated without saccharides. Tables 9B-E (FIG. 27) show the differences in MRP concentration in the heated saccharide-amino acid mixtures. The data shows that at 160° C., Maillard reaction pathways proceed to a greater extent than caramelisation as the amount of different compounds and concentrations of compounds are both greater when amino acids are present than without. This is further supported by data in Table 8 that shows colour development is as expected based on literature reports of the reactivity of amino acids with sugars, and that mixtures containing amino acids show more melanoidin formation and hence greater colour development. Colour development for mixtures containing tryptophan>leucine>histidine>no amino acid. For the oligosaccharide mixtures, a trend of decrease in absorbance was measured from pure xylo-oligosaccharide solutions (100:0) to pure cellobiose solutions (0:100). The monosaccharides glucose and xylose were similar in reactivity, and all these saccharides were more reactive at 160° C. than sucrose in the mixture, as all sucrose reaction mixtures showed little colour development.

No overall trend was observed for the carbonyls identified. Carbonyls in general have a sweet, buttery, caramellike aroma. Diacetyl (2,3 butanedione) is a key caramelisation compound, contributing to the classic caramel flavour. The caramelisation results (mixtures without aminoacids, Tables 9B-E and FIG. 27) show that the reaction mixtures containing sucrose and the monosaccharides have a higher diacetyl concentration. However, when amino acids are present, the oligosaccharide solutions have higher diacetyl concentrations. This suggests that for the reactions producing diacetyl (from rearranged sugars breaking down) when amino acids are present, the monosaccharides proceed further into the Maillard reaction pathway vs oligosaccharides. Unexpectedly, the 80:20 XOS:COS mixture with and without amino acids, show the highest concentration of diacetyl. This is unlikely to do with sample preparation errors, as clear trends are observed from 100:0-0:100 for other compounds.

Strecker aldehydes, aldehydes with the equivalent amino acid side chain, are produced from Strecker degradation reactions. The Strecker aldehyde of leucine is isovaleraldehyde and is observed in higher concentrations (15-27 ppm) in the oligosaccharide mixtures, and monosaccharides vs sucrose. In the sucrose solution, the concentrations are much lower—3400 ppb. This group of compounds typically have a malty, aldehydic, pungent aroma, and the contribution of this reaction pathway to the overall flavour profile of a food product will depend on the protein source and composition in the food matrix, and ultimately on the abundance of amino acids.

Furans, like carbonyls are produced from rearranged sugars, via two mechanisms. Either through cyclisation of rearranged sugars or through the condensation of carbonyls. The typical aroma of furans is caramellike, nutty and cocoa. Further experiments are required to understand why furfural concentration is higher than expected in cellobiose (0:100) reaction mixtures, and why 5-methylfurfural, typically a dehydration product of hexose reducing sugars, is present in higher concentrations in high XOS samples rather than high cellobiose samples.

Pyrazines are produced from condensation of the Strecker intermediate, therefore are only present in the solutions containing amino acids. These compounds contribute to a woody, roasted, nutty aroma profile of foods. The highest concentration of the smaller pyrazines containing methyl groups are present in the monosaccharide mixtures, whereas the larger pyrazines containing ethyl groups are present in greater amounts in the oligosaccharide mixtures containing XOS (100:0-20:80). These larger pyrazines contribute woody, earthy notes.

In food applications, it is important to consider the odour detection thresholds of each compound as well as the concentrations measured. For example, methyl pyrazine pyrazine described above), has a high threshold of detection meaning it does not contribute much to flavour. This compound is present in lower concentrations in high XOS samples and higher concentrations in high cellobiose samples. Whereas ethyl pyrazine (‘large’ pyrazine described above) is important in overall flavour profiles as it has a low detection threshold (Jousse, F., et al. (2002), Simplified Kinetic Scheme of Flavor Formation by the Maillard Reaction. Journal of Food Science, 67: 2534-2542).

The concentration of the different classes of Maillard reaction breakdown products is presented in Tables 9B-E. The same data as Tables 9B-E is also presented in FIG. 27. Concentrations are in parts per billion of the difference non-enzymatic breakdown products for the different compositions at 160° C. analysed by GCMS.

TABLE 9A
Flavor profiles produced by non-enzymatic breakdown products
of oligosaccharide compositions of the present disclosure

| Compound | Flavor Description |
|---|---|
| Diacetyl (2,3-Butanedione) | buttery sweet creamy pungent caramellic |
| 2-Butanone | acetone ethereal fruity camphoreous |
| 2-Propanone, 1-hydroxy- | pungent sweet caramellic ethereal burnt |
| Isovaleraldehyde (Butanal, | ethereal aldehydic chocolate peach fatty |
| 3-methyl-) | |
| Furan, 2-methyl- | ethereal green cocoa nutty almond coffee |
| Furfural | N.D. |
| 5-methyl furfural | sweet caramellic bready brown coffee |
| Furan, 2-pentyl- | fruity green earthy beany vegetable metallic |
| Pyrazine, methyl- | N.D. |
| Pyrazine, 2,5-dimethyl- | cocoa roasted nutty beefy roasted beefy |
| | woody grassy medicinal |
| Pyrazine, ethyl- | peanut butter musty nutty woody roasted |
| | cocoa |
| Pyrazine, 2-ethyl-5-methyl- | nutty coffee roasted coffee hazelnut |
| | cocoa barley roasted barley |
| Pyrazine, 2,5-diethyl- | nutty hazelnut |
| Indole | pungent musty |

TABLE 9B
Breakdown products for example compositions detected
by GCMS without an amino acid present
Concentration (ppb)
Carbonyls/ketones

| | Diacetyl (2,3- | | 2-Propanone, |
|---|---|---|---|
| Compound | Butanedione) | 2-Butanone | 1-hydroxy- |
| RT (min) | 1.885 | 1.944 | 2.76 |
| 100:0 | 159.97 | 474.86 | 66.83 |
| 80:20 | 171.3 | 426.62 | 72.2 |
| 50:50 | 130.85 | 330.13 | 103.86 |
| 20:80 | 99.6 | 203.4 | 119.75 |
| 0:100 | 86.27 | 19.69 | 154.91 |
| Sucrose | 245.45 | 178.52 | 96.48 |
| Glucose | 185.97 | 56.54 | 163.63 |
| Xylose | 267.18 | 75.3 | 196.36 |

Strecker Aldehydes

| | Isovaleraldehyde |
|---|---|
| Compound | (Butanal, 3-methyl-) |
| RT (min) | 2.578 |
| 100:0 | |
| 80:20 | |
| 50:50 | |
| 20:80 | |
| 0:100 | |
| Sucrose | |
| Glucose | |
| Xylose | |

Furans

| | Furan, | | 5-methyl | Furan, 2- |
|---|---|---|---|---|
| Compound | 2-methyl- | Furfural | furfural | penty1- |
| RT (min) | 1.995 | 7.9 | 11.05 | 16.94 |
| 100:0 | 9.45 | 650.86 | 144.46 | |
| 80:20 | 18.52 | 431.23 | 115.48 | |
| 50:50 | 29.64 | 416.38 | 79.08 | |
| 20:80 | 51.17 | 322.33 | 40.44 | |
| 0:100 | 56.03 | 210.89 | 5.01 | |
| Sucrose | 0 | 1.42 | 0 | |
| Glucose | 5.62 | 18.26 | 12.06 | |
| Xylose | 7.83 | 65.56 | 27.19 | |

TABLE 9C
Breakdown products for example compositions detected by GCMS after
performing a Maillard reaction in the presence of Tryptophan
Concentration (ppb)
Carbonyls/ketones

| | Diacetyl (2,3- | | 2-Propanone, |
|---|---|---|---|
| Compound | Butanedione) | 2-Butanone | 1-hydroxy- |
| RT (min) | 1.885 | 1.944 | 2.76 |
| 100:0 | 204.69 | 297.53 | 3.05 |
| 80:20 | 354.28 | 285.98 | 127.53 |
| 50:50 | 130.28 | 240.48 | 153.52 |
| 20:80 | 114.33 | 125.47 | 156.2 |
| 0:100 | 127.54 | 19.44 | 194.15 |
| Sucrose | 6.99 | 3.16 | 20.48 |
| Glucose | 140.39 | 47.09 | 267.47 |
| Xylose | 55.57 | 70.81 | 227.11 |
| Tryptophan | 2.08 | 0.56 | 0.05 |

Strecker Aldehydes

| | Isovaleraldehyde |
|---|---|
| Compound | (Butanal, 3-methyl-) |
| RT (min) | 2.578 |
| 100:0 | |
| 80:20 | |
| 50:50 | |
| 20:80 | |
| 0:100 | |
| Sucrose | |
| Glucose | |
| Xylose | |
| Tryptophan | |

Furans

| | Furan, | | 5-methy1 | Furan, |
|---|---|---|---|---|
| Compound | 2-methyl- | Furfural | furfural | 2-pentyl- |
| RT (min) | 1.995 | 7.9 | 11.05 | 16.94 |
| 100:0 | 15.59 | 288.77 | | 46.42 |
| 80:20 | 54.14 | 208.55 | | 31.32 |
| 50:50 | 82.43 | 286.25 | | 20.75 |
| 20:80 | 82.33 | 207.6 | | 5.3 |
| 0:100 | 129.52 | 178.85 | | 0.04 |
| Sucrose | 0.25 | 0.03 | | 0.03 |
| Glucose | 16.64 | 5.67 | | 0.17 |
| Xylose | 52.32 | 0.15 | | 6.28 |
| Tryptophan | 0 | 0.02 | | 0.03 |

| | Pyrazines | | | | |
|---|---|---|---|---|---|
| | Pyrazine, | Pyrazine, 2,5- | Pyrazine, | Pyrazine, 2- | Pyrazine, |
| Compound | methyl- | dimethyl- | ethyl- | ethyl-5-methyl- | 2,5-diethyl- |
| RT (min) | 7.488 | 10.888 | 11.031 | 14.178 | 17.18 |
| 100:0 | 17.35 | 56.96 | 165.45 | 688.15 | 874.32 |
| 80:20 | 18.06 | 76.87 | 144.28 | 787.19 | 883.33 |
| 50:50 | 24.17 | 128.95 | 128.12 | 837.11 | 641.96 |
| 20:80 | 38.09 | 226.46 | 71.74 | 548.92 | 196.92 |
| 0:100 | 33.7 | 220.65 | 11.66 | 75.82 | 0.04 |
| Sucrose | 0.56 | 778.85 | 0.19 | 201.9 | 5.74 |
| Glucose | 64.33 | 1257.01 | 14.13 | 409.68 | 15.98 |
| Xylose | 59.72 | 751.39 | 13.61 | 394.72 | 25 |
| Tryptophan | 0 | 0 | 0 | 0.26 | 0 |

Aromatic Compounds

| Compound | Indole |
|---|---|
| RT (min) | 23.25 |
| 100:0 | 83.04 |
| 80:20 | 140.85 |
| 50:50 | 66.96 |
| 20:80 | 75.01 |
| 0:100 | 59.43 |
| Sucrose | 20.81 |
| Glucose | 71.01 |
| Xylose | 53.49 |
| Tryptophan | 8.55 |

TABLE 9D
Breakdown products for example compositions detected by GCMS after
performing a Maillard reaction in the presence of Leucine
Concentration (ppb)
Carbonyls/ketones

| | Diacetyl (2,3- | | 2-Propanone, |
|---|---|---|---|
| Compound | Butanedione) | 2-Butanone | 1-hydroxy- |
| RT (min) | 1.885 | 1.944 | 2.76 |
| 100:0 | 466.83 | 921.76 | 352.34 |
| 80:20 | 853.96 | 820.44 | 383.22 |
| 50:50 | 581.28 | 660.78 | 431.44 |
| 20:80 | 555.09 | 434.28 | 559.62 |
| 0:100 | 436.23 | 435.64 | 655.2 |
| Sucrose | 41.79 | 9.73 | 45.73 |
| Glucose | 339.55 | 135.09 | 817.82 |
| Xylose | 458.75 | 212.85 | 647.73 |
| Leucine | 3.75 | 2.04 | 0.23 |

Strecker Aldehydes

| | Isovaleraldehyde |
|---|---|
| Compound | (Butanal, 3-methyl-) |
| RT (min) | 2.578 |
| 100:0 | 25618.5 |
| 80:20 | 26170.72 |
| 50:50 | 24302.97 |
| 20:80 | 23076.17 |
| 0:100 | 21654.84 |
| Sucrose | 3412.25 |
| Glucose | 21592.78 |
| Xylose | 15873.58 |
| Leucine | 1.56 |

Furans

| Compound | Furan, 2-methyl- | Furfural |
|---|---|---|
| RT (min) | 1.995 | 7.9 |
| 100:0 | 58.73 | 1172.77 |
| 80:20 | 140.14 | 1069.02 |
| 50:50 | 203.49 | 925.92 |
| 20:80 | 312.54 | 897.81 |
| 0:100 | 347.86 | 695.69 |
| Sucrose | 0.42 | 0.16 |
| Glucose | 44.35 | 0.47 |
| Xylose | 170.12 | 118.44 |
| Leucine | 0 | 0.03 |

Pyrazines

| | | Pyrazine, | | Pyrazine, | Pyrazine, |
|---|---|---|---|---|---|
| | Pyrazine, | 2,5- | Pyrazine, | 2-ethyl-5- | 2,5- |
| Compound | methyl- | dimethyl- | ethyl- | methyl- | diethyl- |
| RT (min) | 7.488 | 10.888 | 11.031 | 14.178 | 17.18 |
| 100:0 | 48.03 | 442.41 | 876.11 | 4534.2 | 6630.62 |
| 80:20 | 134.87 | 504.35 | 763.53 | 4103.71 | 4981.58 |
| 50:50 | 289.06 | 859.69 | 712.7 | 4348.3 | 3421.53 |
| 20:80 | 404.88 | 1336 | 423.44 | 2585.8 | 1010.53 |
| 0:100 | 459.2 | 1634.34 | 0.85 | 537.94 | 26.44 |
| Sucrose | 20.49 | 2111.75 | 8.8 | 554.43 | 24.28 |
| Glucose | 775.02 | 7024.15 | 100.23 | 2351.46 | 113.98 |
| Xylose | 496.33 | 2510.13 | 59.9 | 1146.75 | 84.11 |
| Leucine | 0 | 0 | 0 | 1 | 0 |

TABLE 9E
Breakdown products for example compositions detected by GCMS after
performing a Maillard reaction in the presence of Histidine
Concentration (ppb)
Carbonyls/ketones

| | Diacetyl (2,3- | | 2-Propanone, |
|---|---|---|---|
| Compound | Butanedione) | 2-Butanone | 1-hydroxy- |
| RT (min) | 1.885 | 1.944 | 2.76 |
| 100:0 | 101.04 | 313.49 | 106.39 |
| 80:20 | 238.25 | 237.7 | 112.94 |
| 50:50 | 110.58 | 222.57 | 154.75 |
| 20:80 | 132.8 | 98.13 | 171.71 |
| 0:100 | 60.2 | 20.94 | 204.28 |
| Sucrose | 1.62 | 1.44 | 14.57 |
| Glucose | 42.94 | 30.06 | 1.34 |
| Xylose | 32.61 | 53.5 | 196.75 |
| Histidine | 2.2 | 1.25 | 0 |

Furans

| Compound | Furan, 2-methyl- | Furfural |
|---|---|---|
| RT (min) | 1.995 | 7.9 |
| 100:0 | 20.89 | 241.12 |
| 80:20 | 32.08 | 232.04 |
| 50:50 | 54.17 | 250.64 |
| 20:80 | 64.06 | 170.58 |
| 0:100 | 81.99 | 159.9 |
| Sucrose | 0 | 0.03 |
| Glucose | 7.71 | 0.04 |
| Xylose | 28.4 | 15.26 |
| Histidine | 0 | 0.02 |

Pyrazines

| | Pyrazine, | Pyrazine, 2,5- | Pyrazine, | Pyrazine, 2-ethyl- | Pyrazine, 2,5- |
|---|---|---|---|---|---|
| Compound | methyl- | dimethyl- | ethyl- | 5-methyl- | diethyl- |
| RT (min) | 7.488 | 10.888 | 11.031 | 14.178 | 17.18 |
| 100:0 | 2 | 30.2 | 108.13 | 467.12 | 703.12 |
| 80:20 | 4.38 | 39.4 | 88.56 | 503.16 | 647.48 |
| 50:50 | 10.22 | 130.56 | 100.33 | 930.19 | 739.32 |
| 20:80 | 7.24 | 165.33 | 34.6 | 470.57 | 175.65 |
| 0:100 | 5.08 | 251.6 | 6.15 | 4.12 | 0.28 |
| Sucrose | 0 | 175.23 | 0.14 | 34.95 | 0.48 |
| Glucose | 24.45 | 1292.32 | 5.91 | 351.25 | 11.9 |
| Xylose | 5.22 | 587.06 | 4.48 | 288.64 | 17.88 |
| Histidine | 0 | 0 | 0 | 0.38 | 0 |

### Example 13—Caramelization Application in Food

Oligosaccharide mixtures caramelizing at lower temperatures than sucrose is advantageous in foods as products that involve heating sugars to different candy stages require lower processing temperatures and times.

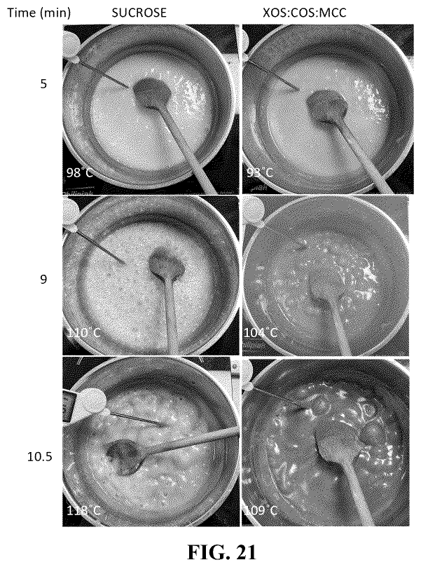

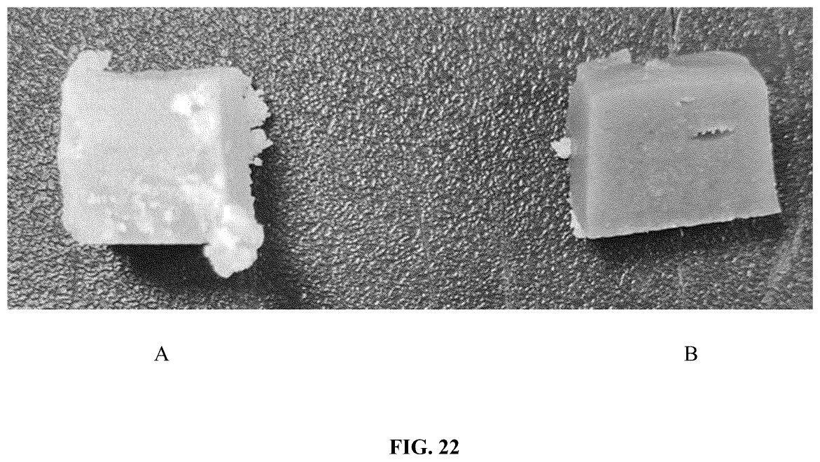

FIG. 21 shows at each time point, heated mixtures of milk, butter and saccharides (sucrose, XOS:COS:MCC 75:10:15) have developed more colour further showing non-enzymatic browning reactions with the saccharide mixture occur at lower temperatures. The final product of this confectionery mixture is shown in FIG. 22, the product containing the saccharide mixture is darker in colour (FIG. 22B). Lower processing temperatures and less processing time could achieve the same browning as the sucrose sample.

Table 10 shows the main differences in non-enzymatic breakdown reaction products in the final sucrose and saccharide confectionery mixtures.

TABLE 10
Concentrations of the non-enzymatic breakdown products in sucrose
confectionery mixture and saccharides confectionery mixture

Concentration (ppb)

| Compound | Sucrose | XOS:COS:MCC |
|---|---|---|
| Acetic acid | 0.01 | 294.86 |
| Isovaleraldehyde | 0.17 | 0.35 |
| Furfural | 0.01 | 1378.56 |
| Benzaldehyde | 0.13 | 0.68 |
| 3-methyl-3-(2- | 0.00 | 19.29 |
| oxopropylamino)butan-2- | | |
| one | | |
| 3-(hydroxymethyl)nonan-2- | 1.09 | 7.76 |
| one | | |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1.-123. (canceled)

124. A flavoring precursor composition comprising:
a) a first oligosaccharide;
b) a second oligosaccharide that is a different type of oligosaccharide to the first oligosaccharide; and
c) an acidity regulator;
wherein:
the first oligosaccharide and the second oligosaccharide of the flavoring precursor composition comprise a ratio of the second oligosaccharide to the first oligosaccharide of up to 90:10 w/w;
wherein a composition of 100 mg of the flavoring precursor added to 1 mL of water can attain a temperature greater than 120° C. (under atmospheric conditions), wherein at least 5% by weight of the added water remains in the composition at 120° C.;
the heating of the flavoring precursor produces a plurality of non-enzymatic oligosaccharide breakdown products comprising one or more compound(s) selected from the group consisting of ketones, esters, aldehydes, furans, pyrazines, and aromatic compounds; and
the first oligosaccharide and the second oligosaccharide are selected independently from one of the following types of oligosaccharide:
i. cello-oligosaccharides having a degree of polymerization (DP) of 2-6
ii. fructo-oligosaccharides having a DP of 2-12
iii. mannan-oligosaccharides having a DP of 2-12
iv. galacto-oligosaccharides having a DP of 2-12
v. mixed-linkage glucan oligosaccharides having a DP of 2-12
vi. malto-oligosaccharides having a DP of 2-12
vii. xylo-oligosaccharides having a DP of 2-12

125. The flavoring precursor composition of claim 124, wherein upon heating to a temperature of 170° C. and maintaining the temperature for five minutes, a 100 mg/mL aqueous solution in total concentration prepared from the first oligosaccharide and the second oligosaccharide of the flavoring precursor composition has a background-subtracted absorbance (using water as a reference) at room temperature and 420 nm that is greater than a sucrose solution, of equivalent mass-concentration, treated in the same manner.

126. The flavoring precursor composition of claim 124, wherein upon heating an aqueous solution of the flavoring precursor to greater than or equal to 170° C., the relative amount of saccharides remaining in the flavoring precursor is at least 45% of the relative amount of saccharides in the flavoring precursor prior to heating.

127. The flavoring precursor composition of claim 124, wherein the flavoring precursor further comprises moisture and/or water.

128. The flavoring precursor composition of claim 124, wherein the first oligosaccharide is cello-oligosaccharides having a DP of 2-6.

129. The flavoring precursor of claim 124, wherein the first oligosaccharide or the second oligosaccharide is selected from the following:
i) cello-oligosaccharide having a DP of 2-6
ii) fructo-oligosaccharide having a DP of 2-12
iii) xylo-oligosaccharide having a DP of 2-12

130. The flavoring precursor composition of claim 128, wherein the ratio of the first oligosaccharide to the second oligosaccharide is from 10:90 to 50:50 w/w.

131. A cooked food product produced from a raw food product, the cooked food product comprising a flavoring component which comprises:
a plurality of non-enzymatic oligosaccharide breakdown products comprising one or more compound(s) selected from the group consisting of ketones, esters, aldehydes, furans, pyrazines, and aromatic compounds;
wherein the non-enzymatic oligosaccharide breakdown products were produced during cooking of the raw food product,
wherein the raw food product comprises a flavoring precursor composition, the flavoring precursor composition comprising:
a) a first oligosaccharide;
b) a second oligosaccharide, that is a different type of oligosaccharide to the first oligosaccharide;
c) an acidity regulator;
wherein:
the first oligosaccharide and the second oligosaccharide of the flavoring precursor composition comprise a ratio of the second oligosaccharide to the first oligosaccharide of up to 90:10 w/w;
a composition of 100 mg of the flavoring precursor added to 1 mL of water can attain a temperature greater than 120° C. (under atmospheric conditions), wherein at least 5% by weight of the added water remains in the composition at 120° C.; and
the first oligosaccharide and the second oligosaccharide are selected independently from one of the following types of oligosaccharide i-vii):
i. cello-oligosaccharides having a DP of 2-6
ii. fructo-oligosaccharides having a DP of 2-12
iii. mannan-oligosaccharides having a DP of 2-12
iv. galacto-oligosaccharides having a DP of 2-12
v. mixed-linkage glucan oligosaccharides having a DP of 2-12
vi. malto-oligosaccharides having a DP of 2-12
vii. xylo-oligosaccharides having a DP of 2-12.

132. The cooked food product of claim 131, wherein at least one of the plurality of non-enzymatic oligosaccharide breakdown products is present at a higher concentration than a cooked food product produced from a raw food product wherein the first oligosaccharide and the second oligosaccharide are substituted for sucrose.

133. The cooked food product of claim 131, wherein the flavoring precursor composition further comprises an amino acid, one or more lipids, or a combination thereof.

134. The cooked food product of claim 131, wherein the cooked food product is a baked good or a confectionary product.

135. The cooked food product of claim 131, wherein the raw food product and/or cooked food product comprises polysaccharides.

136. The cooked food product of claim 135, wherein the polysaccharides comprise cellulose.

137. A method of making a cooked food the method comprising:
(a) providing a composition having a first pH, the composition comprising:
a first oligosaccharide; and
a second oligosaccharide that is a different oligosaccharide from the first oligosaccharide;
(b) adjusting, if necessary, the first pH of to be from 3 to 10; and
(c) heating the composition to greater than 100° C., wherein a flavoring component, comprising a plurality of non-enzymatic breakdown products, is produced;
wherein:
at least one of the plurality of non-enzymatic oligosaccharide breakdown products is present at a higher concentration than if the first oligosaccharide and the second oligosaccharide in the composition of a) are substituted for sucrose;
wherein an acidity regulator is provided during a) and/or b); and
a composition of 100 mg of the flavoring precursor added to 1 mL of water can attain a temperature greater than 120° C. (under atmospheric conditions), wherein at least 5% by weight of the added water remains in the composition at 120° C.

138. The method of claim 137, wherein (b) further comprises adjusting the pH of the composition to a second pH, the second pH being 4 to 7.

139. The method of claim 137, wherein (c) comprises heating the composition to at most 177° C.

140. The method of claim 137, further comprising: (d) maintaining the heat for a time period sufficient to achieve a predetermined sugar stage.

141. The method of claim 140, wherein (d) comprises heating the composition to from 110° C. to 112° C. such that the composition has a consistency of sucrose at a thread stage.

142. The method of claim 140, wherein (d) comprises heating the composition to from 112° C. to 116° C. such that the composition has a consistency of sucrose in a soft ball stage.

143. The method of claim 140, wherein (d) comprises heating the composition to from 118° C. to 120° C. such that the composition has a consistency of sucrose in a firm ball stage.

144. The method of claim 140, wherein (d) comprises heating the composition to from 121° C. to 130° C. such that the composition has a consistency of sucrose in a hard ball stage.

145. The method of claim 140, wherein (d) comprises heating the composition to from 133° C. to 143° C. such that the composition has a consistency of sucrose in a soft crack stage.

146. The method of claim 140, wherein (d) comprises heating the composition to from 146° C. to 154° C. such that the composition has a consistency of sucrose in a hard crack stage.
